(19) United States
(12) Patent Application Publication
(10) Pub. No.: US 2026/0265102 A1
(43) Pub. Date: Sep. 10, 2026

(54) SEPTIC TREATMENT SYSTEM

(71) Applicant: IFLO LLC, Miramar, FL (US)

(72) Inventor: Joseph MCDONNELL, Miramar, FL (US)

(73) Assignee: IFLO LLC, Miramar, FL (US)

(21) Appl. No.: 19/559,381

(22) Filed: Mar. 6, 2026

Related U.S. Application Data
(60) Provisional application No. 63/769,116, filed on Mar. 9, 2025.

(51) Int. Cl. C02F 3/34; C02F 3/00; C02F 103/00

(52) U.S. Cl. CPC C02F 3/341; C02F 3/006; C02F 2103/002; C02F 2103/005; C02F 2201/006; C02F 2203/006; C02F 2209/008; C02F 2209/36; C02F 2209/42

(57) ABSTRACT

A septic treatment system includes a dispensing apparatus and a computing device that controls the dispensing apparatus through a communication link to dispense a septic treatment composition according to a dispensing operation sequence that is selected based on processing external data received from an external device. The septic treatment system may be configured to dispense the septic treatment composition into a septic tank through one or more drain lines. The external data may include cartridge data associated with a cartridge from which the dispensing apparatus is configured to receive the septic treatment composition. The selected dispensing operation sequence may be selected based on being associated with a particular cartridge group identifier code that may be determined based on the cartridge data.

### CROSS-REFERENCE TO RELATED APPLICATION

### Field

This application claims priority to and the benefit of United States Provisional Patent Application No. 63/769,116, filed in the United States Patent and Trademark Office on Mar. 9, 2025, the entire contents of which are incorporated herein by reference.

### BACKGROUND

### Field

The present inventive concepts relate generally to septic tanks and septic treatment, and more particularly to septic treatment systems that dispense septic treatment compositions that may be directed into septic tanks to facilitate decomposition (digestion, breaking down, consumption, treatment, etc.) of organic waste in septic tanks, including solid organic waste.

### Description of Related Art

A septic waste system includes a septic tank through which wastewater (e.g., greywater, blackwater, sewage, etc.) flows. The septic tank implements sewage treatment of the wastewater, for example, based on implementing settling and anaerobic digestion of waste included in the wastewater. The wastewater entering the septic tank may include solids and scum and displaces liquid (e.g., water) already present in the septic tank. The solids may settle at the bottom of the septic tank to form an organic sludge layer, and scum may float in liquid within the septic tank, forming a scum layer. The septic tank may be configured to enable the settled solids to be anaerobically digested. Liquid components of the wastewater (e.g., water) may be directed as effluent to a septic drain field, also referred to as a leach field, a drain field, or a leach drain, for further removal of contaminants, impurities from the effluent.

Septic tanks may be periodically cleaned (e.g., emptied) to remove waste that is not decomposed and/or digested in the septic tank (e.g., from the organic sludge layer and/or the scum layer), for example, via a process variously described as “desludging,” “pumping out,” or the like.

### SUMMARY

Some example embodiments provide a septic treatment system, or a method for controlling same. The septic treatment system, or the method for controlling same, may enable improved treatment of organic waste in one or more septic waste systems at one or more geographic locations, or sites, based on controlling a dispensing apparatus to dispense septic treatment composition according to a particular, selected dispensing operation sequence from among a plurality of separate dispensing operation sequences that are each associated with at least one of a separate dispensing operation frequency, a separate amount of septic treatment composition dispensed per dispensing operation, or a separate maximum dispensing operation quantity.

Some example embodiments provide a computing device for a septic treatment system, where the computing device may control a dispensing apparatus of the septic treatment system through a communication link to cause the dispensing apparatus to dispense a septic treatment composition according to a selected dispensing operation sequence from among at least a plurality of dispensing operation sequences.

According to some example embodiments, a septic treatment system may include a dispensing apparatus and a computing device. The computing device may be communicatively coupled to the dispensing apparatus through a communication link. The computing device may be configured to control the dispensing apparatus through the communication link to cause the dispensing apparatus to dispense a septic treatment composition according to a selected dispensing operation sequence from among at least a plurality of dispensing operation sequences. The selected dispensing operation sequence may be selected based on processing external data received from an external device. Each dispensing operation sequence of the plurality of dispensing operation sequences may be associated with at least one of a separate dispensing operation frequency, a separate amount of septic treatment composition dispensed per dispensing operation, or a separate maximum dispensing operation quantity.

The dispensing apparatus may include an outlet port. The dispensing apparatus may be configured to dispense the septic treatment composition through the outlet port. The outlet port may be coupled in fluid communication with a septic tank of a septic waste system through one or more drain lines of a drain line system, such that the septic treatment system is configured to dispense the septic treatment composition into the septic tank through the one or more drain lines based on the computing device causing the dispensing apparatus to dispense the septic treatment composition according to the selected dispensing operation sequence, the one or more drain lines including at least one of a greywater drain line or a blackwater drain line.

The dispensing apparatus may be configured to dispense the septic treatment composition based on receiving the septic treatment composition from one of a plurality of cartridges, each cartridge of the plurality of cartridges associated with one of a plurality of cartridge groups, each cartridge group associated with a separate cartridge group identifier code among a plurality of cartridge group identifier codes. The plurality of dispensing operation sequences may be associated with separate, respective cartridge group identifier codes among the plurality of cartridge group identifier codes. The external data may include cartridge data indicating a particular cartridge group identifier code among the plurality of cartridge group identifier codes. The computing device may be configured to control the dispensing apparatus through the communication link to cause the dispensing apparatus to dispense the septic treatment composition according to the selected dispensing operation sequence based on: processing the cartridge data to identify the particular cartridge group identifier code from among the plurality of cartridge group identifier codes, and selecting a particular dispensing operation sequence from among at least the plurality of dispensing operation sequences as the selected dispensing operation sequence based on determining that the particular cartridge group identifier code is associated with the particular dispensing operation sequence.

The plurality of cartridge groups may hold different, respective septic treatment compositions.

The different, respective septic treatment compositions may include different concentrations of one or more microorganisms.

The septic treatment system may further include a sensor device communicatively coupled to the computing device, the sensor device configured to generate sensor data based on monitoring at least a portion of a septic system, the septic system including a septic tank, the sensor device configured to transmit the sensor data to the computing device. The computing device may be configured to select the selected dispensing operation sequence based on processing the sensor data to determine at least one property of the septic system, the at least one property including at least one of: a level of waste within the septic tank, a level of waste within a drain field of the septic system, at least one of a presence or concentration of bacteria and/or nutrients within a drain field of the septic system, at least one of a presence, level, or concentration of liquid in soil within a threshold proximity of the septic tank, a drain field of the septic system, or any combination thereof, or at least one of a presence or concentration of bacteria and/or nutrients in soil within a threshold proximity of the septic tank, a drain field of the septic system, or any combination thereof.

The septic treatment system may further include a sensor device communicatively coupled to the computing device, the sensor device configured to generate sensor data based on monitoring at least a portion of a septic system, the septic system including a septic tank, the sensor device configured to transmit the sensor data to the computing device. The computing device may be configured to transmit a signal to a remote device based on processing the sensor data to determine at least one property associated with the septic system, the signal including status information indicating a status of the septic system, the at least one property including at least one of: a level of waste within the septic tank, a level of liquid within a drain field of the septic system, at least one of a presence or concentration of bacteria and/or nutrients within a drain field of the septic system, at least one of a presence, level, or concentration of liquid in soil within a threshold proximity of the septic tank, a drain field of the septic system, or any combination thereof, or at least one of a presence or concentration of bacteria and/or nutrients in soil within a threshold proximity of the septic tank, a drain field of the septic system, or any combination thereof.

The computing device may be configured to cause the dispensing apparatus to perform an interrupt dispensing operation independently of the selected dispensing operation sequence, in response to the computing device receiving a signal from a remote device.

The computing device may be configured to: associate the dispensing apparatus with the selected dispensing operation sequence; track a quantity of dispensing operations performed by the dispensing apparatus according to the selected dispensing operation sequence; and in response to determining that the quantity of dispensing operations at least meets a threshold quantity, command at least one of purchase or delivery of a new cartridge to a mailing address associated with the dispensing apparatus based on an ordering parameter associated with the selected dispensing operation sequence, the new cartridge associated with either: the selected dispensing operation sequence, or a different dispensing operation sequence.

According to some example embodiments, a computing device may include a communication interface configured to establish a communication link with a dispensing apparatus, a memory storing a program of instructions, and a processor configured to execute the program of instructions to cause the computing device to control the dispensing apparatus through the communication link to cause the dispensing apparatus to dispense a septic treatment composition according to a selected dispensing operation sequence from among at least a plurality of dispensing operation sequences, the selected dispensing operation sequence selected based on processing external data received from an external device, each dispensing operation sequence of the plurality of dispensing operation sequences associated with at least one of a separate dispensing operation frequency, a separate amount of septic treatment composition dispensed per dispensing operation, or a separate maximum dispensing operation quantity.

The dispensing apparatus may be configured to dispense the septic treatment composition based on receiving the septic treatment composition from one of a plurality of cartridges, each cartridge of the plurality of cartridges associated with one of a plurality of cartridge groups, each cartridge group associated with a separate cartridge group identifier code among a plurality of cartridge group identifier codes. The plurality of dispensing operation sequences may be associated with separate, respective cartridge group identifier codes among the plurality of cartridge group identifier codes. The external data may include cartridge data indicating a particular cartridge group identifier code among the plurality of cartridge group identifier codes. The processor may be configured to execute the program of instructions to: process the cartridge data to identify the particular cartridge group identifier code from among the plurality of cartridge group identifier codes, and select a particular dispensing operation sequence from among at least the plurality of dispensing operation sequences as the selected dispensing operation sequence based on determining that the particular cartridge group identifier code is associated with the particular dispensing operation sequence.

The plurality of cartridge groups may hold different, respective septic treatment compositions.

The different, respective septic treatment compositions may include different concentrations of one or more microorganisms.

The communication interface may be configured to establish a separate communication link with a sensor device such that the computing device is configured to receive sensor data from the sensor device based on the sensor device monitoring at least a portion of a septic system, the septic system including a septic tank. The external data may include the sensor data received from the sensor device. The processor may be configured to execute the program of instructions to select the selected dispensing operation sequence based on processing the sensor data to determine at least one property of the septic system, the at least one property including at least one of: a level of waste within the septic tank, a level of liquid within a drain field of the septic system, at least one of a presence or concentration of bacteria and/or nutrients within a drain field of the septic system, at least one of a presence, level, or concentration of liquid in soil within a threshold proximity of the septic tank, a drain field of the septic system, or any combination thereof, or at least one of a presence or concentration of bacteria and/or nutrients in soil within a threshold proximity of the septic tank, a drain field of the septic system, or any combination thereof.

The communication interface may be configured to establish a separate communication link with a sensor device such that the computing device is configured to receive sensor data from the sensor device based on the sensor device monitoring at least a portion of a septic system, the septic system including a septic tank. The processor may be configured to execute the program of instructions to cause the computing device to transmit a signal to a remote device based on processing the sensor data to determine at least one property associated with the septic system, the signal including status information indicating a status of the septic system, the at least one property including at least one of: a level of waste within the septic tank, a level of liquid within a drain field of the septic system, at least one of a presence or concentration of bacteria and/or nutrients within a drain field of the septic system, at least one of a presence, level, or concentration of liquid in soil within a threshold proximity of the septic tank, a drain field of the septic system, or any combination thereof, or at least one of a presence or concentration of bacteria and/or nutrients in soil within a threshold proximity of the septic tank, a drain field of the septic system, or any combination thereof.

The processor may be configured to execute the program of instructions to cause the computing device to transmit a dispensing control signal to the dispensing apparatus to cause the dispensing apparatus to perform an interrupt dispensing operation independently of the selected dispensing operation sequence, in response to the computing device receiving a signal from a remote device.

The processor may be configured to execute the program of instructions to: associate the dispensing apparatus with the selected dispensing operation sequence, track a quantity of dispensing operations performed by the dispensing apparatus according to the selected dispensing operation sequence, and in response to determining that the quantity of dispensing operations at least meets a threshold quantity, command at least one of purchase or delivery of a new cartridge to an address associated with the dispensing apparatus based on an ordering parameter associated with the selected dispensing operation sequence, the new cartridge associated with either of: the selected dispensing operation sequence, or a different dispensing operation sequence.

According to some example embodiments, a method for controlling a septic treatment system may include receiving external data from an external device through a first communication link, and transmitting a control signal to a dispensing apparatus through a second communication link to cause the dispensing apparatus to dispense a septic treatment composition according to a selected dispensing operation sequence from among at least a plurality of dispensing operation sequences, the selected dispensing operation sequence selected based on processing the external data, each dispensing operation sequence of the plurality of dispensing operation sequences associated with at least one of a separate dispensing operation frequency, a separate amount of septic treatment composition dispensed per dispensing operation, or a separate maximum dispensing operation quantity.

The dispensing apparatus may be configured to dispense the septic treatment composition based on receiving the septic treatment composition from one of a plurality of cartridges, each cartridge of the plurality of cartridges associated with one of a plurality of cartridge groups, each cartridge group associated with a separate cartridge group identifier code among a plurality of cartridge group identifier codes. The plurality of dispensing operation sequences may be associated with separate, respective cartridge group identifier codes among the plurality of cartridge group identifier codes. The external data may include cartridge data indicating a particular cartridge group identifier code among the plurality of cartridge group identifier codes. The method may include processing the cartridge data to identify the particular cartridge group identifier code from among the plurality of cartridge group identifier codes, and selecting a particular dispensing operation sequence from among at least the plurality of dispensing operation sequences as the selected dispensing operation sequence based on determining that the particular cartridge group identifier code is associated with the particular dispensing operation sequence.

The external data may include sensor data received from a sensor device based on the sensor device monitoring at least a portion of a septic system, the septic system including a septic tank. The method may include selecting the selected dispensing operation sequence based on processing the sensor data to determine at least one property of the septic system, the at least one property including at least one of: a level of waste within the septic tank, a level of liquid within a drain field of the septic system, at least one of a presence or concentration of bacteria and/or nutrients within a drain field of the septic system, at least one of a presence, level, or concentration of liquid in soil within a threshold proximity of the septic tank, a drain field of the septic system, or any combination thereof, or at least one of a presence or concentration of bacteria and/or nutrients in soil within a threshold proximity of the septic tank, a drain field of the septic system, or any combination thereof.

The method may include transmitting a signal to a remote device based on processing sensor data received from a sensor device to determine at least one property associated with a septic system, the sensor data received based on the sensor device monitoring at least a portion of the septic system, the septic system including a septic tank, the signal including status information indicating a status of the septic system, the at least one property including at least one of: a level of waste within the septic tank, a level of liquid within a drain field of the septic system, at least one of a presence or concentration of bacteria and/or nutrients within a drain field of the septic system, at least one of a presence, level, or concentration of liquid in soil within a threshold proximity of the septic tank, a drain field of the septic system, or any combination thereof, or at least one of a presence or concentration of bacteria and/or nutrients in soil within a threshold proximity of the septic tank, a drain field of the septic system, or any combination thereof.

The method may further include transmitting a dispensing control signal to the dispensing apparatus to cause the dispensing apparatus to perform an interrupt dispensing operation independently of the selected dispensing operation sequence, in response to receiving a signal from a remote device.

The method may further include associating the dispensing apparatus with the selected dispensing operation sequence; tracking a quantity of dispensing operations performed by the dispensing apparatus according to the selected dispensing operation sequence; and in response to determining that the quantity of dispensing operations at least meets a threshold quantity, commanding at least one of purchase or delivery of a new cartridge to a mailing address associated with the dispensing apparatus based on an ordering parameter associated with the selected dispensing operation sequence, the new cartridge associated with either: the selected dispensing operation sequence, or a different dispensing operation sequence.

The septic treatment system, the computing device of same, and/or the method for controlling same may enable improved control over organic waste treatment in the septic tank based on control of operation of a dispensing apparatus that dispenses one or more particular septic treatment compositions which may be directed into the septic tank. The improved control may include maintaining, recovering (interchangeably referred to as increasing), or re-starting (e.g., “reviving”) septic tank activity (also referred to herein as waste decomposition activity) in a septic tank where such activity has stopped or has substantially stopped such that organic waste is not being broken down or is substantially not being broken down.

The septic treatment system, the computing device of same, and/or the method for controlling same may be configured to enable improved organic waste treatment performance by septic waste systems, including reviving, recovering, and/or maintaining such performance of septic waste systems.

The septic treatment system, the computing device of same, and/or the method for controlling same may enable improved treatment of organic waste by a septic waste system, including causing reduction, minimization, or elimination of solid organic waste in a septic tank and/or drain field of a septic waste system, thereby reducing, minimizing, or preventing solid organic waste accumulation in the septic waste system and thus improving organic waste treatment performance by the septic waste system.

Such improved organic waste treatment performance by the septic waste system may reduce, minimize, or prevent undesired release of organic waste into a surrounding environment external to the septic tank and/or the drain field of a septic waste system, including surrounding soil, groundwater, surface water, waterways, and/or a structure (e.g., based on reducing, minimizing, or preventing back-up of organic waste into the structure through a drain line system based on accumulation of solid organic waste in the septic tank). Accordingly, the septic treatment system may reduce, minimize, or prevent undesirable contamination of the environment by such organic waste from one or more septic waste systems through at least the respective septic tank and/or drain field thereof. Accordingly, the septic treatment system may enable improvement of the ambient environment proximate to and/or associated with one or more septic waste systems.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a schematic view of a septic treatment system, according to some example embodiments.

FIG. 2 is a schematic view of at least a portion of the septic treatment system shown in FIG. 1, according to some example embodiments.

FIG. 3A is a schematic view of region X in FIG. 2, including a portion of a septic treatment system configured to dispense a septic treatment composition into a drain line of an appliance, according to some example embodiments.

FIG. 3B is a schematic view of region X in FIG. 2, including a portion of a septic treatment system configured to dispense a septic treatment composition through an appliance, according to some example embodiments.

FIG. 4 is a schematic view of at least a portion of the septic treatment system shown in FIG. 1, according to some example embodiments.

FIG. 5 is a flowchart illustrating a method of operation of a septic treatment system according to some example embodiments.

FIG. 6 is a flowchart illustrating a method of operation of a septic treatment system according to some example embodiments.

FIG. 7 is a flowchart illustrating a method of operation of a septic treatment system according to some example embodiments.

FIG. 8 is a flowchart illustrating a method of operation of a septic treatment system according to some example embodiments.

FIG. 9 is a flowchart illustrating a method of operation of a septic treatment system according to some example embodiments.

FIGS. 10A, 10B, and 10C are flowcharts illustrating methods of operation of a septic treatment system according to some example embodiments. FIGS. 11A, 11B, and 11C illustrate treatment of a septic tank based on septic treatment compositions dispensed by the dispensing apparatus of the septic treatment system based on the methods of FIGS. 10A, 10B, and 10C, respectively, according to some example embodiments.

FIG. 12 is a schematic view of a computing device according to some example embodiments.

### DETAILED DESCRIPTION

Reference will now be made in detail to example embodiments, some of which are illustrated in the accompanying drawings, wherein like reference labels refer to like elements throughout. However, specific structural and functional details disclosed herein are merely representative for the purpose of describing example embodiments. Example embodiments may be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments of the inventive concepts.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

It will be understood that elements and/or properties thereof may be recited herein as being “the same” or “equal” as other elements, and it will be further understood that elements and/or properties thereof recited herein as being “identical” to, “the same” as, or “equal” to other elements may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to and/or the same or substantially the same as other elements and/or properties thereof may be structurally the same or substantially the same, functionally the same or substantially the same, and/or compositionally the same or substantially the same.

It will be understood that elements and/or properties thereof described herein as being “substantially” the same and/or identical encompass elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operational tolerance (e.g., ±10%) around the stated elements and/or properties thereof.

It will be understood that, although the terms “first,” “second,” “third,” etc., may be used herein to describe various elements, components, regions, layers, and/or sections, these elements, components, regions, layers, and/or sections should not be otherwise limited by these terms. These terms are only used to distinguish one element, component, region, layer, or section from another region, layer, or section. Thus, a first element, component, region, layer, or section discussed below may be termed a second element, component, region, layer, or section, without departing from the scope of this disclosure.

When the terms “about” or “substantially” are used in this specification in connection with a numerical value, it is intended that the associated numerical value include a tolerance of ±10% around the stated numerical value. When ranges are specified, the range includes all values therebetween, such as increments of 0.1%.

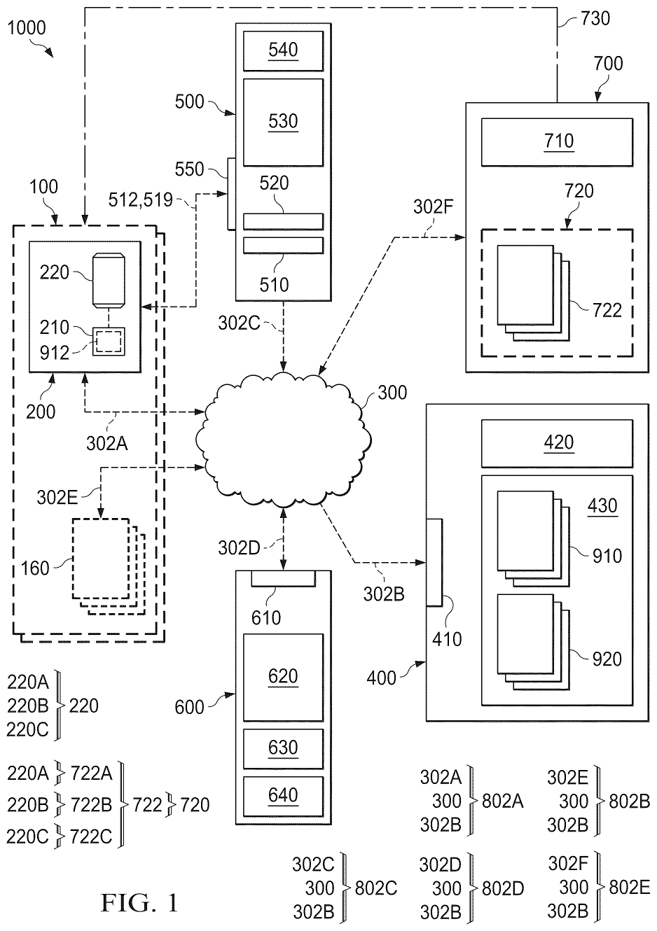

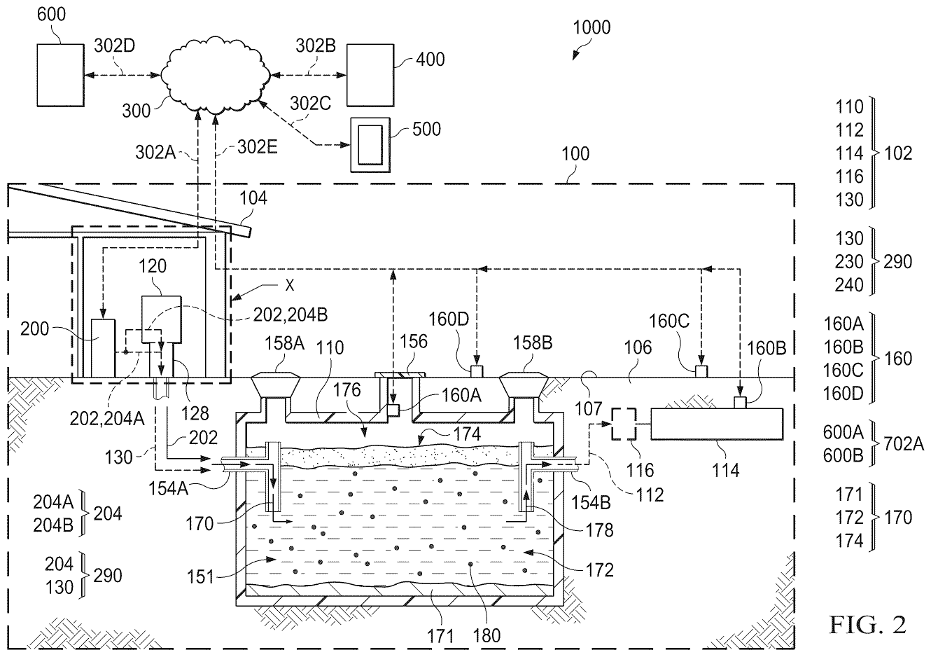

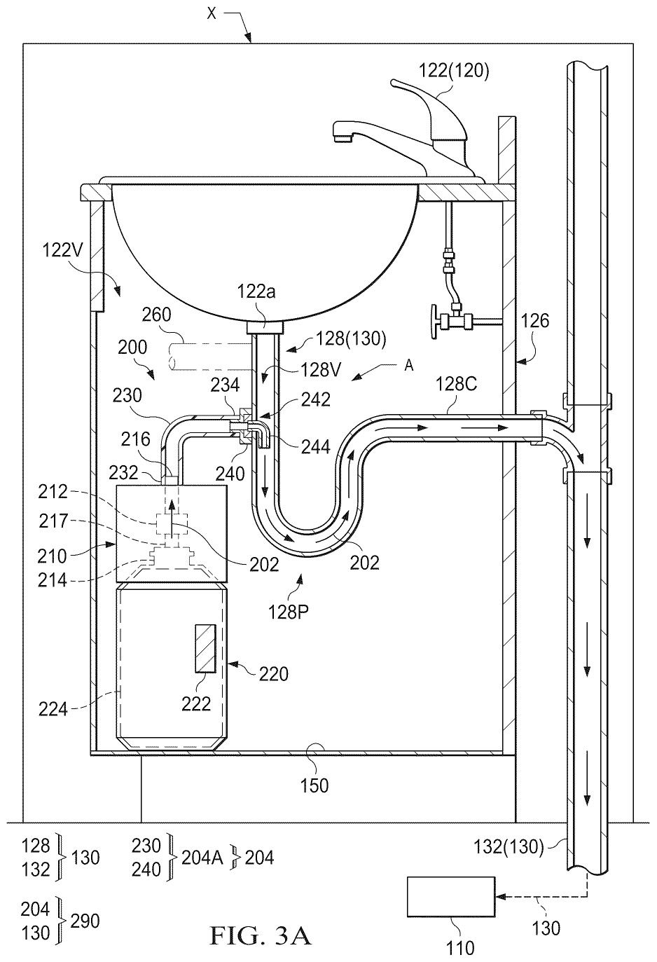

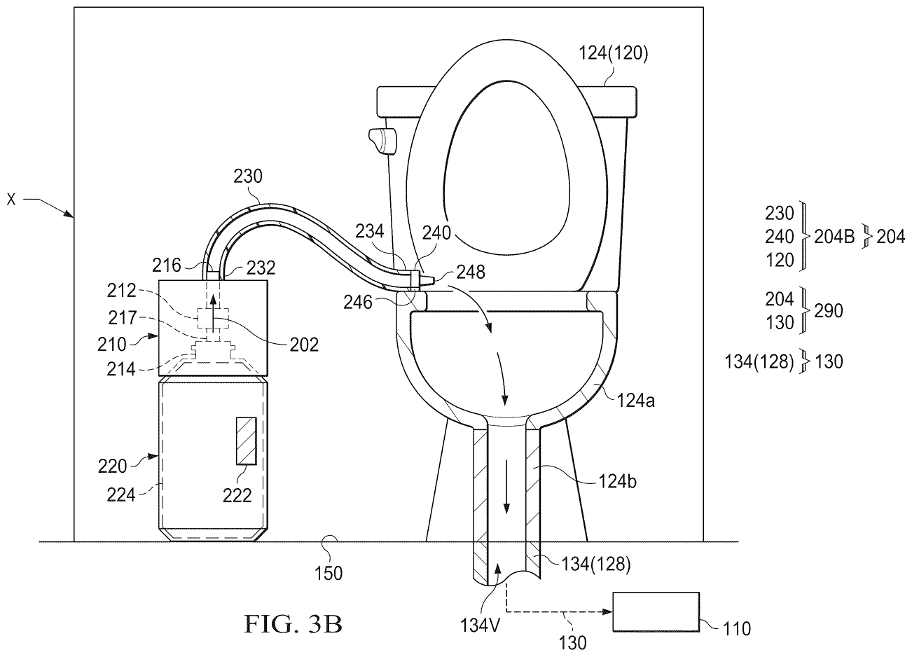

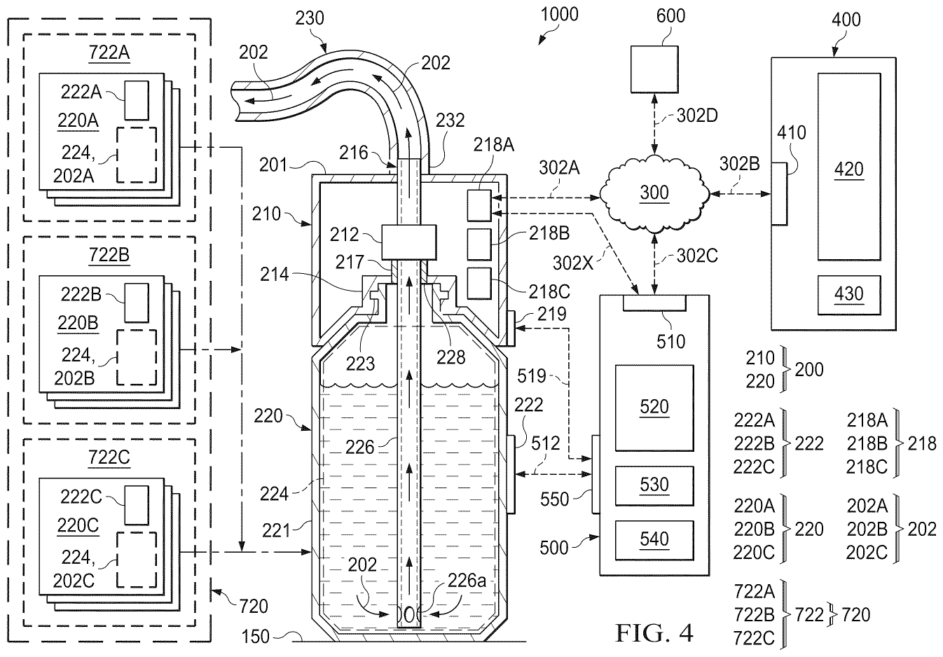

FIG. 1 is a schematic view of a septic treatment system 1000, according to some example embodiments. FIG. 2 is a schematic view of at least a portion of the septic treatment system 1000 shown in FIG. 1, according to some example embodiments. FIG. 3A is a schematic view of region X in FIG. 2, including a portion of a septic treatment system 1000 configured to dispense a septic treatment composition into a drain line of an appliance, according to some example embodiments. FIG. 3B is a schematic view of region X in FIG. 2, including a portion of a septic treatment system configured to dispense a septic treatment composition through an appliance, according to some example embodiments. FIG. 4 is a schematic view of the septic treatment system 1000 shown in FIG. 1, according to some example embodiments.

It will be understood that FIG. 2 is a schematic view of at least a portion of the septic treatment system 1000 shown in FIG. 1, according to some example embodiments. It will be understood that FIGS. 3A and 3B illustrate portions of the septic treatment system 1000 shown in FIGS. 1 and 2, including in Region X in FIG. 2, according to some example embodiments. FIG. 3A is a schematic view of a portion of a septic treatment system 1000 shown in Region X of FIG. 2 and configured to dispense a septic treatment composition into a drain line system 130 through connection to an appliance drain line 128 of an appliance 120 and independently of the appliance 120 itself, according to some example embodiments. FIG. 3B is a schematic view of a portion of a septic treatment system 1000 shown in Region X of FIG. 2 and configured to dispense a septic treatment composition into a waste line system through an appliance 120, according to some example embodiments. It will be understood that the portion of the septic treatment system 1000 shown in FIG. 4, including the dispensing system 200 as shown in FIG. 4, may be included in the septic treatment system 1000 and portions thereof as shown in FIGS. 1, 2, 3A, and 3B according to some example embodiments.

Referring first to FIGS. 1 to 4, example embodiments herein relate to a septic treatment system 1000 or one or more portions thereof. The septic treatment system 1000 may enable improved treatment of one or more septic waste systems 102 at one or more geographic locations, or sites 100. The septic treatment system 1000 (or one or more portions thereof) may be configured to enable treatment of one or more septic waste systems 102 with one or more septic treatment compositions 202 according to respective one or more dispensing operation sequences, so as to provide a higher granularity of control over organic waste breakdown in at least the septic tank 110 of the septic waste system 102. Such controlled dispensing of one or more septic treatment compositions may include controlling one or more dispensing apparatuses to dispense one or more septic treatment compositions according to one or more selected dispensing operation sequences that may be selected based on external data (e.g., a cartridge group identifier code associated with a cartridge providing the septic treatment composition being dispensed, sensor data received from a sensor device monitoring at least a portion of the septic waste system 102, or the like). The septic treatment system 1000 may be configured to revive a “dead” septic tank 110 in which organic waste is not or is substantially not being decomposed to re-start such organic waste decomposition (also referred to herein as consumption, treatment, digestion, or the like) therein.

The septic treatment system 1000 may be configured to provide (also referred to herein as “dispense”) one or more septic treatment compositions 202 according to one or more dispensing operation sequences. Separate septic treatment compositions 202 may be provided according to separate dispensing operation sequences in order to facilitate improved control over organic waste treatment in the septic tank 110 (referred to herein as septic tank “activity” and/or septic tank “waste treatment”), including re-starting (e.g., “reviving”) septic tank activity (also referred to herein interchangeably as organic waste decomposition activity, including solid organic waste decomposition activity, rate of decomposition of same, or the like) in a septic tank 110 where such activity has stopped or has substantially stopped such that organic waste is not being decomposed or is substantially not being decomposed. Accordingly, the septic treatment system 1000 may be configured to enable improved organic waste treatment performance by septic waste systems 102, including reviving, recovering, and/or maintaining such performance of septic waste systems 102. Accordingly, the septic treatment system 1000 may enable improved treatment of organic waste by septic waste systems 102, including causing reduction, minimization, or elimination of solid organic waste in a septic tank 110 and/or drain field 114 of a septic waste system 102, thereby reducing, minimizing, or preventing solid organic waste accumulation in the septic waste system 102 and thus improving organic waste treatment performance by the septic waste system 102. Such improved organic waste treatment performance by the septic waste system 102 may reduce, minimize, or prevent undesired release of organic waste into a surrounding environment external to the septic tank 110 and/or the drain field 114 of a septic waste system 102, including surrounding soil, groundwater, surface water, waterways, and/or a structure 104 (e.g., based on reducing, minimizing, or preventing back-up of organic waste into the structure through a drain line system based on accumulation of solid organic waste in the septic tank 110). Accordingly, the septic treatment system 1000 may reduce, minimize, or prevent undesirable contamination of the environment by such organic waste from one or more septic waste systems 102 through at least the respective septic tank 110 and/or drain field 114 thereof. Accordingly, the septic treatment system 1000 may enable improvement of the ambient environment proximate to and/or associated with one or more septic waste systems 102.

Referring now to FIGS. 1 to 4, the septic treatment system 1000 may include one or more dispensing apparatuses 210 and a computing device 400 that is communicatively coupled to the one or more dispensing apparatuses 210 through respective communication links 802A. Each separate dispensing apparatus 210 that is communicatively coupled to the computing device 400 may be configured to dispense one or more septic treatment compositions 202 according to one or more dispensing operation sequences 910, where the one or more septic treatment compositions 202 dispensed from a given dispensing apparatus 210 may be directed into a septic tank 110 of a septic waste system 102 such that microorganisms included in the septic treatment composition 202 may facilitate biological treatment (e.g., decomposition, digestion, consumption, etc.) of organic waste in the septic tank 110.

The computing device 400 may control each separate dispensing apparatus 210 through a respective communication link 802A to cause the dispensing apparatus 210 to dispense a septic treatment composition 202 according to a selected dispensing operation sequence 912 that is selected by the computing device 400 from among at least a plurality of dispensing operation sequences 910. The computing device 400 may select the selected dispensing operation sequence 912 from among at least the plurality of dispensing operation sequences 910 based on processing external data received from an external device (e.g., a user device 500, a sensor device 160, or any combination thereof, although example embodiments are not limited thereto). Each dispensing operation sequence 910 of the plurality of dispensing operation sequences 910 may be associated with separate, respective operation parameters, including for example at least one of a separate dispensing operation frequency, a separate amount of septic treatment composition dispensed per dispensing operation, or a separate maximum dispensing operation quantity. It will be understood that a dispensing operation sequence may be interchangeably referred to herein as a dispensing operation program. It will be understood that a dispensing apparatus 210 that is dispensing septic treatment composition 202 according to a particular, selected dispensing operation sequence 912 may be referred to as operating according to a particular, selected operating mode or dispensing operation mode.

Referring to FIG. 2, a septic waste system 102 at a respective site 100 and a dispensing apparatus 210 configured to dispense a septic treatment composition 202 at the site 100 to enable treatment of the septic waste system 102 at the site are described. However, it will be understood that such description may apply equally to each of the separate dispensing apparatuses 210 at each of respective sites 100, and which each may be communicatively coupled to the computing device 400, such that the computing device 400 may independently control respective dispensing apparatuses 210 according to respective selected dispensing operation sequences 912 (which may be the same or different dispensing operation sequences) to enable treatment of respective septic waste systems 102 at respective sites 100.

Referring to FIG. 2, a septic waste system 102 at a site 100 (e.g., a lot) may support treatment of organic waste received from one or more appliances 120. The one or more appliances 120 may be associated with (e.g., located within or proximate to) a structure 104, such as a residential building (e.g., a house), although example embodiments are not limited thereto.

As shown, a septic waste system 102 may include a septic tank 110 and a drain line system 130 coupled to a septic tank influent port 154A of the septic tank 110. As shown in FIGS. 3A and 3B, the drain line system 130 may include one or more drain lines, including, for example, a greywater drain line 132 as shown in FIG. 3A, a blackwater drain line 134 as shown in FIG. 3B, or any combination thereof. The drain line system 130 may include one or more drain lines that may couple one or more appliances 120 in fluid communication with a septic tank 110 through one or more septic tank influent ports 154A thereof.

As shown in FIGS. 2 and 3A, a greywater drain line 132 may be coupled to, and configured to carry organic waste from, one or more appliances 122 configured to discharge greywater. As shown in FIG. 3A, an appliance 122 configured to discharge greywater may include a sink, but example embodiments are not limited thereto. For example, an appliance 122 may include a dishwasher, a washing machine, or any combination thereof.

As shown in FIGS. 2 and 3B, a blackwater drain line 134 may be coupled to, and configured to carry organic waste from, one or more appliances 124 configured to discharge blackwater. As shown in FIG. 3B, an appliance 124 configured to discharge blackwater may include a toilet, but example embodiments are not limited thereto.

As further shown, the drain line system 130 may include one or more appliance drain lines 128 that may couple an appliance drain of one or more appliances with one or more greywater drain lines 132 and/or one or more blackwater drain lines 134, and thereby may couple an appliance drain of one or more appliances 120 with the septic tank 110 through the drain line system 130. In some example embodiments, including the example embodiments shown in FIG. 3A, an appliance drain line 128 may be configured to direct greywater from an appliance drain 122a to a greywater drain line 132 and therefore the appliance drain line 128 may be considered to be a greywater drain line of the drain line system 130. In some example embodiments, including the example embodiments shown in FIG. 3B, an appliance drain line 128 may be a blackwater drain line 134 of the drain line system 130 to which an appliance 120 may be directly coupled. However, example embodiments of appliance drain lines 128 are not limited to the example embodiments shown in FIGS. 3A and 3B.

The drain line system 130 (including one or more greywater drain lines 132, one or more blackwater drain lines 134, or any combination thereof) may extend through at least a portion of the structure 104 and may be coupled in fluid communication with one or more septic tank influent ports of the septic tank 110, which may each be defined by a septic tank influent port 154A. While the blackwater and greywater drain lines 134 and 132 in FIGS. 3A and 3B may be coupled to the same septic tank influent port 154A of the septic tank 110, example embodiments are not limited thereto, and in some example embodiments, a drain line system 130 may include one or more greywater drain lines 132 and one or more blackwater drain lines 134 that are coupled to separate, respective septic tank influent ports 154A of the septic tank 110.

Referring now to the septic tank 110, the septic tank 110 defines a septic tank interior 151 in which organic waste 170 may be held and which may be at least partially decomposed (e.g., anaerobically decomposed, or digested, also referred to herein as “broken down,” “consumed,” or “treated”). The septic tank 110 may include a septic tank influent port 154A (also referred to herein as a septic tank inlet, and which may be a baffle tee as shown) that is configured to receive organic waste 170 (e.g., wastewater, greywater, blackwater, etc.) from the drain line system 130 and direct the organic waste 170 into the septic tank interior 151.

As shown, organic waste 170 received into the septic tank 110 may include a liquid component, a solid component, and/or a scum component. The septic tank 110 may be configured to “treat” (e.g., break down, decompose, digest, consume, etc.) at least a portion of the organic waste 170, for example based on implementing settling and anaerobic digestion of at least a portion of the organic waste 170. For example, the solid component of influent organic waste 170 may settle at the bottom of the septic tank interior 151 to form organic sludge 171, also referred to herein as an organic sludge layer, and a scum component may float in or on liquid 172 within the septic tank to thereby form scum 174, also referred to herein as a scum layer.

The septic tank 110 may be configured to enable the settled solids in the organic sludge 171 to be decomposed (e.g., digested, anaerobically digested, consumed, broken down, treated, etc.). For example, the septic tank 110 may hold (e.g., in the liquid 172) an amount (e.g., a population) of a decomposition agent 180. The decomposition agent 180 may include an amount (e.g., a population) of microorganisms, also referred to herein as microbes (e.g., one or more strains of bacteria), an amount of one or more enzymes (which may be generated based on the activity of microorganisms), or any combination thereof. The decomposition agent 180 may facilitate decomposition (e.g., breaking down, digestion, consumption, treatment, etc.) of at least a portion of organic waste 170, including at least a portion of the settled solids defining the organic sludge 171 (also referred to herein as “organic sludge”).

The liquid component of the organic waste 170 and/or by-products of decomposition of one or more portions of the organic waste 170 by the decomposition agent 180 in the septic tank 110 (e.g., water) may form a liquid 172 (also referred to herein as a liquid layer) in the septic tank 110. At least a portion of the liquid 172 may be directed as effluent 178 out of the septic tank 110 through a septic tank effluent port 154B (also referred to herein as a septic tank outlet and which may be defined by a baffle tee as shown) to a drain field 114 (for example, a leach field, a cesspool, or the like), for example, through a distribution box 116 and one or more effluent drain lines 112. In some example embodiments, at least some decomposition agent 180 (e.g., at least some microorganisms) in the liquid 172 may be carried with the effluent 178 to the drain field 114 and may decompose (“treat”) any organic waste 170 carried into the drain field 114 with the effluent 178.

As shown, the septic tank 110 of the septic waste system 102 at a site 100 may be at least partially below grade 107 at the site 100 and at least partially within the soil 106 below grade 107, although example embodiments are not limited thereto. As shown, the septic tank interior 151 may be accessible via one or more ports 156, 158A, and/or 158B, although example embodiments are not limited thereto.

Still referring to FIG. 2, the septic tank interior 151 may have an interior volume configured to hold up to about 1,000 gallons to about 1,500 gallons of organic waste 170. As shown, organic waste 170 may flow into the septic tank 110 from the drain line system 130 from one or more appliances 120. Once the organic waste 170 has reached the septic tank interior 151 through the septic tank influent port 154A, the organic waste 170 may displace at least a portion of the liquid 172 (e.g., water) already within the septic tank interior 151. Portions of the influent organic waste 170 that float to the top of the liquid 172 form or are added to the scum 174, and portions of the influent organic waste 170 that sink to the bottom of the liquid 172 form or are added to the organic sludge 171. An empty space or “void” 176 may be located above the scum 174. The void 176 may be filled with air and/or may hold one or more gas components of the influent organic waste 170 or by-products of decomposition of the organic waste 170 within the septic tank 110.

Septic tanks 110 may be periodically serviced to reduce or remove the scum 174 and/or the organic sludge 171. In some example embodiments, the decomposition agent 180 (e.g., microorganisms such as one or more strains of bacteria, one or more enzymes, or any combination thereof) in the liquid 172 may decompose (e.g., consume, break down, digest, etc.) at least some influent organic waste 170 and/or at least a portion of at least the organic sludge 171. Such decomposition may reduce, minimize, or prevent formation of the scum 174 and/or organic sludge 171 and increase or maximize the liquid 172.

The septic waste system 102, including the septic tank 110, may provide an effective means to collect organic waste 170 from one or more appliances 120 associated with the structure 104 (e.g., household waste, human waste, organic waste, or the like) and to provide a means to treat and dispose of such collected organic waste 170. In some example embodiments, various organic waste (e.g., the organic sludge 171 and/or the scum 174) may accumulate in the septic tank 110, such that the septic tank 110 may be periodically cleaned (e.g., emptied) to remove waste that is not decomposed and/or digested in the septic tank (e.g., from the organic sludge 171 and/or the scum 174), for example via a process variously described as “desludging,” “pumping out,” or the like.

However, in cases where the septic waste system 102 (particularly the septic tank 110) is not properly maintained and/or serviced, organic waste 170 (particularly organic sludge comprising the organic sludge 171) may accumulate within the septic tank 110. For example, in cases where the amount of decomposition agent 180 (e.g., a population or amount of microorganisms and/or amount of enzymes in the septic tank 110) falls below a threshold amount or concentration in the septic tank 110, organic sludge 171 and/or scum 174 may accumulate within the septic tank 110. Such accumulation may lead to discharge of undecomposed organic waste (e.g., organic sludge 171) from the septic tank 110 (via septic tank effluent port 154B and/or any of the ports 156, 158A, 158B, etc.) into the surrounding soil 106 and/or the drain field 114. Such discharge may lead to groundwater contamination and/or surface water contamination (including contamination of the water table and/or waterways proximate to the site 100 that includes the septic waste system 102) with discharged waste (e.g., organic sludge 171) and/or bacteria and/or nutrient amounts prompted by the presence of such discharged waste in the surrounding environment. Waste (e.g., solid waste such as organic sludge 171 and/or scum 174) discharged into the drain field 114 may result in organic waste clogging the drain field 114 and/or distribution box 116 and/or effluent drain lines 112, which may reduce or prevent liquid waste escape from the septic tank 110. Such clogging may cause waste to back up through the drain line system 130 via the septic tank influent port 154A into a structure 104 and/or appliances 120, causing damage to the appliance(s) 120 and/or the structure 104. Additionally, accumulation of organic sludge 171 and/or scum 174 in the septic tank 110 may promote release of noxious odors and may cause reduced property values associated with the site 100 that includes the septic waste system 102.

In some example embodiments, various organic material waste included in the organic waste 170 (referred to herein as “organics”) may accumulate in the septic tank 110 (e.g., as sludge 171 and/or scum 174) and/or in one or more portions of the drain field 114, and such accumulation in the drain field 114 and/or in the septic tank 110 may lead to waste back-up through the septic tank influent port 154A and through the drain line system 130 into one or more appliances 120 and/or into a structure 104 (e.g., through one or more appliances 120 coupled to the drain line system 130). For example, the drain field 114 may include one or more perforated pipes buried below grade 107 and configured to direct liquid waste into the surrounding soil 106, and accumulation of organics (e.g., solid waste) in the drain field 114 may at least partially block the perforations in the perforated pipes to thereby induce back-up of waste from the drain field 114 into the septic tank 110, which may further lead to back-up of organic waste 170 into the drain line system 130.

Septic tanks 110 may be maintained and/or serviced through chemical treatment or biological treatment methods. Chemical treatment may include providing one or more chemical substances into the septic tank 110, for example through the drain line system 130, which may chemically react with solid waste (e.g., scum 174 and/or organic sludge 171) to decompose at least a portion of the solid waste. However, such provided chemical compositions may be diluted by liquid 172 and any additional water received into the septic tank 110. Additionally, the effectiveness of the chemical substances may be reduced or eliminated once the substances exit the septic tank 110 via the liquid component effluent 178 through the septic tank effluent port 154B. Additionally, some chemical substances may be corrosive and may damage the drain line system 130 or any portion of the septic waste system 102. Some chemical substrates may be toxic to humans and/or animals (e.g., household pets). Furthermore, such chemical substances may not provide any additional benefits to the plumbing system of the structure 104 supported by the septic waste system 102 (e.g., the drain line system 130) and may provide generally negative effects to the surrounding environment (e.g., toxicity).

In some example embodiments, biological treatment of a septic waste system 102 may include providing one or more septic treatment compositions 202 that include an amount of microorganisms (microbes) into the septic tank 110 to serve as a decomposition agent 180 therein, for example through the drain line system 130 (e.g., as an aqueous mixture that includes the amount of microorganisms in a mixture with at least water). The microorganisms in the septic treatment composition 202 may facilitate biological decomposition (e.g., anaerobic decomposition, digestion, consumption, treatment, etc.) of organic waste (including influent organic waste 170, scum 174, and/or organic sludge 171), including for example decomposing said organic waste into liquid and/or gaseous byproducts (e.g., waste water) which may be discharged from the septic tank 110 as part of the effluent 178 into the drain field 114 without blockage of the drain field 114 and without contamination of the environment surrounding the septic waste system 102 with organic waste.

In some example embodiments, the septic treatment system 1000 is configured to enable one or more septic treatment compositions 202 to be provided (e.g., dispensed, directed, etc.) into a septic tank 110 of a septic waste system 102 through a drain line system 130 connected between one or more appliances 120 (e.g., of a structure 104) and the septic tank influent port 154A of the septic tank 110, for example based on being dispensed by a dispensing apparatus 210 coupled in fluid communication with the septic tank 110 through a fluid communication pathway 290 extending through at least a portion of the drain line system 130.

The septic treatment composition 202 as described herein may include an amount of one or more microorganisms that may be configured to facilitate decomposition (e.g., digestion, consumption, degradation, treatment, breaking down, etc.) of various types of solid organic waste in the septic tank 110 and/or the drain field 114 (e.g., one or more perforated pipes in the drain field 114) when included therein as a decomposition agent 180. Waste materials that may be decomposed by the septic treatment composition 202 may include solid components of organic waste 170 that may comprise the organic sludge 171, scum components of organic waste 170 that may comprise a scum 174 in the septic tank 110, liquid components of organic waste 170 that may at least partially comprise liquid 172 in the septic tank 110, organic waste, or “organics” that may be in the septic tank 110, or any combination thereof.

The one or more septic treatment compositions 202 may each include an amount (population) of one or more types or “strains” of microorganisms (e.g., as an aqueous mixture that includes the microorganisms in a mixture with at least water), where the one or more types or “strains” of microorganisms are configured to decompose organic waste in the septic tank 110, for example to reduce organics in the septic tank 110 based on decomposing such organics rather than allowing the organics to transfer from the septic tank 110 to the drain field 114 via effluent 178. Accordingly, each separate cartridge 220 may hold a respective amount or “population” of one or more types or “strains” of microorganisms. The microorganisms included in the septic treatment composition 202 may, when introduced into the septic tank 110 to at least partially comprise the decomposition agent 180 therein, reduce, minimize, or prevent transfer of solid waste to the drain field 114 via the effluent 178; reduce organics in the effluent 178 and thus in the drain field 114, improve drain field 114 activity; reduce bottom solids (e.g., organic sludge 171) in the septic tank 110, reduce surface scum (e.g., scum 174) in the septic tank 110; reduce odors emitted from the septic tank 110 and/or the drain field 114; reduce pumping requirements for cleaning out the septic tank 110 (e.g., “desludging,” “pumping out,” etc.), including the amount and/or frequency of such cleaning; any combination thereof; or the like.

In some example embodiments, each septic treatment composition 202 dispensed by a dispensing apparatus 210 of the septic treatment system 1000 and directed into the septic tank 110 to at least partially comprise the decomposition agent 180 therein (e.g., any or all of the plurality of septic treatment compositions 202) may include an amount (e.g., population) of microorganisms (e.g., one or more strains of bacteria) that includes an amount of one or more types (e.g., strains) of microbes, microbial formulations, bacteria, or the like that are configured to implement the aforementioned decomposition (“treatment”) of waste (e.g., solid waste, organics, etc.) in the septic tank 110 and/or in the drain field 114. The septic treatment compositions 202 may each include an aqueous mixture that includes the amount of microorganisms in a mixture with at least water. Such decomposition (e.g., anaerobic decomposition) of waste by microorganisms that are included in a septic treatment composition 202 may be referred to as “biological treatment” of the septic waste system 102. A septic treatment composition 202 may include an iFLO-Zyme® “Multi Spore FOG” septic treatment composition.

In some example embodiments, a septic treatment composition 202 that may be dispensed by a dispensing apparatus 210 of the septic treatment system 1000 (e.g., any or all of the plurality of septic treatment compositions 202) may include a plurality of strains of bacteria. In some example embodiments, one or more, or some or all septic treatment compositions 202 may include a blend of Bacillus bacteria designed to target a wide range of organics (e.g., organic waste) across a wide range of applications, where such a blend may include a blend of individually fermented Bacillus bacteria strains that are blended and are produced under the ISO 9001:2015 standard. In some example embodiments, any or all septic treatment compositions 202 may provide improved breakdown of organic waste 170 in the septic tank 110 and/or the drain field 114 based on being dispensed (e.g., discharged) into the septic tank 110, as evidenced by improved dry weight digestion percentage of waste, improved fat digestion percentage of waste (e.g., at pH 4.3), improved performance of biochemical oxygen demand (BOD), for example based on such a septic treatment composition 202 being provided into the septic tank 110 in dispensed amounts of 12 oz at a frequency of approximately 14 days per dispensed amount of septic treatment composition 202. It will be understood that the septic treatment composition 202 as described herein may include the iFLO-Zyme® “Multi Spore FOG” septic treatment composition according to some example embodiments.

It will be understood that a septic treatment composition 202 that may be dispensed by a dispensing apparatus 210 of the septic treatment system 1000 (e.g., any or all of the plurality of septic treatment compositions 202) into a septic tank 110 may facilitate “biological treatment” of the septic tank 110 to promote break-down of organic waste 170 therein, for example based on providing and/or maintaining a population of one or more strains of microorganisms (e.g., bacteria) in the septic tank 110 (e.g., within the liquid 172 therein) to produce enzymes that break down and consume such organic waste 170 (e.g., solid waste including organic sludge 171 and/or scum 174). The septic treatment composition 202 may include one or more strains of particular microorganisms (e.g., a blend of particular bacteria strains) that produce enzymes to break down and/or consume organic waste 170 (e.g., solid waste including organic sludge 171 and/or scum 174).

The septic treatment system 1000 may be configured to provide (dispense) one or more septic treatment compositions 202 into a septic tank 110 of one or more various septic waste systems 102 at each of one or more sites 100 to create, increase, and/or maintain activity (e.g., biological activity, including active decomposition of waste by microorganisms and/or enzymes) in the septic tank(s) 110 (e.g., decomposition of organic waste therein) at a desired level (e.g., a desired decomposition rate). The septic treatment system 1000 may enable one or more septic treatment compositions 202 to be provided into a septic tank 110 to establish or maintain an amount (e.g., population) of microorganisms in the septic tank 110 to serve as a decomposition agent 180 therein to promote ongoing decomposition of organic waste in the septic tank interior 151 and/or in the drain field 114. The microorganism population (e.g., bacteria) in the septic tank 110 may maintain such “activity” without dilution, due to both reproduction of the microorganisms (e.g., bacteria) and periodic dispensing of additional septic treatment composition 202 into the septic tank 110 by the septic treatment system 1000.

Additionally, microorganisms introduced into the septic tank 110 to serve as a decomposition agent 180 therein may be carried in effluent 178 into the drain field 114 to continue waste decomposition further downstream of the septic tank effluent port 154B to reduce, minimize, or prevent organic waste blockage or clogging downstream of the septic tank effluent port 154B.

Additionally, it will be understood that microorganisms included in a septic treatment composition 202 may be less (or not) corrosive on pipes or structures of the septic waste system 102, may have reduced (or no) toxicity for humans or animals (e.g., household pets), may have a positive effect throughout an entire plumbing system of a structure 104 (e.g., based on breaking down organic waste therein without corroding said plumbing) and may have a positive effect on the surrounding environment based on reducing, minimizing, or preventing waste contamination of the surrounding environment without said microorganisms of the septic treatment composition 202 similarly contaminating said environment.

Referring back to FIGS. 1 and 2, the septic treatment system 1000 may include at least one dispensing apparatus 210 and a computing device 400 that is communicatively coupled to the dispensing apparatus 210 through a communication link 802A. The computing device 400 is configured to control the dispensing apparatus 210 through the communication link 802A to cause the dispensing apparatus 210 to dispense one or more septic treatment compositions 202 according to a selected dispensing operation sequence 912 that is selected by the computing device 400 from among at least a plurality of dispensing operation sequences 910. The dispensing apparatus 210 may at least partially establish a dispensing system 200 that is configured to provide one or more septic treatment compositions 202 that may be directed into a septic tank 110 of a septic waste system 102 through a fluid communication pathway 290 extending through at least a portion of a drain line system 130 that couples one or more appliances 120 to the septic tank 110, so as to decompose organic waste therein. The dispensing system 200 may include the dispensing apparatus 210 and a septic treatment composition source that is coupled to the dispensing apparatus 210 to enable septic treatment composition 202 to be received at the inlet port 217 of a dispenser device 212 of the dispensing apparatus 210 and discharged from an outlet port 216 of the dispensing apparatus based on operation of the dispenser device 212. The septic treatment composition source may include a cartridge 220 that may be coupled to the dispensing apparatus 210 as described herein, but example embodiments of a septic treatment composition source are not limited thereto.

In some example embodiments, the dispensing system 200 may include a cartridge 220 coupled to the dispensing apparatus 210. The cartridge 220 may include an internal cartridge reservoir 224 holding an amount of a septic treatment composition 202 therein. The dispensing apparatus 210 may be configured to dispense septic treatment composition 202 that is received at the dispensing apparatus 210 from the cartridge 220 based on the cartridge 220 being coupled with the dispensing apparatus 210 to establish fluid communication between the internal cartridge reservoir 224 of the cartridge 220 with an inlet port 217 of a dispenser device 212 of the dispensing apparatus 210. However, example embodiments are not limited thereto. For example, in some example embodiments, the dispensing apparatus 210 may dispense septic treatment composition received from a separate composition source that is not coupled to the dispensing apparatus (e.g., via a conduit).

In some example embodiments, the dispensing apparatus 210 includes a housing 201 that at least partially defines an interior of the dispensing apparatus 210 and may include a dispenser device 212 and circuitry 218 therein. The dispenser device 212 may include any known pump device, valve device, or the like that is configured to be operated (also referred to as “actuated”) to controllably dispense a controlled amount of septic treatment composition thereto. In some example embodiments, the dispenser device 212 may include any known positive displacement pump, a gear pump, or the like that is configured to operate for a particular period of time to move the amount of the septic treatment composition from the inlet port 217 to the outlet port 216, based on a control signal generated by circuitry 218 (e.g., a controller 218A thereof).

The dispensing apparatus 210 may include an outlet port 216. The dispenser device 212 is coupled at an outlet end to the outlet port 216 and is coupled at an inlet end to an inlet port 217 that is configured to receive septic treatment composition 202 from a septic treatment composition source (e.g., a cartridge 220 coupled to the dispensing apparatus 210, although example embodiments are not limited thereto). The dispensing apparatus 210 is configured to dispense a septic treatment composition 202 through the outlet port 216 and out of the dispensing apparatus 210, for example, based on operating the dispenser device 212 to dispense septic treatment composition 202 out of the dispensing apparatus 210 through the outlet port 216.

The dispenser device 212 may be configured to dispense (e.g., selectively dispense) an amount of septic treatment composition 202 that is a particular amount (e.g., a particular volume, particular mass, etc.) so that the dispensing apparatus 210 may dispense a particular amount of septic treatment composition 202, received at the inlet port 217, through the outlet port 216 (e.g., repeatedly at a fixed time interval or frequency). For example, in some example embodiments, the amount of septic treatment composition 202 as described herein that is dispensed by the dispenser device 212 when the dispenser device 212 is operated in a dispensing operation may be a particular volume (e.g., 3 oz, 12 oz, etc.) of septic treatment composition 202, and the dispenser device 212 may be configured to be operated (e.g., may be configured to operate for a particular period of time) to cause the particular amount of septic treatment composition 202 to be dispensed through the outlet port 216. An individual operation of the dispenser device 212 for a particular duration and/or to dispense a particular amount of septic treatment composition 202 through the outlet port 216 may be referred to as an individual dispensing operation performed by the dispensing apparatus 210.

In some example embodiments, the dispensing apparatus 210 includes circuitry 218. The circuitry 218 may be at least partially within the interior space defined by the housing 201, although example embodiments are not limited thereto. The circuitry 218 may include a controller 218A, a communication interface 218B, and a power supply 218C; however, example embodiments are not limited thereto, and one or more of such circuitry components may be omitted.

The controller 218A may be configured to operate (e.g., actuate) the dispenser device 212 to cause a particular amount of the septic treatment composition 202 (e.g., septic treatment composition 202 received at the inlet port 217) to be dispensed through the outlet port 216 without manual intervention. For example, the controller 218A may be configured to cause an electrical signal to be generated and transmitted to the dispenser device 212 to cause the dispenser device 212 to operate (e.g., actuate a valve thereof from a closed position to an open position, operate a pump, etc.) for a period of time (e.g., a particular, or alternatively a predetermined period of time), to thus cause a particular amount of the septic treatment composition 202 to be dispensed through the outlet port 216 and thus to be dispensed out of the dispensing apparatus 210 in a controlled manner.

The controller 218A may include a memory (e.g., a solid-state drive, or SSD) storing a program of instructions, and the controller 218A may include a processor (e.g., a Central Processing Unit, or CPU) configured to execute the program of instructions to implement any functionality of the controller 218A, the dispensing apparatus 210, or any portion thereof. However, example embodiments are not limited thereto. For example, in some example embodiments, the controller 218A may include circuitry that is configured to implement a timer circuit (e.g., a clock, timer, or any combination thereof) and is configured to generate a signal to operate the dispenser device 212 based on the timer circuit counting a particular time interval. It will be understood that, where the dispensing apparatus 210 is described herein to perform or be configured to perform any operation, the controller 218A may be configured to implement and/or control one or more portions, devices, elements, or the like of the dispensing apparatus 210 (e.g., based on executing a program of instructions) to cause the dispensing apparatus 210 to perform any operations according to any of the example embodiments.

In some example embodiments, the controller 218A is configured to operate the dispenser device 212 to cause the dispenser device 212 to dispense an amount of septic treatment composition 202 through the outlet port 216 to be dispensed (e.g., provided) to one or more portions of the septic waste system 102 (e.g., into the septic tank 110 through at least a portion of the drain line system 130). In some example embodiments, the controller 218A may be configured to generate a signal to cause at least a portion of the dispenser device 212 to operate (actuate) to dispense septic treatment composition 202 therethrough for a particular period of time that is associated, at the controller 218A, with performing a dispensing operation to cause a particular amount of septic treatment composition 202 to be dispensed by the dispensing apparatus 210.

The controller 218A may cause a particular amount of septic treatment composition 202 to be dispensed based on accessing a look-up table that is stored in a memory of the controller 218A, where the look-up table is empirically generated and associates a period of time (duration) of operation of at least a portion of the dispenser device 212 (e.g., a period of time of generation of a control signal) with dispensing (e.g., selective dispensing) of a corresponding amount of septic treatment composition 202 by the dispenser device 212. The controller 218A may determine a particular amount of septic treatment composition 202 to be dispensed, access the look-up table to determine a corresponding duration or period of applied control signal to the dispenser device 212, and then generate a control signal that is transmitted to the dispenser device 212 to cause at least a portion of the dispenser device 212 to be operated for the corresponding duration or period.

However, example embodiments are not limited thereto, and in some example embodiments, the controller 218A may cause the dispensing apparatus 210 to perform a particular, selected dispensing operation sequence 912 that includes causing the dispenser device 212 to operate for a particular duration at a particular frequency to perform each of a sequence of dispensing operations, performed at a particular frequency or interval, for a particular quantity (e.g., maximum quantity) of dispensing operations. The controller 218A may perform a particular (e.g., selected) dispensing operation sequence based on processing a control signal received at the dispensing apparatus 210 through the communication interface 218B.

In some example embodiments, the controller 218A is configured to operate the dispenser device 212 to perform a selected dispensing operation sequence 912 to cause an amount of septic treatment composition 202 received at the inlet port 217 (e.g., 3 oz, 12 oz, etc.) to be dispensed (e.g., to perform a dispensing operation) in response to an elapse of a particular period of time (e.g., 1 day, 7 days, etc.) (e.g., at a particular frequency or interval) for at least a particular quantity (e.g., a maximum dispensing operation quantity) of dispensing operations. The controller 218A may be configured to control the dispenser device 212 to perform dispensing operations that each cause dispensation of a particular amount (or substantially the particular amount) of septic treatment composition 202 through the outlet port 216, where the particular amount is a separate amount of septic treatment composition, to be dispensed per dispensing operation, that is associated with the selected dispensing operation sequence 912. The controller 218A may be configured to operate the dispenser device 212 repeatedly upon repeated elapse of the particular period of time (e.g., the separate dispensing operation frequency of the dispensing operation sequence), which may be referred to as a “fixed time interval” (e.g., a fixed time interval of 7 days). In some example embodiments, the controller 218A may be configured to perform the selected dispensing operation sequence 912 for up to a maximum dispensing operation quantity of dispensing operations associated with the selected dispensing operation sequence 912.

The controller 218A may, in response to determining that a quantity of dispensing operations performed by the dispensing apparatus 210 according to the selected dispensing operation sequence 912 has reached the maximum dispensing operation quantity associated with the selected dispensing operation sequence 912, determine that the selected dispensing operation sequence is completed and, in response, inhibit further operation of the dispenser device 212 until receiving and processing a new control signal. For example, the controller 218A may cause the dispensing apparatus 210 to perform a particular, selected dispensing operation sequence 912 based on processing a control signal received at the dispensing apparatus 210 through the communication interface 218B, where the selected dispensing operation sequence 912 is associated with a dispensing operation amount of 3 oz of septic treatment composition 202, a dispensing operation frequency of 7 days, and a maximum dispensing operation quantity of 12 dispensing operations, so that the controller 218A performs the selected dispensing operation sequence 912 to cause the dispensing apparatus 210 to dispense 3 oz of septic treatment composition 202 every 7 days (e.g., every 1 week) for a period of 12 weeks. Upon performing the 12^{th} dispensing operation according to the selected dispensing operation sequence, the controller 218A may inhibit the dispensing apparatus 210 from performing further dispensing operations until a new control signal is received and processed to initiate performance of a selected dispensing operation sequence (which may be the same or a different dispensing operation sequence).

The controller 218A may be configured to repeatedly operate the dispenser device 212 at a fixed time frequency or interval (dispensing operation frequency) associated with a dispensing operation sequence being performed based on monitoring a timer that increments a timer value at a fixed frequency, operating the dispenser device 212 in response to the timer value reaching a particular time value corresponding to the elapse of the particular frequency or interval (e.g., 7 days), and resetting the timer value to an initial timer value (e.g., 0 days) in response to operating the dispenser device 212. For example, the controller 218A may include and/or implement a clock and/or timer that counts a period of elapsed time from an initial timer value (e.g., increments from 0 days) at a fixed frequency (e.g., counts days, hours, minutes, and/or seconds at a fixed frequency of days, hours, minutes, and/or seconds). In response to determining that a threshold timer value is reached (e.g., a timer value corresponding to the particular period of time and/or fixed time interval of 7 days), the controller 218A may generate and/or transmit a signal to the dispenser device 212 to cause the dispenser device 212 to operate for at least a particular (e.g., predetermined) period of time to cause an amount (e.g., a particular amount) of the septic treatment composition 202 to be dispensed through the outlet port 216 and further reset the timer value so that the controller 218A may subsequently cause the dispenser device 212 to dispense another amount of the septic treatment composition 202 upon a re-elapse of the particular period of time (frequency, interval, etc.) associated with the dispensing operation sequence being performed.

In some example embodiments, the controller 218A is configured to implement a counter that increments a counter value, starting from an initial counter value (e.g., 0), in response to each operation of the dispenser device 212 (e.g., each dispensing operation performed by the dispensing apparatus 210). The counter thereby enables the controller 218A to track the quantity of dispensing operations performed according to the selected dispensing operation sequence 912. As a result, where the controller 218A repeatedly operates the dispenser device 212 at a fixed dispensing operation frequency associated with a selected dispensing operation sequence 912, the controller 218A may track the number (e.g., quantity) of dispensing operations performed according to the selected dispensing operation sequence 912 from an initial counter value (e.g., a zero value, such as zero (0)) over time. The controller 218A may track the counter value to determine when the total quantity of dispensing operations performed by the dispensing apparatus 210 according to a dispensing operation sequence 912 reaches a maximum dispensing operation quantity associated with the selected dispensing operation sequence 912 (e.g., the counter value equals the maximum dispensing operation quantity value) and may generate a signal (e.g., a depletion signal) in response to the counter value reaching a threshold quantity (also referred to herein as a depletion threshold value). The dispensing apparatus 210 may be configured to transmit the signal to the computing device 400 through the communication link 802A. The depletion threshold value may equal the maximum dispensing operation quantity value associated with the dispensing operation sequence or may be less than the maximum dispensing operation quantity value by a particular quantity. For example, the controller 218A may be configured to transmit the depletion signal in response to determining that the counter value (and thus the quantity of dispensing operations performed according to the selected dispensing operation sequence 912) equals a depletion threshold value that is 1 or 2 less than the maximum dispensing operation quantity, such that the depletion signal may be transmitted prior to the selected dispensing operation sequence 912 being completed. The controller 218A may determine the depletion threshold value based on processing a control signal that causes the controller 218A to operate the dispensing apparatus 210 according to a selected dispensing operation sequence 912 and/or may be determined based on loading information stored in a memory of the controller 218A.

However, example embodiments are not limited thereto, and in some example embodiments the controller 218A may be configured to perform this process repeatedly so long as electrical power is supplied to the controller 218A (e.g., from power supply 218C), so that the process may be performed (e.g., repeatedly at a fixed time interval) without human intervention.

Additionally, the controller 218A may be configured to cause the counter value to be reset to an initial counter value (e.g., 0) in response to processing a received control signal to initiate performance of a dispensing operation sequence 912.

Still referring to FIGS. 1 to 4, the circuitry 218 of the dispensing apparatus 210 may include a communication interface 218B that is communicatively coupled to the controller 218A. It will be understood that the communication interface 218B may be separate from the controller 218A as shown or may be included in and/or implemented by the controller 218A. The communication interface 218B may be any known network communication transceiver, including a wireless network communication transceiver such as a Wi-Fi transceiver, a 5G cellular network communication transceiver, an ad hoc network communication transceiver such as a Bluetooth transceiver, any combination thereof, or the like.

The communication interface 218B may be configured to establish a communication link 302A (which may be a wired network communication link, a wireless network communication link, an ad hoc wireless network communication link, or the like) with a communication network 300 as described herein and may engage in one-way or two-way communication with one or more computing devices via the communication link 302A with the communication network 300. As described herein, the communication network 300 may be any known wireless and/or wired communication network.

In some example embodiments, the controller 218A may be configured to cause the dispensing apparatus 210 to communicate (send and/or receive) signals over the communication link 302A that indicate operations of the controller 218A (e.g., indicating operation of the dispenser device 212 at particular points in time, a present timer value, a present counter value, a selected dispensing operation sequence 912 currently or most recently performed by the dispensing apparatus 210, a present quantity of dispensing operations performed by the dispensing apparatus 210 according to the selected dispensing operation sequence 912, any combination thereof, or the like). In some example embodiments, the controller 218A may be configured to cause the dispensing apparatus 210 to communicate (e.g., transmit) one or more signals (e.g., a depletion signal generated in response to the counter value reaching a threshold quantity value or maximum dispensing operation quantity value associated with a currently performed dispensing operation sequence) to a separate computing device (e.g., computing device 400) via the communication link 302A.

In some example embodiments, the controller 218A may be configured to cause the dispensing apparatus 210 to perform one or more dispensing operations according to or independently of a selected dispensing operation sequence 912 based on processing one or more control signals received from a remote device (e.g., computing device 400) via at least the communication link 302A at the communication interface 218B. For example, the controller 218A may be configured to cause the counter value of the counter of the dispensing apparatus 210 to be reset to an initial counter value (e.g., 0) in response to receiving, at the communication interface 218B, a control signal from the remote computing device 400 via the communication link 302A.

The power supply 218C may be configured to supply electrical power to devices included therein, including the dispenser device 212, the controller 218A, the communication interface 218B, an internal sensor included in the dispensing apparatus 210, or the like. The power supply 218C may include a battery, which may include any known rechargeable battery (e.g., a lithium-ion battery). In some example embodiments, the power supply 218C may include a wired power connection that may be configured to couple to a power outlet provided at the structure 104 and/or any appliance 120. The power supply 218C may further include a charging circuit that may be configured to recharge a battery from the wired power connection and may be configured to enable the battery to supply power to operate the dispenser device 212 in the absence of electrical power being received via the wired power connection.

Still referring to FIGS. 1 to 4, the outlet port 216 of the dispensing apparatus 210 may be coupled in fluid communication with a septic tank 110 of a septic waste system 102 through one or more drain lines defining at least a portion of the drain line system 130, to establish a fluid communication pathway 290 between the dispensing apparatus 210 and the septic tank 110 through at least a portion of the drain line system 130. For example, the outlet port 216 may be coupled to a first end 232 of a conduit 230, and an opposite second end 234 of the conduit 230 may be coupled to an adaptor 240 that may be coupled to an appliance 120 or an appliance drain line 128 that establishes fluid communication between the appliance 120 and one or more drain lines of the drain line system 130, where the adaptor 240 may be coupled to the drain line independently of the appliance 120 such that the appliance 120 is excluded from the fluid communication pathway 290 between the dispensing apparatus 210 and the septic tank 110. The conduit 230 may comprise any known flexible or rigid tubing having opposite ends 232 and 234 and defining a pathway therebetween.

It will be understood that the one or more drain lines at least partially defining the drain line system 130 and at least partially defining fluid communication between the dispensing apparatus 210 and the septic tank 110 may include at least one of an appliance drain line 128, a greywater drain line 132, or a blackwater drain line 134 (e.g., as shown in FIGS. 3A and 3B). It will be understood that any of the drain lines in the drain line system 130, including any of an appliance drain line 128, a greywater drain line 132, or a blackwater drain line 134 therein, may be referred to herein as a “wastewater” drain line or a “waste” drain line (e.g., a greywater wastewater drain line, a blackwater wastewater drain line, a greywater waste drain line, a blackwater waste drain line, etc.).

The outlet port 216 of the dispensing apparatus 210 may be coupled in fluid communication with the septic tank 110 through a fluid communication pathway 290 that may include at least a portion of the drain line system 130, an adaptor 240, a conduit 230, an appliance 120, any combination thereof, or the like. As a result, a septic treatment system 1000 that includes the dispensing apparatus 210 may be configured to dispense one or more septic treatment compositions 202 into the septic tank 110 through one or more wastewater drain lines of the drain line system 130, for example, based on the computing device 400 of the septic treatment system 1000 causing the dispensing apparatus 210 to dispense the one or more septic treatment compositions 202 through the outlet port 216 according to a selected dispensing operation sequence 912.

Referring to FIGS. 2, 3A, and 3B, the dispensing apparatus 210 may be coupled through an adaptor 240 to one or more drain lines of the drain line system 130 through various appliances, drain lines, appliance drain lines, or any combination thereof. As shown, the dispensing apparatus 210 may be coupled in fluid communication with the drain line system 130, to at least partially define the fluid communication pathway 290 between the outlet port 216 and the septic tank 110 through at least a portion of the drain line system 130, via a fluid coupling 204.

As shown in FIGS. 2 and 3A, the fluid coupling 204 may include a drain line coupling 204A of the dispensing apparatus 210 (e.g., outlet port 216 thereof) with an appliance drain line 128 of an appliance 120, where the appliance drain line 128 couples an appliance drain of the appliance 120 in fluid communication with the septic tank 110 through the drain line system 130, and wherein the drain line coupling 204A includes a connection with the appliance drain line 128 independently of the appliance 120 so that the drain line coupling 204A establishes fluid communication between the dispensing apparatus 210 and the drain line 128 (e.g., via conduit 230, adapter 240, or any combination thereof) independently of the appliance 120. Accordingly, the dispensing apparatus 210 may be configured to dispense septic treatment composition 202 that is directed to the septic tank 110 through the drain line system 130 independently of any appliance 120 based on being directed through the drain line coupling 204A.

Referring to FIGS. 2 and 3A, a dispensing apparatus 210 may be coupled to an adaptor 240 via a conduit 230 coupled between the outlet port 216 of the dispensing apparatus 210 and the adaptor 240, where the adaptor 240 is coupled to an access port 242 in a sidewall of an appliance drain line 128 extending from an appliance drain 122a of an appliance 122 so as to be coupled to the appliance drain line 128 between the appliance 122 and the septic tank 110 at a location that is downstream from a drain of the appliance 122, to thereby establish a drain line coupling 240A of the dispensing apparatus 210 (e.g., outlet port 216 thereof) with the drain line interior 128V independently of the appliance 120 that is coupled in fluid communication with the septic tank 110 through at least said drain line interior 128V of the appliance drain line 128. The appliance drain line 128 may be considered to be included within the one or more drain lines of the drain line system 130. As shown in FIG. 3A, an appliance 122 may be an appliance configured to discharge greywater waste (also referred to herein as greywater, greywater wastewater, or the like). The appliance 122 is shown to be a sink, but example embodiments are not limited thereto; for example, the appliance 122 may include a shower, washing machine, dishwasher, or the like.

The adaptor 240 that may couple the dispensing apparatus 210 to an appliance drain line 128 (e.g., independently of the appliance 120 configured to discharge waste into the drain line 128) may include an elbow nozzle 244 that is configured to extend through an access port 242 in a sidewall of the appliance drain line 128 and is further configured to curve within the drain line interior 128V so that an outlet of the elbow nozzle 244 faces in a downwards direction that is at least partially in a direction of gravity G, so that the adaptor 240 is configured to discharge septic treatment composition 202 received from the dispensing apparatus 210 via conduit 230 in the downwards direction through at least a portion of the appliance drain line 128 towards the septic tank 110 through at least a portion of the drain line system 130 (e.g., greywater drain line 132).

As further shown in FIG. 3A, the appliance drain line 128 may include a p-trap 128P between the appliance drain 122a and the greywater drain line 132, and the adaptor 240 may be configured to be coupled to an access port 242 in the appliance drain line 128 sidewall at a location that is between the appliance drain 122a and the p-trap 128P. As a result, the adaptor 240 may be configured to discharge a flow and/or amount of a septic treatment composition 202 received at the adaptor 240 from a dispensing apparatus 210 coupled to the adaptor 240 into the appliance drain line 128 in a downward direction towards the p-trap 128P within the drain line interior 128V of the appliance drain line 128. Based on being configured to discharge the septic treatment composition 202 in the drain line in the downward direction at least partially in the direction of gravity G as shown, the adaptor 240 may be configured to reduce, minimize, or prevent splashing of the septic treatment composition 202 upwards, against the direction of gravity, towards the appliance drain 122a (e.g., upwards through the drain of a single appliance 122). The adaptor 240 may direct septic treatment composition 202 received from the dispensing apparatus 210 (e.g., via the conduit 230) to flow through the appliance drain line 128 to the greywater drain line 132 and thus to flow (e.g., to be dispensed) to the septic tank 110 via the drain line system 130 and septic tank influent port 154A.

As shown in FIGS. 2 and 3B, the fluid coupling 204 may include an appliance coupling 204B of the dispensing apparatus 210 (e.g., outlet port 216 thereof) with an appliance 120 that is coupled in fluid communication with the septic tank 110 through the drain line system 130 (including an appliance drain line 128 connected to an appliance drain of the appliance 120), and wherein the appliance coupling 204B establishes fluid communication between the outlet port 216 of the dispensing apparatus 210 and the drain line system 130 through at least a portion of the appliance 120, including an appliance drain thereof that is connected to an appliance drain line 128 of the drain line system 130. Accordingly, the dispensing apparatus 210 may be configured to dispense septic treatment composition 202 that is directed to the septic tank 110 through the appliance 120 and further from the appliance 120 and through the drain line system 130.

Referring to FIGS. 2 and 3B, a dispensing apparatus 210 may be coupled to an adaptor 240 via a conduit 230 coupled between the outlet port 216 of the dispensing apparatus 210 and the adaptor 240, where the adaptor 240 is coupled to an appliance 124 and is configured to direct septic treatment composition 202 received at the adaptor 240 to flow into at least a portion of the appliance 124 so as to flow into a blackwater drain line 134 of the drain line system 130 through a drain 124b of the appliance 124. As shown, the blackwater drain line 134 may serve as an appliance drain line 128 of the appliance 124. The appliance 124 may be an appliance that is configured to discharge blackwater waste (also referred to herein as blackwater, blackwater wastewater, or the like) and/or solid organic waste (e.g., feces, urine, etc.). For example, as shown in FIG. 3B, the appliance 124 may be a toilet. However, example embodiments are not limited thereto.

As shown, the adaptor 240 may include a nozzle 248 and a coupling surface 246 that is configured to be coupled (e.g., adhered, via an adhesive on the coupling surface 246) to a surface of the appliance 124 to position the nozzle 248 to face toward a portion of the appliance 124 that is in fluid communication with the drain 124b. For example, in FIGS. 2 and 3B where the appliance 124 is a toilet, the adaptor 240 may be configured to be adhered to a surface of the bowl 124a so that the nozzle 248 of the adaptor 240 faces towards the bowl 124a and is configured to direct a septic treatment composition 202 received from the dispensing apparatus 210 coupled to the adaptor 240 into the bowl 124a to flow through the drain 124b into the interior 134V of the blackwater drain line 134 and to further flow through the drain line system 130 to the septic tank 110.

While FIGS. 3A and 3B illustrate a dispensing apparatus 210 being coupled in fluid communication with a drain line system 130 through either a drain line coupling 204A or an appliance coupling 204B (FIG. 3B), it will be understood that example embodiments are not limited thereto. In some example embodiments, a dispensing apparatus 210 may be coupled in fluid communication with the drain line system 130 through both a drain line coupling 204A with an appliance drain line 128 independently of an appliance 120 and also an appliance coupling 204B, where the drain line coupling 204A may couple with the same or different appliance drain line 128 as the appliance drain line 128 configured to carry waste discharged from the appliance 120 that receives septic treatment composition 202 through the appliance coupling 204B. Accordingly, a dispensing apparatus 210 may be configured to dispense septic treatment composition to flow in various fluid pathways (e.g., parallel pathways) to pass into the drain line system 130 via multiple various fluid couplings 204.

While example embodiments shown in FIGS. 2, 3A, and 3B illustrate a dispensing apparatus 210 being coupled in fluid communication with the drain line system 130 and thus the septic tank 110 via a fluid coupling 204 that includes at least a conduit 230 and an adaptor 240, it will be understood that example embodiments of a fluid coupling 204 are not limited thereto. For example, in some example embodiments, the dispensing apparatus 210 may have an outlet port 216 that may be configured to couple directly with an appliance 120 or an appliance drain line 128 so that the dispensing apparatus 210 is configured to dispense septic treatment composition 202 into the drain line system 130 in an appliance coupling 204B or a drain line coupling 204A without using any adaptor 240 or conduit 230. In some example embodiments, the dispensing apparatus 210 may have an outlet port 216 that may be configured to couple directly with an adaptor 240 without using any conduit 230.

While the adaptor 240 in FIG. 3A is shown to couple to an access port 242 in an appliance drain line 128, it will be understood that such an adaptor 240 may couple with an access port 242 formed in a sidewall of any drain line in the drain line system 130 to establish fluid communication (e.g., a fluid communication pathway 129) between the dispensing apparatus 210 and the septic tank 110 through at least a portion (e.g., through one or more drain lines) of the drain line system 130.

It will be understood that the adaptor 240 that may couple the outlet port 216 of the dispensing apparatus 210 in fluid communication with an appliance 120 or a drain line (e.g., at least one of an appliance drain line 128, a greywater drain line 132, or a blackwater drain line 134 of the drain line system 130) may include any of the adaptors as described and/or illustrated in U.S. Pat. No. 12,140,337, U.S. Pat. No. 12,379,133, U.S. Pat. No. 12,331,867, or any combination thereof, and is incorporated by reference herein. It will be understood that the access port 242 may be formed, and the adaptor 240 coupled therewith (e.g., to at least partially insert nozzle 244 therethrough) according to any of the methods and/or installation guide devices as described and/or illustrated in U.S. Pat. No. 12,140,337, U.S. Pat. No. 12,379,133, U.S. Pat. No. 12,331,867, or any combination thereof, the methods and installation guide devices used to perform such methods being incorporated by reference herein. However, it will be understood that example embodiments of the adaptor 240 and the methods for installing same are not limited thereto. For example, in some example embodiments, an adaptor 240 configured to extend a nozzle 244 through an access port 242 formed in a sidewall of a drain line (including, for example, appliance drain line 128) may be formed partially or entirely of a flexible material and/or may include a strap that wraps around the drain line to secure to one or more portions of the adaptor 240 to hold (secure) the adaptor 240 against the sidewall of the appliance drain line 128, where the adaptor 240 may include a nozzle 244 that may extend through the access port 242 based on the strap being wrapped around the drain line to secure to one or more portions of the adaptor 240 to hold (secure) the adaptor 240 against the sidewall of the appliance drain line 128.

Referring to FIGS. 1-4, in some example embodiments, the dispensing apparatus 210 is configured to receive septic treatment composition 202 from a container, also referred to as a cartridge 220. The cartridge 220 may include an internal cartridge reservoir 224 holding an amount of a septic treatment composition 202. The cartridge 220 may be configured to be coupled (directly or indirectly) to the dispensing apparatus 210 to establish fluid communication between the cartridge reservoir 224 and the inlet port 217 of the dispensing apparatus 210. As a result, the dispensing apparatus 210 may be configured to dispense a septic treatment composition 202 based on receiving the septic treatment composition 202 from the cartridge 220.

For example, as shown in FIG. 4, the dispensing apparatus 210 may be configured to couple with a cartridge 220, where the cartridge 220 may include a housing 221 at least partially defining an internal cartridge reservoir 224 that may hold a volume of a septic treatment composition 202 therein. The cartridge 220 may further include an outlet port 228. As shown, the cartridge 220 may include an outlet conduit 226 having one or more apertures 226a at one end and coupled to the outlet port 228 at an opposite end, such that the cartridge 220 is configured to enable septic treatment composition to be drawn out of the cartridge 220 through the outlet conduit 226. However, example embodiments are not limited thereto, and in some example embodiments, the outlet conduit 226 may be omitted.

The dispensing apparatus 210 may include a connector 214 that may be configured to couple (e.g., detachably couple, removably couple, reversibly couple, etc.) with a connector 223 of the cartridge 220 (e.g., a complementary connector at least partially defining the outlet port 228, although example embodiments are not limited thereto) in order to establish fluid communication between the internal cartridge reservoir 224 of the cartridge 220 and the inlet port 217. As shown in FIGS. 2, 3A, 3B, and 4, the dispensing apparatus 210 and the cartridge 220 may be structured so that when the cartridge 220 is coupled to the dispensing apparatus 210, the coupled dispensing apparatus 210 and cartridge 220 collectively define a dispensing system 200 configured to dispense septic treatment composition 202 held in the cartridge reservoir 224 of the coupled cartridge 220 out of the outlet port 216 of the dispensing apparatus 210 according to a selected dispensing operation sequence 912.

As shown in FIGS. 3A and 3B, the cartridge 220 may be configured to rest on a surface 150 so as to support the dispensing apparatus 210 above the cartridge 220 when the dispensing apparatus 210 and the cartridge 220 are coupled together. For example, as shown in FIG. 3A, in example embodiments where the dispensing apparatus 210 is coupled at the outlet port 216 with an appliance drain line 128 and is also coupled to a cartridge 220, and where the appliance drain line 128 is at least partially located within a cabinet structure 126, the cartridge 220 may rest on a surface 150 defined by a floor of the cabinet interior adjacent to the appliance drain line 128. In another example, as shown in FIG. 3B, in example embodiments where the dispensing apparatus 210 is coupled at the outlet port 216 with an appliance 124, the cartridge 220 may rest on a surface 150 defining a floor adjacent to the appliance 124. However, it will be understood that example embodiments of a dispensing system 200 that includes a coupled dispensing apparatus 210 and cartridge 220 are not limited to example embodiments where the cartridge 220 rests on a surface 150 to support the dispensing apparatus 210 thereabove. For example, the dispensing apparatus 210 may be configured to rest on a surface 150 and support a coupled cartridge 220 above the dispensing apparatus 210.

In some example embodiments, the dispensing apparatus 210 may be configured to be coupled to one of various cartridges 220 that may have different dimensions, sizes, and/or shapes and thus may have different sizes of internal cartridge reservoirs 224 to hold different amounts of one or more septic treatment compositions 202. For example, in some example embodiments, the dispensing apparatus 210 may be configured to couple to cartridges 220 having an internal cartridge reservoir 224 volume of about 36 oz and may be further configured to couple to cartridges 220 having an internal cartridge reservoir 224 volume of about 72 oz.

While example embodiments shown herein illustrate the dispensing system(s) 200 as being coupled in fluid communication with the septic tank 110 through the drain line system 130 such that the dispensing system 200 dispenses septic treatment composition(s) 202 to the septic tank 110 through the drain line system 130, it will be understood that example embodiments are not limited thereto. For example, a dispensing system 200 may be coupled in fluid communication to the septic tank interior 151 independently of the drain line system 130, the septic tank influent port 154A, or any combination thereof.

Still referring to FIGS. 1 and 4, the dispensing apparatus 210 may be configured to couple with one cartridge 220 from among a plurality of cartridges 720. The plurality of cartridges 720 may include a plurality of cartridge groups 722 of cartridges 220. Each cartridge 220 of the plurality of cartridges 720 may be associated with one cartridge group of the plurality of cartridge groups 722, and each cartridge group 722 may be associated with a separate cartridge group identifier code (also referred to herein interchangeably as a cartridge group identifier) among a plurality of cartridge group identifier codes. The plurality of cartridges 720, including the plurality of cartridge groups 722, may be provided (distributed, delivered, shipped, etc.) from a cartridge distribution system 700, including, for example, one or more distribution centers and/or warehouses.

Each separate cartridge group 722 of cartridges 220 may have a different property or “cartridge type.” For example, cartridges in different cartridge groups 722 may have different sizes (e.g., different volumes of internal cartridge reservoir 224), different septic treatment compositions 202 held in respective internal cartridge reservoirs 224, or any combination thereof.

The plurality of cartridge groups 722 may hold different, respective septic treatment compositions 202, such that cartridges 220 included in different cartridge groups 722 hold different septic treatment compositions 202. In some example embodiments, each separate septic treatment composition 202 includes an amount of one or more types or “strains” of microorganisms, including, for example, one or more strains of bacteria (e.g., as an aqueous mixture that includes the amount of the one or more types of microorganisms in a mixture with at least water), and different, respective septic treatment compositions 202 held in cartridges 220 of different cartridge groups 722 may include different concentrations of the one or more microorganisms (e.g., different concentrations of the one or more strains of bacteria). For example, different septic treatment compositions 202 held by respective cartridges 220 of different cartridge groups 722 may include respective blends (e.g., in at least water) of a particular plurality of particular strains of Bacillus bacteria designed to target a wide range of organics (e.g., organic waste) across a wide range of applications, where such blends may each include a blend of individually fermented Bacillus bacteria strains that are blended and are produced under the ISO 9001:2015 standard, and further where respective blends of different septic treatment compositions 202 (e.g., septic treatment compositions 202A, 202B, 202C, etc.) may include different concentrations of such blends of Bacillus bacteria, so that cartridges 220 of different cartridge groups 722 may include different concentrations or amounts per unit of volume of such blends of septic treatment composition held in the respective internal cartridge reservoirs 224 of such cartridges 220.

For example, referring to FIG. 4 (and further referring to FIGS. 11A to 11C), a plurality of cartridges 720 that may each be configured to couple with a dispensing apparatus 210 may include different, first to third cartridge groups 722A, 722B, and 722C, that include separate, respective pluralities of first cartridges 220A, second cartridges 220B, and third cartridges 220C, respectively. The first to third cartridges 220A to 220C may each include a different septic treatment composition 202 held therein, a different internal cartridge reservoir 224 volume, or any combination thereof.

The first cartridge group 722A may include first cartridges 220A that each hold a first septic treatment composition 202A. The first septic treatment composition 202A may include an aqueous mixture that includes a first concentration of microorganisms that includes a multi-strain blend of particular strains of Bacillus bacteria, and the first cartridges 220A may each have an internal cartridge reservoir 224 configured to hold a first volume of 36 oz of septic treatment composition, such that the first cartridges 220A may each hold an amount of a first septic treatment composition 202A having about 1.0 trillion to about 1.5 trillion colony-forming units (CFU) of a particular multi-strain blend of Bacillus bacteria in a reservoir 224 having a first volume of 36 oz.

The second cartridge group 722B may include second cartridges 220B that each hold a second septic treatment composition 202B that is different from the first septic treatment composition 202A. The second cartridges 220B may each have an internal cartridge reservoir 224 configured to hold a second volume of 36 oz of septic treatment composition, and the second septic treatment composition 202B may include an aqueous mixture that includes a second concentration of the microorganisms that include a multi-strain blend of the particular strains of Bacillus bacteria, such that the second cartridges 220B may each hold an amount of a second septic treatment composition 202B having about 500 billion to about 750 billion CFU of a multi-strain blend of the particular strains of Bacillus bacteria in a reservoir 224 having a second volume of 36 oz. The third cartridge group 722C may include third cartridges 220C that each hold a third septic treatment composition 202C that is different from the first and second septic treatment compositions 202A and 202B.

The third cartridges 220C may each have an internal cartridge reservoir 224 configured to hold a third volume of 72 oz, which is different from the first and second volumes, and the third septic treatment composition 202C may include an aqueous mixture that includes a third concentration of the microorganisms that include a third multi-strain blend of the particular strains of Bacillus bacteria, such that the third cartridges 220C may each hold an amount of a third septic treatment composition 202C having about 350 billion to about 450 billion CFU of the particular multi-strain blend of Bacillus bacteria in a reservoir 224 having the third volume of 72 oz. In some example embodiments, the third cartridges 220C may each hold the second septic treatment composition 202B in the internal cartridge reservoir 224 configured to hold a third volume of 72 oz, which is different from the first and second volumes.

Each separate cartridge group 722, and the respective cartridges 220 included in each separate cartridge group 722, may be associated with a separate, particular cartridge group identifier code that uniquely identifies the respective cartridges 220 as being associated with the cartridge group 722 and/or one or more particular properties of the cartridge group 722. In some example embodiments, the plurality of cartridge groups 722 are associated with separate, respective dispensing operation sequences 910 that may be performed by the dispensing apparatus 210 to dispense septic treatment composition 202. It will be understood that each separate dispensing operation sequence of the plurality of dispensing operation sequences 910 may be associated with at least one of a separate dispensing operation frequency, a particular amount of septic treatment composition dispensed per dispensing operation, or a separate maximum dispensing operation quantity. As a result, the plurality of dispensing operation sequences 910, which may each be associated with at least one of a separate dispensing operation frequency, a particular amount of septic treatment composition dispensed per dispensing operation, or a separate maximum dispensing operation quantity, may be associated with separate, respective cartridge group identifier codes among a plurality of cartridge group identifier codes that are each associated with a separate cartridge group 722 of the plurality of cartridge groups 722.

A cartridge group identifier code that is uniquely associated with a given cartridge group 722 may indicate properties associated with the given cartridge group 722, including, for example, a particular associated dispensing operation sequence (and/or any properties thereof) to be performed by a dispensing apparatus 210 coupled to a cartridge 220 of the particular cartridge group 722, properties of the respective septic treatment composition held in the cartridge 220 of the particular cartridge group 722, a threshold cumulative dispensing operation quantity associated with the particular cartridge group 722, one or more ordering parameters associated with the particular cartridge group 722, any combination thereof, or the like.

As further shown in FIGS. 1 and 4, each respective cartridge 220 may include a cartridge identifier 222 that is configured to indicate a particular cartridge group identifier code that is associated with (e.g., uniquely associated with, uniquely identifies, etc.) the particular cartridge group 722 that includes the respective cartridge 220. For example, the cartridge identifier 222 of a respective cartridge 220 may present a visible pattern and/or may be configured to transmit a signal representing cartridge data, which may be processed to detect the particular cartridge group identifier code associated with the respective cartridge 220 by virtue of being associated with a particular cartridge group 722 that includes the respective cartridge 220. The cartridge identifier 222 thus may be understood to be configured to provide cartridge data, including a cartridge group identifier code, which enables the particular cartridge group 722 of the cartridge 220 and/or one or more properties associated therewith (e.g., a particular associated dispensing operation sequence 910) to be identified and thus to enable a selected dispensing operation sequence 912 to be selected from among at least the plurality of dispensing operation sequences 910 and used by a particular dispensing apparatus 210 to dispense the respective septic treatment composition 202 from the respective cartridge 220.

For example, cartridge data provided by a cartridge identifier 222 of a respective cartridge 220 (e.g., based on a sensor device being a camera that captures an image of a visible pattern presented by the cartridge identifier 222, and the image of the visible pattern being processed to obtain the cartridge data) may be processed to detect a particular cartridge group identifier code associated with the respective cartridge 220 and/or a cartridge group 722 including the same. For example, the cartridge identifier 222 of a respective cartridge 220 may be configured to provide cartridge data, for example, in the form of a visible pattern, a transmitted signal, or the like, which may be processed to detect a particular cartridge group identifier that is associated with (e.g., uniquely associated with) the particular cartridge group 722 that includes the respective cartridge 220. The particular cartridge group identifier code may be an alphanumeric code, a data code, or the like.

The cartridge identifier 222 may be one of various types of indicators, indicator devices, etc., as described herein. In some example embodiments, including the example embodiments shown in FIG. 4, the cartridge identifier 222 of a respective cartridge 220 may include a device that is at least partially visible on an outer surface of the cartridge 220, where at least the visible portion of the cartridge identifier 222 may present a visible pattern which may represent cartridge data that includes a particular cartridge group identifier code when processed. For example, the cartridge identifier 222 may include a visible pattern that is externally visible on an outer surface of the cartridge 220, where the visible pattern (e.g., an image of the visible pattern) may be processed by a computing device to detect the particular cartridge group identifier code that is associated with the cartridge 220 and/or the cartridge group 722 including the same. Such a device comprising the cartridge identifier 222 may include a sticker, label, or the like that is on (e.g., adhered to via any known adhesive or bond) the outer surface of the cartridge 220 and which displays the cartridge data in the form of a visible pattern, a printed visible pattern that is printed on the outer surface of the cartridge 220 based on ink being deposited on the outer surface, and/or based on the visible pattern being formed in the outer surface of the cartridge 220 due to patterning of the outer surface (e.g., etching, laser etching, etc. of the outer surface). The visible pattern may represent cartridge data that includes a machine-readable code that, when processed, indicates the particular cartridge group identifier code associated with the particular cartridge 220 that includes the particular cartridge identifier 222. The machine-readable code may be obtained by a separate device (e.g., user device 500 and/or computing device 400) based on the separate device generating (e.g., capturing) an image of the visible pattern and processing the image of the visible pattern to enable the separate device to obtain (e.g., detect, identify, etc.) the particular cartridge group identifier based on processing the code represented by the cartridge data. For example, the visible pattern of the cartridge identifier 222 may include a barcode, such as a quick response (QR) code, which may be processed based on a separate device capturing and processing an image of the visible pattern to obtain (e.g., identify) the particular cartridge group identifier code associated with the particular cartridge 220 that includes the particular cartridge identifier 222 and/or the particular cartridge group 722 including the particular cartridge 220.

As described herein, where a signal, information, or the like is described to “indicate” certain information, codes, or the like, it will be understood that a device such as a computing device, controller, system supported by a computing device, or the like as described herein may be configured to process the signal, information, or the like to detect, determine, etc. the certain information, codes, or the like. It will also be understood that in some example embodiments the cartridge data and the particular cartridge group identifier may be identical, such that the particular cartridge group identifier may be detected based on simply obtaining and processing the cartridge data. It will be understood that the visible pattern may be described as representing cartridge data, but in some example embodiments the visible pattern and the cartridge data may be identical to each other and may be referred to interchangeably to refer to the information, provided (e.g., transmitted, displayed, etc.) by the cartridge identifier 222, to indicate the particular cartridge group identifier that is associated with the cartridge 220 that includes the cartridge identifier 222.

In some example embodiments, the cartridge identifier 222 may include a wireless communication interface device that is configured to transmit a signal that indicates (e.g., includes, may be processed to obtain, etc.) the cartridge data to be processed by a device to determine a cartridge group identifier code. For example, the cartridge identifier 222 of a cartridge 220 may include a near-field communication (NFC) device that is configured to transmit a signal (e.g., an NFC signal) in response to an NFC field (e.g., an RF field generated by an NFC antenna of a separate device) being received at the NFC device. The transmitted NFC signal may represent cartridge data which may be processed to detect the particular cartridge group identifier code associated with the particular cartridge 220 that includes the particular cartridge identifier 222 and/or the cartridge group 722 including the particular cartridge 220. The NFC signal may be received and processed by a separate device (e.g., user device 500) to enable the separate device to obtain (e.g., detect, identify, etc.) the particular cartridge group identifier code. Such a cartridge identifier 222, which includes an NFC device, may be partially or completely obscured from visible exposure to an exterior of the cartridge 220, thereby reducing the risk of removal, alteration, and/or replacement of the cartridge identifier 222.

As shown in FIGS. 4 and 11A to 11C, different cartridges 220 included in different cartridge groups 722 may include separate, respective cartridge identifiers 222, which are each configured to provide different, respective cartridge data indicating different cartridge group identifier codes that are each associated (e.g., uniquely associated) with the separate, respective cartridge group 722 that includes the respective cartridge 220. Each respective cartridge identifier 222 of each respective cartridge 220 may thus be configured to identify (e.g., uniquely identify) the specific cartridge group 722 that includes the respective cartridge 220. As a result, a particular cartridge group 722 and/or one or more properties associated therewith (e.g., a particular associated dispensing operation sequence from among at least the plurality of dispensing operation sequences 910) may be uniquely identified based on obtaining and processing cartridge data obtained from the cartridge identifier 222 of the cartridge 220, for example, based on communication with the cartridge identifier 222, generating and processing an image of a visible pattern representing cartridge data that is present on at least an externally visible (e.g., visible externally to the cartridge 220) portion of the cartridge identifier 222, etc.

Still referring to FIGS. 1 and 4 and 11A to 11C, the plurality of cartridges 720 may include separate, respective cartridge groups 722A to 722C that are each associated with a separate cartridge group identifier code and include a respective plurality of first to third cartridges 220A to 220C having respective cartridge identifiers 222A to 222C. The first cartridge identifiers 222A on first cartridges 220A are configured to provide first cartridge data indicating a respective first cartridge group identifier code associated with the first cartridge group 722A. The second cartridge identifiers 222B on second cartridges 220B are configured to provide second cartridge data indicating a respective second cartridge group identifier code associated with the second cartridge group 722B. The third cartridge identifiers 222C on third cartridges 220C are configured to provide third cartridge data indicating a respective third cartridge group identifier code associated with the third cartridge group 722C. Accordingly, based on processing the cartridge data provided by a cartridge identifier 222 of a cartridge 220, a cartridge group identifier code associated with a particular cartridge group 722 that includes the cartridge 220 (and/or one or more properties associated with the particular cartridge group 722) may be determined, and the cartridge group identifier code may be processed to determine one or more properties associated with the cartridge group 722, including a particular dispensing operation sequence, a particular septic treatment composition, one or more particular ordering parameters, or any combination thereof.

Referring to FIGS. 1 and 4, a user device 500 may support a user (e.g., a user associated with a site 100, a septic waste system 102 at the site, a structure 104 at the site, or any combination thereof). The user device 500 may be communicatively coupled to the computing device 400 through a communication link 802C. The user device 500 may be considered to be included in the septic treatment system 1000 or may be considered to be external to the septic treatment system 1000.

The user device 500 may include a communication interface 510, a processor 520, a memory 530, a user interface 540 (e.g., a touchscreen display), a sensor device 550 (e.g., a camera, a near-field communication (NFC) transceiver, etc.) or any combination thereof. The communication interface 510 may be configured to establish a communication link 302C (e.g., a network communication link) with a communication network 300. The communication interface 510 may be any known network communication transceiver, including a wireless network communication transceiver such as a WI-FI transceiver, 5G cellular network communication transceiver, an ad hoc network communication transceiver such as a Bluetooth® transceiver, any combination thereof, or the like. The memory 530 may be a memory device (e.g., an SSD) that may store a program of instructions and the processor 520 (e.g., a CPU) may execute the program of instructions to control functionality of the user device 500. In some example embodiments, the communication interface 510 may be configured to establish a communication link 302X with the dispensing apparatus 210, which may be a link that is independent of the communication network 300 (e.g., an ad hoc network communication link, such as a Bluetooth® link). In some example embodiments, the computing device 400 may be communicatively linked with the dispensing apparatus 210 through link 302B between the computing device 400 and the communication network 300, link 302C between the communication network 300 and the user device 500, and link 302X between the user device 500 and the dispensing apparatus 210.

The sensor device 550 may include a camera or an NFC transceiver. Referring to FIG. 4, the user device 500 may be configured to control the sensor device 550 to scan a cartridge identifier 222 of a cartridge 220 (e.g., capture an image of a visible pattern provided by the cartridge identifier 222) to obtain 512 cartridge data indicated by the cartridge identifier 222 (e.g., a code represented by a visible pattern of the cartridge identifier 222 that is imaged by a camera sensor device 550). Such cartridge data may indicate a particular cartridge group identifier code associated with the cartridge 220, for example, associated with a cartridge group 722 that includes the cartridge 220. The user device 500 may transmit some or all of such cartridge data, including data indicating the cartridge group identifier code, in a cartridge data signal. The user device 500 may be further configured to provide information to a supported user through the user interface 540 (e.g., a touchscreen display) and may be configured to receive commands from a user based on user interaction with the user interface 540.

Still referring to FIG. 4, the user device 500 may be configured to control the sensor device 550 to scan an apparatus identifier 219 of a dispensing apparatus 210 (e.g., capture an image of a visible pattern provided by the apparatus identifier 219) to obtain 519 dispensing apparatus data indicated by the apparatus identifier 219 (e.g., a code represented by a visible pattern of the apparatus identifier 219 that is imaged by a camera sensor device 550). Such dispensing apparatus data may include a dispensing apparatus identifier code that may uniquely identify a particular dispensing apparatus 210 (e.g., apparatus serial number, model number, etc.). The user device 500 may transmit some or all of such dispensing apparatus data in a user account signal that may include data indicating a particular user account or user data to be associated with the dispensing apparatus 210 indicated by the dispensing apparatus data in a user account 920.

Still referring to FIGS. 1 and 4, the septic treatment system 1000 may include a computing device 400. The computing device 400 may include a communication interface 410, a processor 420, and a memory 430. The communication interface 410 may be configured to establish a communication link 302B (e.g., a network communication link) with a communication network 300. The communication interface 410 may be any known network communication transceiver, including a wireless network communication transceiver such as a WI-FI transceiver, 5G cellular network communication transceiver, an ad hoc network communication transceiver such as a Bluetooth® transceiver, any combination thereof, or the like. The memory (e.g., an SSD) may store a program of instructions, and the processor 420 (e.g., a CPU) may execute the program of instructions to control the functionality of the computing device 400. The communication interface 410 may establish a communication link 302B with a communication network 300. The communication interface 410 may establish communication links 802A to 802F with various devices through the communication network 300 based on respective communication links of said devices and the computing device 400 with the communication network 300.

As shown in FIG. 1, the computing device 400 may store and/or may access (e.g., in memory 430) information associated with and/or representing a plurality of dispensing operation sequences 910 that may be used by one or more dispensing apparatuses 210 to control the dispensing of one or more septic treatment compositions 202. Such information may include a database that may associate separate dispensing operation sequences 910 with separate, respective cartridge group identifier codes that may each be associated with a separate cartridge group 722. Each separate dispensing operation sequence 910 may indicate and may be associated with (and may include information indicating) at least one of a separate dispensing operation frequency, a separate amount of septic treatment composition dispensed per dispensing operation, or a separate maximum dispensing operation quantity. Each separate dispensing operation sequence may be associated with a particular ordering parameter and/or a threshold cumulative dispensing operation quantity.

The computing device 400 may (e.g., based on the processor 420 executing a program of instructions stored at the memory 430) control a dispensing apparatus 210 through the communication link 802A to cause the dispensing apparatus 210 to dispense a septic treatment composition 202 (e.g., received at an inlet port 217 of the dispensing apparatus 210 from a coupled cartridge 220 or other composition source) according to a selected dispensing operation sequence 912 from among at least a plurality of dispensing operation sequences 910, where the computing device 400 may select the selected dispensing operation sequence 912 from among at least the plurality of dispensing operation sequences 910 based on processing external data received from an external device (e.g., user device 500, one or more sensor devices 160, or any combination thereof). An external device may be referred to herein interchangeably as a “remote device.”

The computing device 400 may store and/or may access (e.g., in memory 430) a plurality of user accounts 920. Each user account 920 may associate user data associated with a user, who may be supported by a user device 500, with dispensing apparatus data associated with a dispensing apparatus 210 at a site 100. The user data included in the user account 920 may include data identifying a user name, a mailing address (e.g., a mailing address associated with site 100 and/or structure 104 at the site 100), payment information such as credit card information, user device communication link data identifying a user device 500 supporting the user and/or communication link 802C associated with the user device 500 supporting the user, any combination thereof, or the like. The dispensing apparatus data may include a dispensing apparatus identifier code uniquely identifying a particular dispensing apparatus 210 (which may be received from a user device 500 associated with the user data based on the user device 500 obtaining 519 the dispensing apparatus data from an apparatus identifier 219 of the dispensing apparatus 210 and/or which may be received from the dispensing apparatus 210 independently of the user device 500), communication link data identifying a communication link 802A between the computing device 400 and the dispensing apparatus 210, or the like. Each user account 920 stored and/or accessible by the computing device 400 may include data indicating a current selected dispensing operation sequence 912 currently being performed by the dispensing apparatus 210 associated with the respective user account (including, for example, a dispensing operation frequency and/or maximum dispensing operation quantity associated therewith), a current operating status of the dispensing apparatus 210 including an indication of a current quantity of dispensing operations performed by the dispensing apparatus 210 according to the selected dispensing operation sequence 912, information identifying a particular cartridge group 722 of a cartridge 220 associated with (e.g., coupled to) the dispensing apparatus associated with the user account, a septic treatment composition held in the cartridge, one or more ordering parameters associated with a cartridge group 722 of the cartridge 220 and/or associated with the selected dispensing operation sequence 912, information indicating one or more properties of the septic waste system associated with the user account, any combination thereof, or the like.

The computing device 400 may create or update a user account 920 based on receiving a user account signal from the user device 500. The user account signal may include user data and/or dispensing apparatus data. For example, the user device 500 may transmit a user account signal that may include user data associated with the user supported by the user device 500 and associated with a dispensing apparatus 210 at a site 100, dispensing apparatus data associated with the dispensing apparatus 210, or any combination thereof. The user device 500 may transmit user data associated with the user device 500 based on receiving at least some of such information based on user interaction with the user interface 540. The user device 500 may transmit dispensing apparatus data associated with the dispensing apparatus 210 based on user interaction with the user device 500 via the user interface 540 (e.g., manual entry of a dispensing apparatus identifier code uniquely identifying the dispensing apparatus 210), operation of a sensor device 550 of the user device 500 to scan an apparatus identifier 219 of the dispensing apparatus 210 that presents a visible pattern (e.g., QR code), alphanumeric code, or the like indicating a dispensing apparatus identifier code uniquely identifying the dispensing apparatus 210, or the like. The computing device 400 may, based on processing the user account signal (e.g., the user data and dispensing apparatus data included therein) and further obtaining dispensing apparatus data separately from the dispensing apparatus 210 via communication link 802A between the computing device 400 and the dispensing apparatus 210 and determining a match between at least some of the separate dispensing apparatus data received from both the user device 500 and the dispensing apparatus 210, create or update a user account 920 to associate the user data (including, for example, associating the user device 500) with the dispensing apparatus 210.

In some example embodiments, the computing device 400 is configured to establish a communication link 802A with one or more dispensing apparatuses 210, located at one or more sites 100, for example via communication network 300 based on respective communication links 302A and 302B of the dispensing apparatuses 210 and the computing device 400 with the communication network 300. In some example embodiments, the computing device 400 is configured to establish a communication link 802C with one or more user devices 500 associated with one or more user accounts 920, for example via communication network 300 based on respective communication links 302C and 302B of the user device(s) 500 and the computing device 400 with the communication network 300.

Referring back to FIG. 4, in some example embodiments, the user device 500 may be configured to operate a sensor device 550 to scan a cartridge identifier 222 of a cartridge 220 that is to be coupled (or is coupled) to a particular dispensing apparatus 210 in order to obtain 512 cartridge data from the cartridge identifier 222 (e.g., a visible pattern, bar code, or alphanumeric code indicated by the cartridge identifier 222). The user device 500 may obtain 512 cartridge data based on scanning the cartridge identifier 222, for example based on processing a captured image of a visible pattern provided by the cartridge identifier 222 to obtain a particular cartridge group identifier code associated with at least one cartridge 220 of the plurality of cartridges 720 (e.g., the particular cartridge 220 and/or the cartridge group 722 including same). The user device 500 may transmit a cartridge data signal that includes at least a portion of the obtained cartridge data, including information identifying the cartridge group identifier code and/or cartridge group 722 associated with same, to the computing device 400 through the communication link 802C. The cartridge data signal may include additional information that may be provided by the user device 500, for example based on user interaction with the user interface 540, including information identifying a particular dispensing apparatus 210 to which the cartridge 220 identified by the cartridge data is to be coupled, a particular site 100 (e.g., indicated by a mailing address) of a septic waste system 102 supported by the particular dispensing apparatus 210, or the like. It will be understood that a dispensing apparatus 210 having an outlet port 216 that is coupled in fluid communication with a septic tank 110 of a septic waste system 102 (e.g., via conduit 230, adaptor 240, or the like) may be understood to be “supporting” the septic waste system 102. The cartridge data signal may include information identifying the user device 500, a user supported by same, a particular user account 920 associated with the user device 500 and/or the dispensing apparatus 210, or any combination thereof.

The computing device 400 may receive the cartridge data signal from the user device 500 as “external data” received from an external device. The computing device 400 may process the cartridge data signal to identify the cartridge group identifier code indicated thereby, where the cartridge group identifier code may be understood to be associated with at least one cartridge 220 of the plurality of cartridges 720 (e.g., a particular cartridge group 722). The computing device 400 may further identify a particular user account and/or dispensing apparatus 210 associated with the cartridge data signal.

The computing device 400 may control the dispensing apparatus 210 associated with the user account 920 that is further associated with the user device 500 from which the cartridge data is received (or the user supported by the user device 500) through the communication link 802A to cause the dispensing apparatus 210 to dispense a septic treatment composition 202 (e.g., the septic treatment composition 202 held in the cartridge 220 associated with the cartridge group identifier code indicated by the cartridge data signal) according to a selected dispensing operation sequence 912. For example, the computing device 400 may process the cartridge data included in a received cartridge data signal (received from user device 500) to determine a particular cartridge group identifier code from among a plurality of cartridge group identifier codes that is indicated by the cartridge data signal. The computing device 400 may select a particular dispensing operation sequence from among at least the plurality of dispensing operation sequences 910 (e.g., stored in the memory 430 or a memory of a device communicatively coupled with the computing device 400) as a selected dispensing operation sequence 912 based on determining that the particular cartridge group identifier code is associated with the particular dispensing operation sequence. For example, the computing device 400 may access a database (which may be stored at memory 430 of computing device 400 or a memory of a separate device communicatively coupled thereto), for example, an empirically generated look-up table, that may associate respective dispensing operation sequences of the plurality of dispensing operation sequences 910 with respective cartridge group identifier codes. The computing device 400 may identify a particular dispensing operation sequence, among the plurality of dispensing operation sequences 910, that is associated with the cartridge group identifier code in the database. The computing device 400 may then “select” the particular dispensing operation sequence determined to be associated with the particular cartridge group identifier code that is indicated by the cartridge data received in the cartridge data signal from the user device 500 as a selected dispensing operation sequence 912.

Based on selecting the selected dispensing operation sequence 912, the computing device 400 may transmit a particular control signal to the dispensing apparatus 210 that is determined to be associated with and/or identified by the cartridge data signal and/or associated with the user account 920 associated with the user device 500 from which the cartridge data is received. The particular control signal may include data identifying one or more properties of the selected dispensing operation sequence 912 (e.g., a particular dispensing operation frequency, a particular maximum dispensing operation quantity, a particular dispensing operation amount or duration, any combination thereof, or the like) and may include a command to perform dispensing operations according to the selected dispensing operation sequence 912 or the one or more properties thereof.

The dispensing apparatus 210 (e.g., the controller 218A) may be configured to process the particular control signal to cause the dispensing apparatus 210 to perform the selected dispensing operation sequence 912 based on processing the particular control signal, so as to cause the dispensing apparatus 210 associated with the user account 920 and/or identified by information included in the cartridge data signal to dispense a septic treatment composition 202 (e.g., received at inlet port 217 of the dispensing apparatus 210 from the particular cartridge 220 associated with the cartridge data signal) according to the selected dispensing operation sequence 912 that is associated with the cartridge 220 and/or the particular cartridge group 722 including same.

Accordingly, it will be understood that the computing device 400 may be configured to control the dispensing apparatus 210 through the communication link 802A to cause the dispensing apparatus 210 to dispense a septic treatment composition 202 according to a selected dispensing operation sequence 912 from among at least a plurality of dispensing operation sequences 910, where the selected dispensing operation sequence 912 is selected based on processing external data received from an external device (e.g., cartridge data in a cartridge data signal received from a user device, the cartridge data signal including information identifying a particular cartridge group identifier code associated with a particular cartridge group 722 that includes a cartridge 220 from which cartridge data is obtained at the user device 500).

Referring back to FIG. 1, in some example embodiments, the septic treatment system 1000 is communicatively coupled to a remote device 600 (also referred to herein as a remote computing device) supporting a separate, third-party entity. Such a separate entity may include a government agency that may desire to track treatment of septic waste systems 102 at various sites 100. The remote device 600 may include a communication interface 610, a processor 620, a memory 630, a user interface 640, or any combination thereof. The communication interface 610 may be any known network communication transceiver, including a wireless network communication transceiver such as a Wi-Fi transceiver, a 5G cellular network communication transceiver, an ad hoc network communication transceiver such as a Bluetooth® transceiver, any combination thereof, or the like. The communication interface 610 may establish a communication link 302D with the communication network 300. The memory 630 may store a program of instructions and may store data associated with various septic waste systems 102 at various sites 100, including dispensing apparatus data regarding respective dispensing apparatuses 210, user data associated with respective user accounts 920 associated with said sites 100 and/or septic waste systems 102, site data regarding respective sites 100 and septic waste systems 102 thereof, or any combination thereof. The processor 620 may execute a program of instructions stored at the memory 630 to control operations of the remote device 600, including, for example, providing reports to one or more users (e.g., government agents) supported by the remote device 600 through one or more user interfaces (e.g., a display screen). The computing device 400 may establish a communication link 802D with the remote device 600 based on respective communication links 302D and 302B between the remote device 600 and the computing device 400 with the communication network 300.

In some example embodiments, the computing device 400 may be configured to transmit status signals indicating information associated with one or more user accounts, including information indicating dispensing operations and/or current selected dispensing operation sequences 912 being performed by respective dispensing apparatuses 210 associated with said user accounts. Said status signals may include information indicating particular cartridge group identifier codes associated with cartridges 220 coupled to the dispensing apparatuses 210 and providing septic treatment compositions thereto, particular septic treatment compositions indicated by same, or the like that may be associated with the user accounts. Such status signals may be transmitted to a user device 500 associated with a user account and/or to a remote device 600. The entity supported by the remote device 600 may use the status signals to track treatment of septic waste systems 102 at various sites 100 through use of one or more dispensing apparatuses 210 of the septic treatment system 1000.

Still referring to FIGS. 1 and 2, the septic treatment system 1000 may include one or more sensor devices 160 that may be provided at a site 100 to monitor one or more portions of a septic waste system 102 at the site 100. As shown in FIG. 1, the one or more sensor devices 160 at a site 100 may be communicatively coupled to the communication network 300 through one or more communication links 302E. The one or more sensor devices 160 may each be communicatively coupled to the computing device 400 via a communication link 802B based on the respective communication links 302E and 302B between the sensor device(s) 160 and the computing device 400 with the communication network 300. The one or more sensor devices 160 may each independently include any known liquid level sensor, any known static pressure sensor, any known contact sensor, any known moisture sensor, any known remote proximity sensor, any known laser time-of-flight sensor, any known chemical and/or biological substance detection sensor (e.g., any known sensor configured to detect a presence and/or concentration of any particular substance and/or organism, including a presence and/or concentration of one or more bacteria and/or nutrients, proximate to the sensor device), any combination thereof, or the like. One or more, or all, of the sensor devices 160A to 160E may be omitted, in some example embodiments.

The one or more sensor devices 160 may be configured to generate sensor data based on monitoring at least a portion of the septic waste system 102 at a site 100 and may be configured to transmit the sensor data to the computing device 400 through the communication link 802B. The one or more sensor devices 160 may include any known sensor device and may generate sensor data indicating any detectable aspects of the septic waste system 102. For example, the one or more sensor devices 160 may include a sensor device 160A that may include at least one of any known liquid level sensor, any known static pressure sensor, any known contact sensor, any known moisture sensor, any known remote proximity sensor, any known laser time-of-flight sensor, any combination thereof, or the like. The sensor device 160A may be configured to generate sensor data indicating a level of waste (e.g., organic waste 170) within the septic tank 110. The level of waste within the septic tank 110 may represent a depth of organic waste 170 in the septic tank 110, a height of a top surface of the organic waste 170 (e.g., of the top surface of scum 174) from a bottom of the septic tank 110, a vertical proximity to a top surface of the septic tank 110, a depth of sensor device 160A from the top surface of waste 170 within the septic tank 110 (e.g., indicated by a static pressure measurement), any combination thereof, or the like. The level of waste within the septic tank 110 may be indicated by sensor data indicating a vertical proximity of an upper surface of organic waste 170 (e.g., the upper surface of the scum 174 or any organic waste 170) from the sensor device 160A in the septic tank 110, a determination of whether organic waste 170 is in contact with the sensor device 160A, or any combination thereof. In some example embodiments, material located within the septic tank 110 may be assumed to be included in waste 170, and therefore sensor data indicating a height, depth, level, etc. of material (liquid and/or solid) in the septic tank 110 may be assumed to indicate a height, depth, level, etc. of waste (e.g., organic waste 170) in the septic tank 110.

In another example, the one or more sensor devices 160 may include a sensor device 160B that may include a level sensor configured to generate sensor data indicating a level of waste (e.g., liquid, water, waste, etc.) within the drain field 114, a sensor configured to generate sensor data indicating at least one of a presence of bacteria and/or nutrients within the drain field 114, or the like. The sensor device 160B may include at least one of any known liquid level sensor, any known static pressure sensor, any known contact sensor, any known moisture sensor, any known remote proximity sensor, any known laser time-of-flight sensor, any known chemical and/or biological substance detection sensor (e.g., any known sensor configured to detect a presence and/or concentration of any particular substance and/or organism, including a presence and/or concentration of one or more bacteria and/or nutrients, proximate to the sensor device), any combination thereof, or the like.

In another example, the one or more sensor devices 160 may include a sensor device 160C and/or 160D in or on the soil 106 proximate to or vertically overlapping the drain field 114 and/or the septic tank 110 (or proximate thereto, for example, within 5 meters horizontally of the septic tank 110 and/or drain field 114). The sensor device 160C and/or 160D may include a sensor configured to generate sensor data indicating at least one of a presence, level, or concentration of liquid in soil within a threshold proximity (e.g., within 5 meters, vertically overlapping, etc.) of the septic tank 110, the drain field 114, or any combination thereof. The sensor device 160C and/or 160D may include a sensor configured to generate sensor data indicating at least one of a presence and/or concentration of bacteria and/or nutrients in soil 106 within a threshold proximity (e.g., within 5 meters, vertically overlapping, etc.) of the septic tank 110, the drain field 114, or any combination thereof. The sensor device 160C and the sensor device 160D may each independently include at least one of any known liquid level sensor, any known static pressure sensor, any known contact sensor, any known moisture sensor, any known remote proximity sensor, any known laser time-of-flight sensor, any known chemical and/or biological substance detection sensor (e.g., any known sensor configured to detect a presence and/or concentration of any particular substance and/or organism, including a presence and/or concentration of one or more bacteria and/or nutrients, proximate to the sensor device), any combination thereof, or the like.

The computing device 400 may associate one or more sensor devices 160 with a user account 920 based on the user device 500 transmitting a signal that includes information identifying the one or more sensor devices (e.g., including identifier codes identifying the one or more sensor devices) and further identifying a user account or user device 500 associated therewith, and the computing device 400 processing the signal to match the identifier codes indicated by the signal with identifier codes obtained from the one or more sensor devices 160 through the communication link 802B and, in response to a match, associating the sensor device(s) 160 and sensor data received therefrom with the user account 920.

The computing device 400 may associate one or more sensor devices 160 with a particular site 100 and/or a user account 920 associated with the same. The computing device 400 may process sensor data received from one or more sensor devices 160 at a site 100 to determine at least one property of the septic waste system 1 being monitored by the one or more sensor devices 160. The at least one property may include at least one of a level of waste within the septic tank 110 (e.g., a vertical proximity of an upper surface of organic waste 170 from sensor device 160A, an indication of whether solid and/or liquid material, such as solid and/or liquid organic waste 170, is contacting the sensor device 160 to indicate that the level of waste in the septic tank 110 is at least at the level of the sensor device 160A), a level of waste within a drain field 114 of the septic waste system 102 (e.g., a vertical proximity of an upper surface of waste from sensor device 160B in the drain field 114, an indication of whether solid and/or liquid material, such as water, solid and/or liquid organic waste 170, or the like is contacting the sensor device 160B to indicate that the level of waste in the drain field 114 is at least at the level of the sensor device 160B), at least one of a presence or concentration of bacteria and/or nutrients within a drain field of the septic system (which may be indicated by sensor data generated by sensor device 160B in the drain field 114 and/or a sensor device 160C at least partially vertically overlapping the same), a presence, level, or concentration of liquid in soil within a threshold proximity (e.g., 5 meters horizontally) of the septic tank 110, the drain field 114, or any combination thereof (which may be indicated by sensor data generated by sensor device 160C and/or 160D), at least one of a presence or concentration of bacteria and/or nutrients in soil within a threshold proximity (e.g., 5 meters horizontally) of the septic tank 110, the drain field 114, or any combination thereof (which may be indicated by sensor data generated by sensor device 160C and/or 160D), or any combination thereof.

The computing device 400 may process sensor data received from one or more sensor devices 160 associated with a user account 920 to determine whether at least one property of the septic waste system 102 being monitored by the one or more sensor devices 160 (and thus associated with the user account) at least meets a corresponding at least one property threshold value (which may be stored at and/or accessible by the computing device 400 from a memory such as memory 430). For example, the computing device 400 may store or access a property threshold value that is a threshold level of waste in the septic tank 110 or an indication that solid and/or liquid material is contacting a sensor device 160A in the septic tank 110. In another example, the computing device 400 may store or access a property threshold value that is a threshold level of waste in the drain field 114 or an indication that solid and/or liquid material is contacting a sensor device 160B in the drain field 114. In another example, the computing device 400 may store or access a property threshold value that is a threshold concentration or indication of presence of liquid, bacteria, and/or nutrients in soil 106 within a threshold proximity (e.g., 5 meters) of the septic tank 110, drain field 114, or any combination thereof as may be indicated by sensor data received from sensor device 160C and/or 160D.

In response to determining that at least one property indicated by sensor data received from one or more sensor devices 160 associated with a user account 920 at least meets a corresponding at least one property threshold value, the computing device 400 may select a particular dispensing operation sequence from among at least a plurality of dispensing operation sequences 910 to be performed by a dispensing apparatus 210 associated with the user account 920. For example, the computing device 400 may access a database (e.g., an empirically generated look-up table) which may be stored at memory 430 or accessed from a device communicatively coupled to the computing device 400, which associates separate dispensing operation sequences of the plurality of dispensing operation sequences 910 with separate, respective determinations of threshold property values that are at least met as determined by sensor data. The computing device 400 may access the database and determine, as a selected dispensing operation sequence 912, a particular dispensing operation sequence that is indicated by the database to be associated with the particular at least one property determined, based on processing sensor data, to at least meet a corresponding at least one threshold property value. The computing device 400 may transmit a particular control signal associated with the selected dispensing operation sequence 912 to the dispensing apparatus 210 associated with the same user account 920 as the one or more sensor devices 160 to cause the dispensing apparatus 210 to process the control signal to dispense septic treatment composition 202 according to the selected dispensing operation sequence 912.

As a result, the computing device 400 may select a particular selected dispensing operation sequence among the plurality of dispensing operation sequences 910 as a selected dispensing operation sequence 912 to control a dispensing apparatus 210 based on processing sensor data received from one or more sensor devices 160 to determine at least one property of a septic waste system 102. Accordingly, the computing device 400 may be configured to control the dispensing apparatus through the communication link to cause the dispensing apparatus 210 to dispense a septic treatment composition 202 according to a selected dispensing operation sequence 912 from among at least a plurality of dispensing operation sequences 910, where the selected dispensing operation sequence 912 is selected based on processing external data received from an external device (e.g., based on processing sensor data received from one or more sensor devices 160 associated with the same user account as the dispensing apparatus 210 and monitoring one or more portions of a septic waste system 102 which the dispensing apparatus 210 may be coupled in fluid communication).

For example, the computing device 400 may control the dispensing apparatus 210 to dispense septic treatment composition 202 at a greater frequency and/or amount per dispensing operation to try to control the at least one property of the septic waste system 102 based on a determination, according to sensor data, that the at least one property at least meets a corresponding at least one threshold property value.

In addition or alternatively, the computing device 400 may respond to a determination that the at least one property at least meets one or more property threshold values by commanding purchase and/or delivery of a new cartridge 220 to a mailing address associated with the user account 920 and/or the septic waste system 102, including a new cartridge associated with a particular cartridge group 722 and/or particular cartridge group identifier code in order to enable the dispensing apparatus 210 to dispense a particular septic treatment composition 202 (which may be directed to the septic tank 110 of the septic waste system 102 to which the dispensing apparatus 210 is coupled in fluid communication) to particularly control the at least one property of the septic waste system 102 that is determined to at least meet a corresponding at least one property threshold value, thereby exerting improved control over operation of the septic waste system 102.

The computing device 400 may, in some example embodiments, transmit a signal (e.g., a status signal) to an external device (e.g., at least one of the user device 500 associated with a user account, the remote device 600, or any combination thereof) based on determining at least one property associated with the septic waste system 102 as determined based on processing sensor data from one or more sensor devices 160 monitoring one or more portions of the septic waste system 102. The status signal may include status information indicating a status of the septic waste system 102, including data indicating a value of at least one property of the septic waste system 102 as determined based on processing the sensor data, data indicating whether at least one determined property of the septic waste system 102 at least meets a corresponding at least one property threshold value, or any combination thereof, or the like.

In some example embodiments, the computing device 400 may transmit a dispensing control signal to a dispensing apparatus 210 to cause the dispensing apparatus 210 to perform a dispensing operation independently of a selected dispensing operation sequence 912 that the dispensing apparatus 210 is currently performing. Such a dispensing operation may be referred to as an interrupt dispensing operation and may be performed independently of a dispensing operating frequency of the selected dispensing operation sequence 912 being performed by the dispensing apparatus 210. The dispensing apparatus 210 may continue to perform dispensing operations according to the selected dispensing operation sequence 912 independently of the interrupt dispensing operation, but the dispensing apparatus 210 and/or the computing device 400 may increment the quantity of dispensing operations performed according to the selected dispensing operation sequence 912 to account for the performance of the interrupt dispensing operation. Accordingly, the computing device 400 may cause the dispensing apparatus 210 to perform an interrupt dispensing operation independently of the selected dispensing operation sequence 912 being performed by the dispensing apparatus, in response to the computing device 400 receiving a signal (e.g., a dispensing command signal) from a remote computing device, including, for example, the user device 500. The computing device 400 may transmit the dispensing control signal in response to receiving a dispense command signal from the user device 500 or based on a determination that at least one property associated with a septic waste system 102 that is associated with the same user account as the dispensing apparatus 210 (e.g., based on processing sensor data received from one or more sensor devices 160 associated with the user account) at least meets a corresponding at least one property threshold value.

Still referring to FIG. 1, the septic treatment system 1000 may be communicatively coupled to a cartridge distribution system 700, which may include a controller 710 and may include at least one distribution center or warehouse storing a plurality of cartridges 720, including a plurality of separate cartridge groups 722 of cartridges associated with separate, respective cartridge group identifier codes. The cartridge distribution system 700 may include one or more computing devices that may be communicatively coupled with the communication network 300 through a communication link 302F. The computing device 400 may establish a communication link 802E with the cartridge distribution system 700 through respective communication links 302F and 302B between the cartridge distribution system 700 and the computing device 400 with the communication network 300. The controller 710 may include a communication interface (which may be any known network communication transceiver, including a wireless network communication transceiver such as a Wi-Fi transceiver, a 5G cellular network communication transceiver, an ad hoc network communication transceiver such as a Bluetooth® transceiver, any combination thereof, or the like), a memory storing a program of instructions, and a processor that may execute the program of instructions to perform some or all of the functionality of the cartridge distribution system 700.

The computing device 400 may be configured to transmit an order command signal to the cartridge distribution system 700 through the communication link 802E to cause the cartridge distribution system 700 to deliver 730 one or more selected cartridges 220 from one or more particular cartridge groups 722 to a mailing address associated with a user account 920 and/or a particular septic waste system 102 at a particular site 100. The computing device 400 may command such delivery of one or more new cartridges 220 associated with a particular cartridge group 722 (indicated by a particular cartridge group identifier code uniquely associated with the particular cartridge group 722) based on processing external data (e.g., cartridge data and/or sensor data) received from an external device.

The computing device 400 may transmit an order signal to the cartridge distribution system 700 based on processing a depletion signal from a dispensing apparatus 210 to determine that a quantity of dispensing operations performed by the dispensing apparatus 210 according to a selected dispensing operation sequence 912 has reached a threshold (e.g., maximum) quantity (e.g., a dispensing operation maximum quantity associated with the selected dispensing operation sequence). The computing device 400 may access an order parameter associated with the user account 920 that is also associated with the dispensing apparatus 210 (e.g., an order parameter associated with the selected dispensing operation sequence 912 being performed by the dispensing apparatus 210). The order parameter may indicate a particular cartridge group 722 of a new cartridge 220 to be purchased and/or delivered and may include a command to deliver a new cartridge associated with the particular cartridge group 722 to a mailing address associated with the user account 920. The cartridge distribution system 700 may, based on processing the order signal, cause one or more particular cartridges 220 associated with the particular cartridge group 722 indicated by the order signal to be delivered to a particular mailing address associated with the user account (where the user account and/or the particular mailing address may be indicated by the order signal).

Accordingly, the computing device 400 may associate a dispensing apparatus 210 of a user account 920 with a selected dispensing operation sequence that the computing device 400 has caused the dispensing apparatus 210 to perform, and the computing device 400 may track a quantity of dispensing operations performed by the dispensing apparatus 210 according to the selected dispensing operation sequence 912 (e.g., based on processing status signals transmitted by the dispensing apparatus 210 in response to performing one or more dispensing operations according to the selected dispensing operation sequence 912). The computing device 400 may, in response to determining that the quantity of dispensing operations performed by the dispensing apparatus 210 according to the selected dispensing operation sequence 912 at least meets a threshold quantity (e.g., a maximum dispensing operation quantity associated with the selected dispensing operation sequence 912), transmit an order signal to the cartridge distribution system 700 to command at least one of purchase or delivery of a new cartridge 220 to a mailing address associated with the dispensing apparatus based on an ordering parameter associated with the selected dispensing operation sequence 912 (e.g., associated with the particular cartridge group identifier code used to select the selected dispensing operation sequence 912). The new cartridge may be associated with either of: the selected dispensing operation sequence 912, or a different dispensing operation sequence. For example, the ordering parameter may indicate a cartridge group identifier code that identifies a cartridge group 722 from which the new cartridge 220 is to be purchased and/or delivered. The cartridge group identifier code indicated in the ordering parameter may be the same as the cartridge group identifier code that is associated with the current selected dispensing operation sequence 912 being performed by the dispensing apparatus 210 or may be a different cartridge group identifier code that is associated with a different dispensing operation sequence from among at least the plurality of dispensing operation sequences 910. The computing device 400 may transmit the order signal to include the cartridge group identifier code indicated by the ordering parameter, and the cartridge distribution system 700 may process the order signal to cause delivery 730 of a new cartridge 220 from a cartridge group 722 associated with the cartridge group identifier code indicated in the order signal. Accordingly, the new cartridge 220 that the order signal commands at least one of purchase or delivery to the mailing address may be associated with either of the current selected dispensing operation sequence or a different dispensing operation sequence.

In some example embodiments, the computing device 400 may transmit an ordering signal to the cartridge distribution system 700 based on processing sensor data received from one or more sensor devices 160 associated with the user account 920 to determine that at least one property of a septic waste system 102 being monitored by the one or more sensor devices 160 at least meets a corresponding at least one property threshold value, in order to cause the cartridge distribution system 700 to deliver 730 a new cartridge 220 to a mailing address associated with the user account 920 to be coupled to the dispensing apparatus 210 associated with the user account 920 to configure the dispensing system 200 to provide a new septic treatment composition to control the at least one property of the septic waste system 102 to approach and/or achieve a desired value.

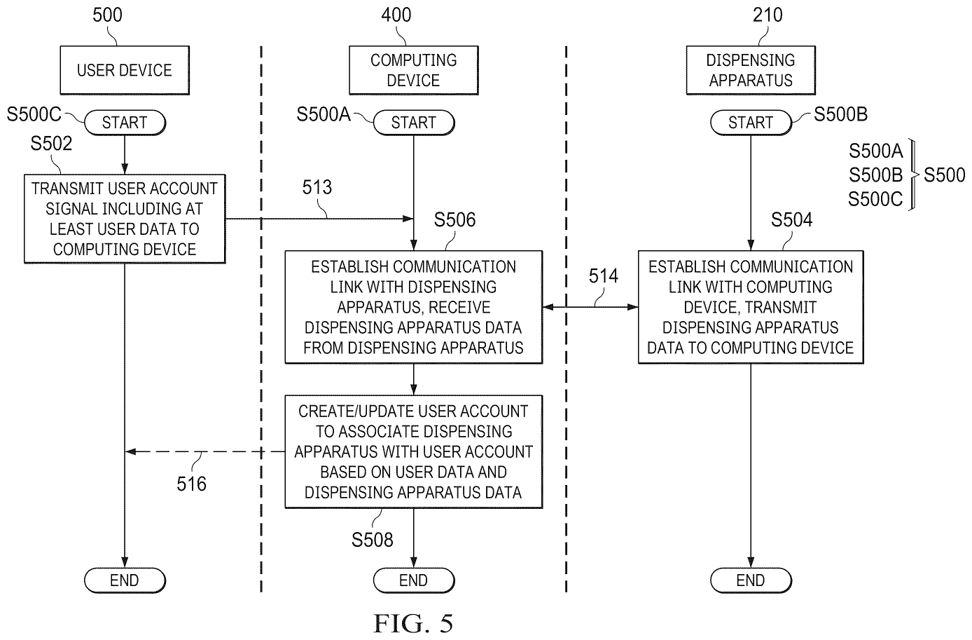

FIG. 5 is a flowchart illustrating a method S500 of operation of a septic treatment system according to some example embodiments. The method shown in FIG. 5 may be implemented with regard to the septic treatment system 1000 as shown in FIGS. 1 to 4, including the computing device 400, the dispensing apparatus 210, and the user device 500, although example embodiments are not limited thereto, and it will be understood that the method S500 shown in FIG. 5 may be implemented by a septic treatment system 1000 that is different from what is shown in FIGS. 1-4. As shown, method S500 may include respective methods S500A, S500B, and S500C performed by the computing device 400, the dispensing apparatus 210, and the user device 500, respectively, of the septic treatment system 1000. In some example embodiments, one or more of methods S500A to S500C may be performed independently of one or more others of methods S500A to S500C.

One or more operations of the method S500 shown to be implemented by the computing device 400 may be implemented by the user device 500, the dispensing apparatus 210, or any combination thereof. One or more operations of the method S500 shown to be implemented by the user device 500 may be implemented by the computing device 400. Operations of method S500 shown to be implemented by the computing device 400 may be implemented based on processor 420 executing a program of instructions stored at memory 430. Operations of method S500 shown to be implemented by the user device 500 may be implemented based on processor 520 executing a program of instructions stored at memory 530. Operations of method S500 shown to be implemented by the dispensing apparatus 210 may be implemented based on a processor of controller 218A executing a program of instructions stored at a memory of the controller 218A. It will be understood that operations shown to be performed in FIG. 5 may be performed in a different order than shown. One or more operations of method S500 may be omitted, and one or more operations may be added to method S500.

Referring to FIG. 5, at S502, a user device 500 may transmit a user account signal 513 to the computing device 400 through a communication link (e.g., communication link 802C).

The user account signal may include user data identifying a user supported by the user device 500, and/or the user device 500 itself, to be associated with the user account. Such user data may include information identifying a user name, a mailing address (e.g., a mailing address associated with site 100 and/or structure 104 at the site 100), payment information such as credit card information, user device communication link data identifying a user device 500 supporting the user and/or communication link 802C associated with the user device 500 supporting the user, any combination thereof, or the like.

The user account signal may include dispensing apparatus data identifying a particular dispensing apparatus 210 to be associated with the user account. Such dispensing apparatus data may include a dispensing apparatus identifier code uniquely identifying a particular dispensing apparatus 210, communication link data identifying a communication link 802A between the computing device 400 and the dispensing apparatus 210, or the like. The user device 500 may transmit dispensing apparatus data associated with the dispensing apparatus 210 based on user interaction with the user device 500 via the user interface 540 (e.g., manual entry of a dispensing apparatus identifier code uniquely identifying the dispensing apparatus 210), operation of a sensor device 550 of the user device 500 to scan an apparatus identifier 219 of the dispensing apparatus 210 that presents a visible pattern (e.g., QR code), alphanumeric code, or the like indicating a dispensing apparatus identifier code uniquely identifying the dispensing apparatus 210 to thereby obtain 519 the dispensing apparatus data including the dispensing apparatus identifier code, or the like. In some example embodiments, the apparatus identifier 219 may include a bar code, NFC chip, QR code, or the like at the outer surface of the dispensing apparatus 210, and the user device 500 may operate a sensor device 550 (e.g., a camera or NFC transceiver) to scan at least a portion of the dispensing apparatus 210 (e.g., capture and process an image of a bar code or QR code or alphanumeric code printed on an outer surface of the dispensing apparatus 210, communicate with an NFC chip, or the like) to obtain the dispensing apparatus identifier code uniquely associated with the particular dispensing apparatus 210.

At S502, the user device 500 may transmit the user account signal to the computing device 400, where the user account signal 513 may include, in addition to the user data and the dispensing apparatus data, a command to create or update a user account that associates the user data and the dispensing apparatus data (and thus associates the user supported by the user device 500 with the particular dispensing apparatus 210).

At S504, the dispensing apparatus 210 may establish a communication link 802A with the computing device 400 and may transmit a dispensing apparatus data signal 514 that includes dispensing apparatus data that indicates the dispensing apparatus identifier code identifying (e.g., uniquely identifying) the dispensing apparatus 210 to the computing device 400 through the communication link 802A.

At S506, the computing device 400 may establish the communication link 802A with the dispensing apparatus 210 and receive the dispensing apparatus data signal 514 associated with the dispensing apparatus 210 from the dispensing apparatus 210 over the communication link 802A. As a result, the computing device 400 may receive dispensing apparatus data from the dispensing apparatus 210 through the communication link 802A and independently of the user device 500 (and dispensing apparatus data received from the user device 500).

In some example embodiments, including the example embodiments shown in FIG. 5, the communication link 802A may be established based on the particular dispensing apparatus 210 being communicatively coupled with the communication network 300 and the dispensing apparatus 210 further executing a program of instructions stored in a memory of the dispensing apparatus 210 at S504 to establish the communication link 802A with the computing device 400. Such a communication link initiated from the dispensing apparatus 210 may be established independently of any user account 920 supported at the computing device 400. It will be understood that example embodiments of establishing the communication link between the computing device 400 and the dispensing apparatus 210 are not limited thereto, and in some example embodiments, the computing device 400 may initiate the communication link 802A with the dispensing apparatus 210.

At S508, the computing device 400 may create or update a user account 920 that associates the user data with the dispensing apparatus data, and thus may associate the user data with the dispensing apparatus 210, based on the user data received from the user device 500 and the dispensing apparatus data (e.g., the dispensing apparatus identifier code) received independently from each of the user device 500 (via user account signal 513) and the dispensing apparatus 210 (via the dispensing apparatus data signal 514). Such creation or updating may include associating dispensing apparatus data received from the user device 500 and/or the dispensing apparatus 210 with the user data in a user account. Such creation or updating may include determining a match between at least a portion of the dispensing apparatus data received from the user device 500 via the user account signal 513 and the dispensing apparatus data independently received from the particular dispensing apparatus 210 via dispensing apparatus data signal 514. For example, at S508 the computing device 400 may determine a match between dispensing apparatus data (e.g., a dispensing apparatus identifier code) received from the user device 500 in the account data received at S504 and the data received independently from the dispensing apparatus 210 at S506.

In response to determining the match between at least a portion of the dispensing apparatus data received via the user account signal 513 and dispensing apparatus data received from the particular dispensing apparatus at S506, at S508 the computing device 400 may associate the particular dispensing apparatus 210 (e.g., information uniquely identifying the dispensing apparatus 210, the communication link 802A therewith, or the like) with the user data (e.g., information identifying a user name, a mailing address (e.g., a mailing address associated with site 100 and/or structure 104 at the site 100), payment information such as credit card information, user device communication link data identifying a user device 500 supporting the user and/or communication link 802C associated with the user device 500 supporting the user, any combination thereof, or the like).

As shown, method S500 may include method S500A performed by the computing device 400, including operations S506 and S508, method S500B performed by the dispensing apparatus 210, including operation S504, and method S500C performed by the user device 500 and including operation S502. Based on performance of method S500 or any portion thereof (e.g., performance of at least method S500A), the computing device 400 may establish a user account that links user data with dispensing apparatus data associated with a particular dispensing apparatus 210 that may support treatment of a septic waste system 102 at a site 100 (also referred to as a geographic site, a geographic location, a property lot, or the like).

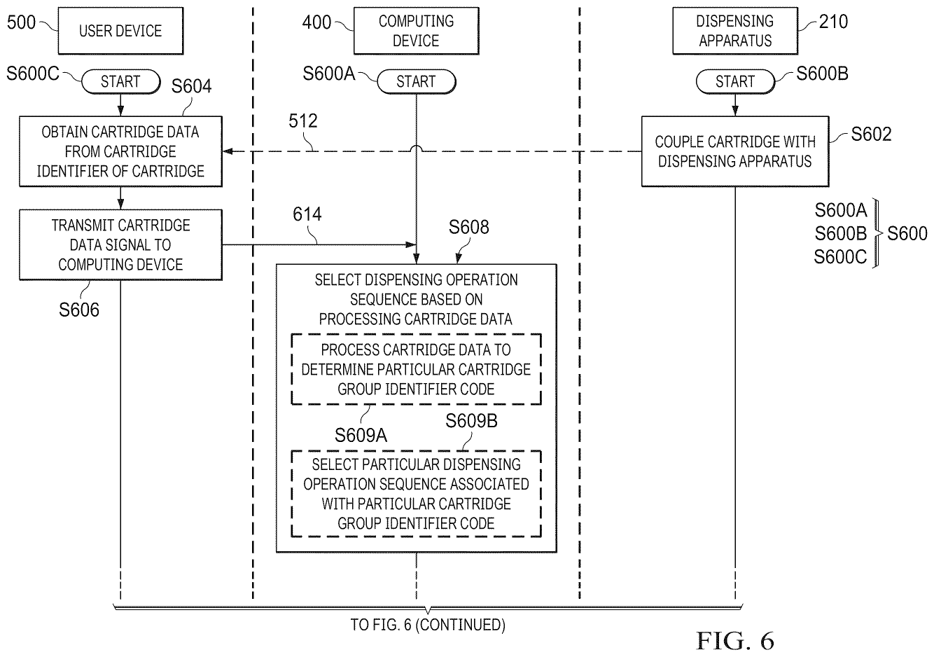

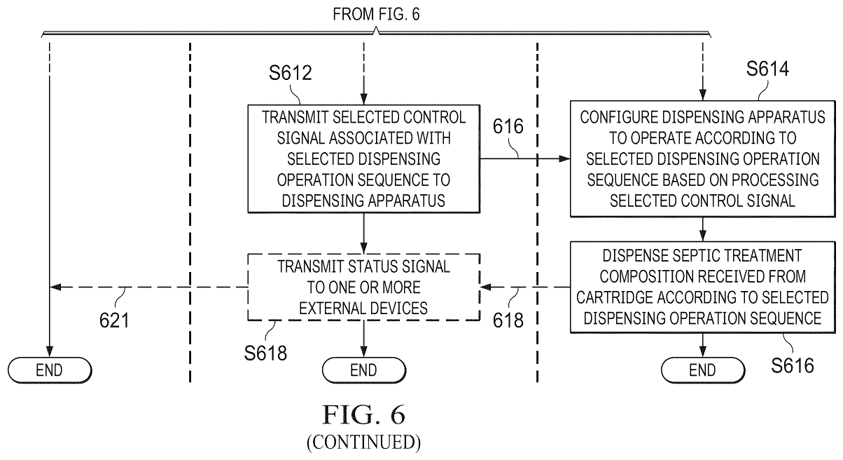

FIG. 6 is a flowchart illustrating a method S600 of operation of a septic treatment system according to some example embodiments. The method shown in FIG. 6 may be implemented with regard to the septic treatment system 1000 as shown in FIGS. 1 to 4, including the computing device 400, the dispensing apparatus 210, and the user device 500, although example embodiments are not limited thereto, and it will be understood that the method S600 shown in FIG. 6 may be implemented by a septic treatment system 1000 that is different from what is shown in FIGS. 1-4. As shown, method S600 may include respective methods S600A, S600B, and S600C performed by the computing device 400, the dispensing apparatus 210, and the user device 500, respectively, of the septic treatment system 1000. In some example embodiments, one or more of methods S600A to S600C may be performed independently of one or more others of methods S600A to S600C.

One or more operations of the method S600 shown to be implemented by the computing device 400 may be implemented by the user device 500, the dispensing apparatus 210, or any combination thereof. One or more operations of the method S600 shown to be implemented by the user device 500 may be implemented by the computing device 400. Operations of method S600 shown to be implemented by the computing device 400 may be implemented based on processor 420 executing a program of instructions stored at memory 430. Operations of method S600 shown to be implemented by the user device 500 may be implemented based on processor 520 executing a program of instructions stored at memory 530. Operations of method S600 shown to be implemented by the dispensing apparatus 210 may be implemented based on a processor of controller 218A executing a program of instructions stored at a memory of the controller 218A. It will be understood that operations shown to be performed in FIG. 6 may be performed in a different order than shown. One or more operations of method S600 may be omitted, and one or more operations may be added to method S600.

Referring to FIG. 6, at S602, a particular cartridge 220 that includes a cartridge identifier 222 (and from which the cartridge data is obtained at S604) may be coupled with the dispensing apparatus 210, for example, connected with a connector 214 of the dispensing apparatus 210 to establish fluid communication between an internal cartridge reservoir 224 of the cartridge 220 and an inlet port 217 of the dispensing apparatus 210. As described herein, a cartridge 220 may include a cartridge identifier 222 that may indicate cartridge data, including a cartridge group identifier code associated with a cartridge group 722 that includes the cartridge 220.

In some example embodiments, the cartridge identifier 222 may include a bar code, NFC chip, QR code, printed alphanumeric code, or the like, at the outer surface of the cartridge 220. At S604, the user device 500 (e.g., a sensor device 550 thereof, including, for example, a camera, NFC communication interface, or the like) may scan at least a portion of the cartridge identifier 222 (e.g., capture and process an image of a bar code or QR code or alphanumeric code comprising the cartridge identifier 222, communicate with an NFC chip comprising the cartridge identifier 222, or the like) to obtain 512 cartridge data indicated by the cartridge identifier 222 (e.g., cartridge identifier data indicated by a QR code, bar code, alphanumeric code, or the like, comprising the cartridge identifier 222).

At S604, the user device 500 may obtain 512 the cartridge data from the cartridge identifier 222 of the particular cartridge 220. Based on processing the cartridge data indicated by the cartridge identifier 222 (e.g., based on processing an image of a QR code, bar code, alphanumeric code, or the like, comprising the cartridge identifier 222), the user device 500 may obtain (e.g., capture, generate, etc.) cartridge data associated with the particular cartridge 220. The cartridge data may include the cartridge group identifier code associated with the particular cartridge group 722 that includes the particular cartridge 220 from which the cartridge data is obtained 512.

It will be understood that operations S602 and S604 may be performed in any order; while FIG. 6 illustrates S602 being performed prior to S604, such operations may be performed in the reverse order, at least partially simultaneously, or any combination thereof.

At S606, the user device 500 may transmit a cartridge data signal 614 that includes at least a portion of the cartridge data (e.g., includes at least the cartridge group identifier code) to the computing device 400. The computing device 400 may receive the cartridge data signal from the user device 500. It will be understood that the user device 500 may be an external device in relation to the computing device 400, such that the cartridge data may be an example of external data that may be received at the computing device 400 from an external device.

At S608, the computing device 400 may process the received cartridge data to select a particular dispensing operation sequence from among at least a plurality of dispensing operation sequences 910. For example, at S609A the computing device 400 may process the received cartridge data (received via the cartridge data signal 614) to determine (obtain) the particular cartridge group identifier code that is indicated by the cartridge data associated with the cartridge 220 from which the cartridge data is obtained at S604. At S609B, the computing device 400 may access a database (e.g., a look-up table) that associates the plurality of dispensing operation sequences 910 with separate, respective cartridge group identifier codes. At S609B, the computing device 400 may thereby apply the cartridge group identifier code determined at S609A to the database to identify (and select) a particular dispensing operation sequence from among at least the plurality of dispensing operation sequences 910 based on determining that the particular cartridge group identifier determined at S609A is associated with the particular dispensing operation sequence. The computing device 400 may thereby select the particular dispensing operation sequence as the selected dispensing operation sequence 912.

At S612, the computing device 400 may select a particular control signal 616 associated with the selected dispensing operation sequence 912 and transmit the selected control signal 616 to the dispensing apparatus 210 associated with the same user account 920 as the user device 500 from which the cartridge data signal 614 was received. For example, the computing device 400 may determine a particular control signal 616 that is associated with the selected dispensing operation sequence 912 (e.g., as may be indicated by a database accessible by the computing device 400 or stored in a memory 430 of the same). The cartridge data signal 614 may include information identifying a particular user account 920 (e.g., based on identifying the particular user device 500 transmitting the cartridge data signal and/or a user account associated therewith) and/or a particular dispensing apparatus 210, and at S612 the computing device 400 may transmit the selected control signal 616 to the dispensing apparatus 210 determined to be associated with the identified user account 920 and/or identified by the cartridge data signal 614.

At S614, the dispensing apparatus 210 may receive the selected control signal 616 from the computing device 400 and may configure (e.g., program) the dispensing apparatus 210 to operate according to the selected dispensing operation sequence 912 based on processing the selected control signal 616. Such configuring may include determining one or more properties of the selected dispensing operation sequence 912 based on processing the control signal 616, where such one or more properties may include a particular dispensing operation frequency (e.g., interval), a particular amount of dispensing composition and/or duration of dispensing operation per dispensing operation, for a particular dispensing operation maximum quantity of dispensing operations, or any combination thereof.

At S616, the dispensing apparatus 210 may perform the selected dispensing operation sequence 912 to controllably dispense septic treatment composition 202 (which may be received at the dispensing apparatus 210 from the cartridge 220) at a particular dispensing operation frequency (e.g., interval), at a particular amount of dispensing composition and/or duration of dispensing operation per dispensing operation, for a particular dispensing operation maximum quantity of dispensing operations, or any combination thereof.

Accordingly, referring to S608 and S612, the computing device 400 may receive external data (cartridge data signal 614) from an external device (user device 500) through a first communication link (communication link 802C) and may transmit a control signal 616 to the dispensing apparatus 210 through a second communication link (communication link 802A) to cause the dispensing apparatus 210 to dispense a septic treatment composition 202 according to a selected dispensing operation sequence 912 from among at least a plurality of dispensing operation sequences 910, where the selected dispensing operation sequence 912 is selected (e.g., at the computing device 400) based on processing the external data (e.g., the cartridge data signal 614), where each dispensing operation sequence of the plurality of dispensing operation sequences 910 may be associated with at least one of a separate dispensing operation frequency, a separate amount of septic treatment composition dispensed per dispensing operation, or a separate maximum dispensing operation quantity.

In some example embodiments, at S608 and/or S612, the computing device 400 may associate a user account 920 that is associated with the dispensing apparatus 210 and/or the user device 500 from which the cartridge data signal 614 is received with the selected dispensing operation sequence 912, including an ordering parameter associated therewith, a threshold cumulative dispensing operation quantity associated therewith, and a current quantity of dispensing operations performed by the dispensing apparatus 210 according to the selected dispensing operation sequence 912, or the like.

In some example embodiments, the dispensing apparatus 210 may transmit a status signal 618 to the computing device 400 as part of performing one or more dispensing operations according to the selected dispensing operation sequence 912. The status signal 618 may indicate performance of one or more dispensing operations according to the selected dispensing operation sequence 912 by the dispensing apparatus 210. The status signal 618 may indicate a quantity of dispensing operations performed since the control signal 616 was processed at S614. The status signal 618 may indicate a quantity of dispensing operations performed by the dispensing apparatus 210 according to the selected dispensing operation sequence 912.

At S618, the computing device 400 may receive one or more status signals from the dispensing apparatus 210. The computing device 400 may process the status signal to determine a status of the dispensing apparatus 210. The computing device 400 may transmit a status signal 621 indicating the status of the dispensing apparatus 210 to the user device 500 that is associated with the user account 920 (e.g., via communication link 802C). The user device 500 may receive the status signal 621 and may provide information indicated by the status signal 621, including information indicating the status of the dispensing apparatus 210, to a user supported by the user device 500.

As shown, method S600 may include method S600A performed by the computing device 400, including operations S608, S609A, S609B, S612, and S618, method S600B performed by the dispensing apparatus 210, including operations S602, S614, and S616, and method S600C performed by the user device 500, including operations S604 and S606. Based on performance of method S600 or any portion thereof (e.g., performance of at least method S600A), the computing device 400 may control the dispensing apparatus 210 through the communication link 802A to cause the dispensing apparatus 210 to dispense a septic treatment composition according to a selected dispensing operation sequence from among at least a plurality of dispensing operation sequences, the selected dispensing operation sequence selected based on processing external data (e.g., cartridge data) received from an external device (e.g., user device 500), each dispensing operation sequence of the plurality of dispensing operation sequences associated with at least one of a separate dispensing operation frequency, a separate amount of septic treatment composition dispensed per dispensing operation, or a separate maximum dispensing operation quantity.

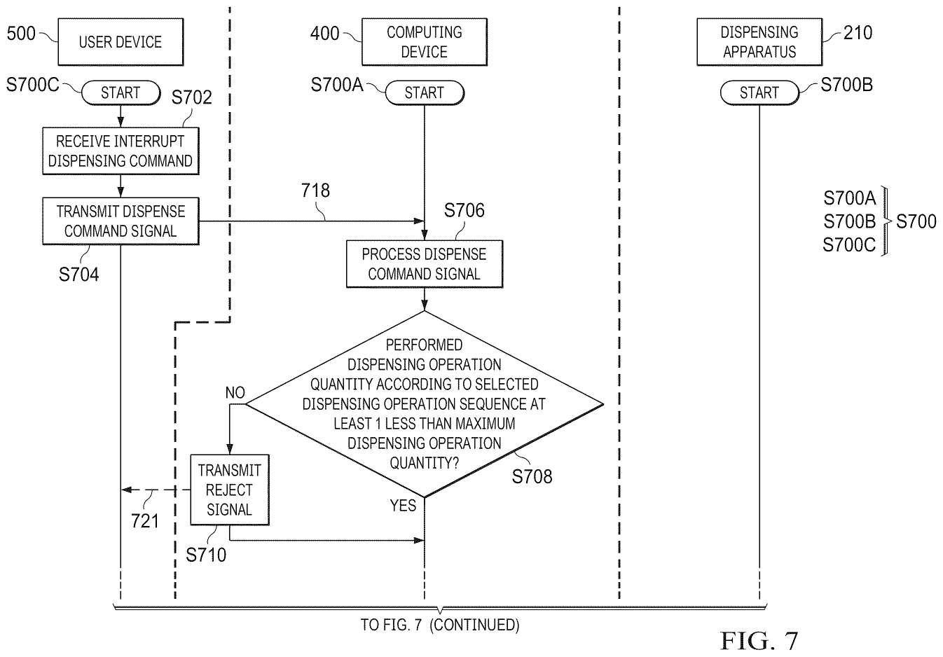

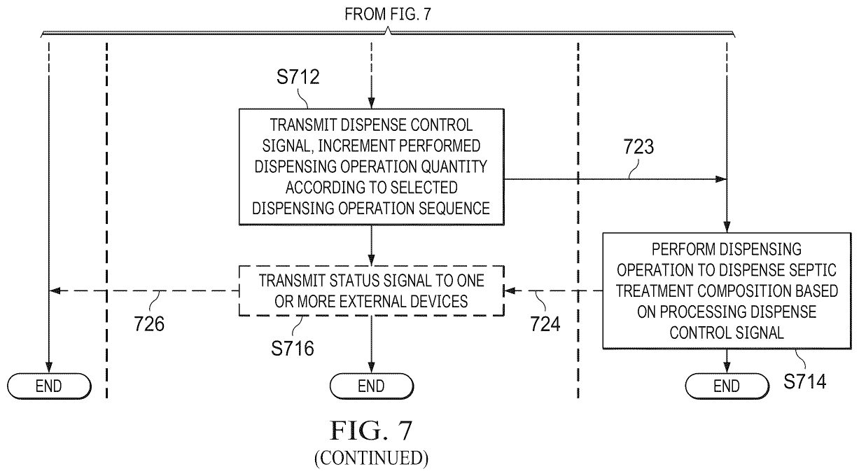

FIG. 7 is a flowchart illustrating a method S700 of operation of a septic treatment system according to some example embodiments. The method shown in FIG. 7 may be implemented with regard to the septic treatment system 1000 as shown in FIGS. 1 to 4, including the computing device 400, the dispensing apparatus 210, and the user device 500, although example embodiments are not limited thereto, and it will be understood that the method S700 shown in FIG. 7 may be implemented by a septic treatment system 1000 that is different from what is shown in FIGS. 1-4. As shown, method S700 may include respective methods S700A, S700B, and S700C performed by the computing device 400, the dispensing apparatus 210, and the user device 500, respectively, of the septic treatment system 1000. In some example embodiments, one or more of methods S700A to S700C may be performed independently of one or more others of methods S700A to S700C.

One or more operations of the method S700 shown to be implemented by the computing device 400 may be implemented by the user device 500, the dispensing apparatus 210, or any combination thereof. One or more operations of the method S700 shown to be implemented by the user device 500 may be implemented by the computing device 400. Operations of method S700 shown to be implemented by the computing device 400 may be implemented based on processor 420 executing a program of instructions stored at memory 430. Operations of method S700 shown to be implemented by the user device 500 may be implemented based on processor 520 executing a program of instructions stored at memory 530. Operations of method S700 shown to be implemented by the dispensing apparatus 210 may be implemented based on a processor of controller 218A executing a program of instructions stored at a memory of the controller 218A. It will be understood that operations shown to be performed in FIG. 7 may be performed in a different order than shown. One or more operations of method S700 may be omitted, and one or more operations may be added to method S700.

At S702, the user device 500 receives an interrupt dispensing command (also referred to as a manual dispensing command) via a user interface of the user device 500 (e.g., based on user interaction with a user interface 540 of the user device 500). At S704, the user device 500 transmits a dispense command signal 718 to the computing device 400 via the communication link 802C. The dispense command signal 718 may indicate a particular dispensing apparatus 210 associated with the interrupt dispensing command.

At S706, the computing device 400 receives and processes the dispense command signal 718 received from the user device 500 to determine that an interrupt dispensing operation is commanded to be performed by a particular dispensing apparatus 210. The processing at S706 may include determining that the dispense command signal is received from a particular user device 500 and/or is associated with a particular user account 920 that is associated with a particular dispensing apparatus 210.

At S708, the computing device 400 determines whether the dispensing apparatus 210 is performing a selected dispensing operation sequence 912 (which may be determined based on processing user account data of the user account 920 associated with the dispensing apparatus 210) and the computing device 400 may determine whether the quantity of dispensing operations already performed by the dispensing apparatus 210 according to the selected dispensing operation sequence 912 is at least one less than a maximum dispensing operation quantity associated with the selected dispensing operation sequence 912. If not, at S710 the computing device 400 refrains from enabling the interrupt dispensing operation and may transmit a rejection signal 721 to the user device 500 via the communication link 802C (although example embodiments are not limited thereto).

If so (S708=YES), at S712 the computing device 400 transmits a dispensing control signal 723 to the dispensing apparatus 210, commanding the dispensing apparatus 210 to perform an interrupt dispensing operation independently of the selected dispensing operation sequence 912 currently being performed by the dispensing apparatus 210. At S714, the dispensing apparatus 210 receives and processes the dispensing control signal and further performs the interrupt dispensing operation independently of the selected dispensing operation sequence 912 to dispense an amount of a septic treatment composition 202. The dispensing apparatus 210 and/or the computing device 400 may increment a record of a quantity of dispensing operations performed according to the selected dispensing operation sequence 912 to account for the interrupt dispensing operation. For example, in example embodiments where the dispensing apparatus 210 utilizes a counter to track the quantity of dispensing operations performed according to the selected dispensing operation sequence 912, the dispensing apparatus 210 may increment the counter based on performing the dispensing operation at S714.

At S716, the computing device 400 may receive one or more status signals 724 from the dispensing apparatus 210. The computing device 400 may process the status signal 724 to determine a status of the dispensing apparatus 210. The computing device 400 may transmit a status signal 726 indicating the status of the dispensing apparatus 210 to the user device 500 that is associated with the user account 920 (e.g., via communication link 802C). The user device 500 may receive the status signal 726 and may provide information indicated by the status signal 726, including information indicating the status of the dispensing apparatus 210, to a user supported by the user device 500.

As shown, method S700 may include method S700A performed by the computing device 400, including operations S706, S708, S710, S712, and S716, method S700B performed by the dispensing apparatus 210, including operation S714, and method S700C performed by the user device 500 and including operations S702 and S704. Based on performance of method S700 or any portion thereof (e.g., performance of at least method S700A), the computing device 400 may control the dispensing apparatus 210 through the communication link 802A based on transmitting a dispensing control signal 723 to the dispensing apparatus 210 to cause the dispensing apparatus 210 to perform an interrupt dispensing operation independently of the selected dispensing operation sequence 912, in response to receiving a signal (e.g., dispense command signal 718) from a remote device (e.g., user device 500).

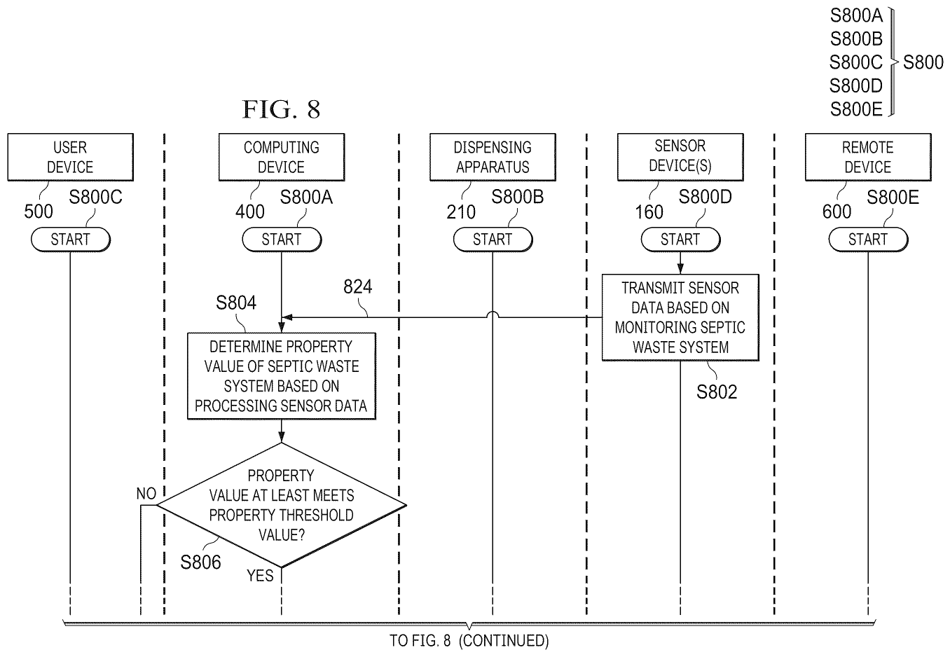

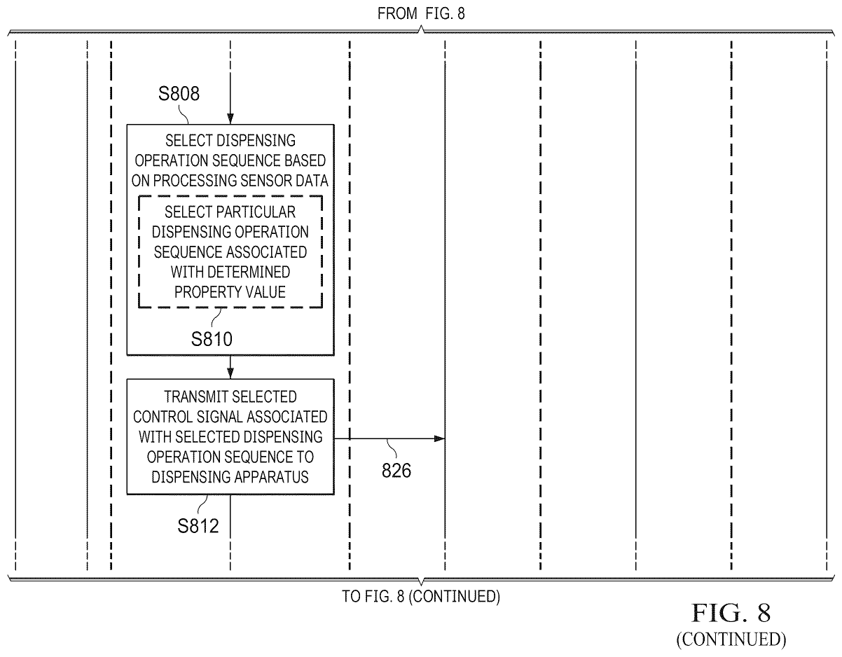

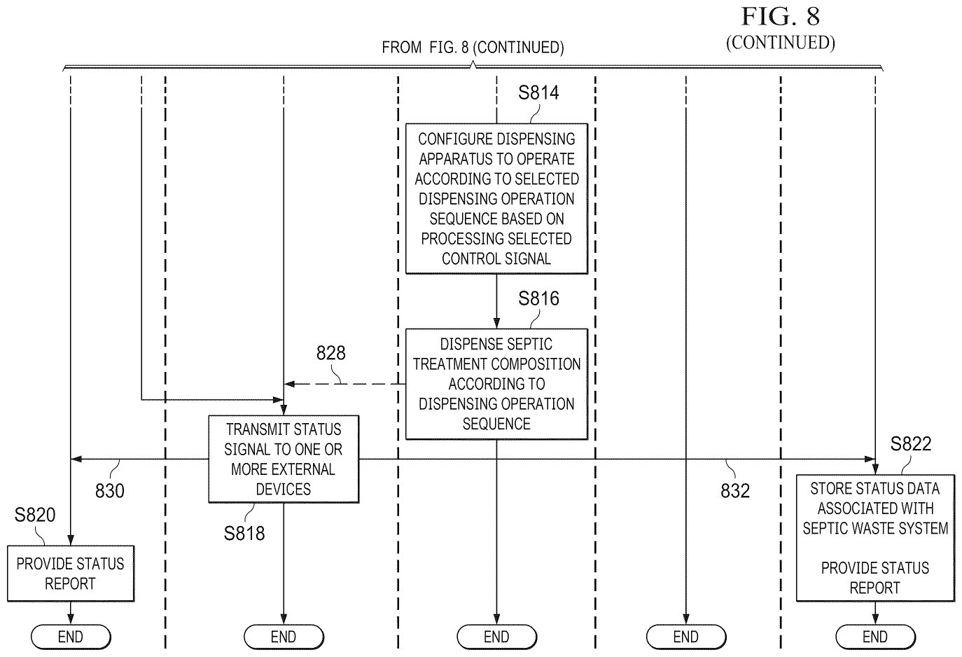

FIG. 8 is a flowchart illustrating a method S800 of operation of a septic treatment system according to some example embodiments. The method shown in FIG. 8 may be implemented with regard to the septic treatment system 1000 as shown in FIGS. 1 to 4, including the computing device 400, the dispensing apparatus 210, the user device 500, the sensor device 160, and the separate remote device 600, although example embodiments are not limited thereto, and it will be understood that the method S800 shown in FIG. 8 may be implemented by a septic treatment system 1000 that is different from what is shown in FIGS. 1-4. As shown, method S800 may include respective methods S800A, S800B, S800C, S800D, and S800E performed by the computing device 400, the dispensing apparatus 210, the user device 500, one or more sensor devices 160, and the remote device 600, respectively. In some example embodiments, one or more of methods S800A to S800E may be performed independently of one or more others of methods S800A to S800E.

One or more operations of the method S800 shown to be implemented by the computing device 400 may be implemented by the user device 500, the dispensing apparatus 210, or any combination thereof. One or more operations of the method S800 shown to be implemented by the user device 500 may be implemented by the computing device 400. Operations of method S800 shown to be implemented by the computing device 400 may be implemented based on processor 420 executing a program of instructions stored at memory 430. Operations of method S800 shown to be implemented by the user device 500 may be implemented based on processor 520 executing a program of instructions stored at memory 530. Operations of method S800 shown to be implemented by the dispensing apparatus 210 may be implemented based on a processor of controller 218A executing a program of instructions stored at a memory of the controller 218A. It will be understood that operations shown to be performed in FIG. 8 may be performed in a different order than shown. One or more operations of method S800 may be omitted, and one or more operations may be added to method S800.

Referring to FIG. 8, at S802, one or more sensor devices 160 may generate sensor data based on monitoring one or more portions of a septic waste system 102 and may transmit the sensor data 824 to the computing device 400 (e.g., via communication link 802B). As shown in FIG. 1, the one or more sensor devices 160 may include any one of a sensor device 160A configured to monitor an interior of the septic tank 110, a sensor device 160B configured to monitor a level, presence, or concentration of material in a drain field, a sensor device 160C configured to monitor at least one of a presence or concentration of liquid, bacteria, and/or nutrients in soil within a threshold proximity (e.g., 5 meters) of the drain field 114, a sensor device 160D configured to monitor at least one of a presence or concentration of liquid, bacteria, and/or nutrients in soil within a threshold proximity (e.g., 5 meters horizontally) of the septic tank 110, any combination thereof, or the like.

At S804, the computing device may process the sensor data received from one or more sensor devices 160 to determine a value of at least one property of the septic waste system 102. The at least one property may include at least one of a level of waste within the septic tank 110, a level of liquid within the drain field 114, at least one of a presence or concentration of bacteria and/or nutrients within the drain field 114, a presence, level, or concentration of liquid in soil within a threshold proximity (e.g., 5 meters) of the septic tank 110, the drain field 114, or any combination thereof, or at least one of a presence or concentration of bacteria and/or nutrients in soil within a threshold proximity (e.g., 5 meters) of the septic tank 110, the drain field 114, or any combination thereof.

At S806, the computing device 400 may determine whether at least one property determined at S804 has a value that at least meets a corresponding at least one property threshold value (which may be a threshold value that is stored at a memory accessible by the computing device 400). If not (S806=NO), the method proceeds to S818. If so (S806=YES), the method proceeds to S808.

At S808, in response to a determination that at least one property of the septic waste system 102 (determined based on processing sensor data received from one or more sensor devices 160) at least meets a corresponding at least one threshold value (S806=YES), the computing device 400 may select a particular dispensing operation sequence from among at least the plurality of dispensing operation sequences 910 (which may be stored at the computing device 400). For example, at S810, the computing device 400 may access a database (e.g., an empirically generated look-up table) which may be stored at memory 430 or accessed from a device communicatively coupled to the computing device 400, which associates separate dispensing operation sequences of the plurality of dispensing operation sequences 910 with separate, respective determinations of threshold property values that at least meet, as determined by sensor data. The computing device 400 may access the database and determine, as a selected dispensing operation sequence 912, a particular dispensing operation sequence that is indicated by the database to be associated with the particular at least one property being determined at S806, based on processing sensor data, to at least meet a corresponding at least one threshold property value.

At S812, the computing device 400 may transmit a particular control signal 826 associated with the selected dispensing operation sequence 912 that is determined at S808 to the dispensing apparatus 210 associated with the same user account 920 as the one or more sensor devices 160. The computing device 400 may transmit the particular control signal 826 to a particular dispensing apparatus 210 determined to be associated with the same user account 920 that is associated with the one or more sensor devices 160 from which the sensor data 824 is received.

At S814, the dispensing apparatus 210 may receive the control signal from the computing device 400 and may configure (e.g., program) the dispensing apparatus 210 to operate according to the selected dispensing operation sequence 912 based on processing the control signal. At S816, the dispensing apparatus 210 may perform the selected dispensing operation sequence 912 to controllably dispense septic treatment composition (which may be received at the dispensing apparatus 210 from a cartridge 220 coupled thereto) at a particular dispensing operation frequency (e.g., interval), at a particular amount of dispensing composition and/or duration of dispensing operation per dispensing operation, for a particular dispensing operation maximum quantity of dispensing operations, or any combination thereof.

While the method S800 as shown in FIG. 8 illustrates the computing device 400 selecting a particular dispensing operation sequence from among a plurality of dispensing operation sequences 910 based on a determination that a value (“property value”) of at least one property of the septic waste system 102, as determined based on processing sensor data received from one or more sensor device 160, at least meets a corresponding at least one property threshold value, example embodiments are not limited thereto. For example, in some example embodiments, the computing device 400 may select a dispensing operation sequence as the selected dispensing operation sequence 912 at S808 and transmit a control signal to the dispensing apparatus 210 at S812, to cause the dispensing apparatus to operate at S814-S816 according to the selected dispensing operation sequence 912, based on processing sensor data received from one or more sensor devices 160. For example, at S808 the computing device 400 may select a particular dispensing operation sequence as the selected dispensing operation sequence 912 based on determining that sensor data received from one or more sensor devices 160 indicates that at least one property of the septic waste system 102 (e.g., a level of waste, such as the level of the top surface of waste 170 in the septic tank 110) has a certain value, where the computing device 400 may determine at S808, as the selected dispensing operation sequence 912, a corresponding dispensing operation sequence associated with the determined value (“property value”) of the at least one property as indicated by the sensor data (e.g., based on accessing a database such as a look-up table that associates one or more property values determined based on processing sensor data from one or more sensor devices 160 with corresponding dispensing operation sequences), and then select and transmit a selected control signal at S812 to cause the dispensing apparatus 210 to perform the selected dispensing operation sequence 912.

While the computing device 400 may select a dispensing operation sequence at S808 from among a plurality of dispensing operation sequences 910 (e.g., which may be stored at memory 430), example embodiments are not limited thereto. For example, at S808 the computing device 400 may select a particular dispensing operation sequence as the selected dispensing operation sequence 912 based on generating a new dispensing operation sequence to form the selected dispensing operation sequence 912, based on processing sensor data received from one or more sensor devices 160. To generate the new dispensing operation sequence, the computing device 400 at S808 may access a database (e.g., a look-up table) and determine one or more dispensing operation sequence properties (e.g., dispensing operation frequency, amount, and/or maximum dispensing quantity duration) associated with respective property values of at least one property of the septic waste system 102, and the computing device 400 may select, as one or more properties of the new (generated) dispensing operation sequence, one or more properties indicated by the database to be associated with a respective property value of one or more properties of the septic waste system 102 that is/are determined based on processing sensor data at S804.

In some example embodiments, S806 may be omitted (e.g., such that the computing device 400 does not perform S806). Instead, at S808 the computing device 400 may, based on a property value of the septic waste system 102 (e.g., level of waste in the septic tank 110) that is determined based on processing sensor data at S804, generate, as the selected dispensing operation sequence 912, a new dispensing operation sequence (which may not be a stored dispensing operation sequence) to have a particular set of properties (e.g., dispensing operation frequency, dispensing operation amount, and/or maximum dispensing operation quantity) corresponding to the property value of the property of the septic waste system 102 determined at S804. For example, the computing device 400 may, at S808, access a database (e.g., a look-up table) that associates the determined property value with one or more corresponding properties of a dispensing operation sequence to be selected. The computing device 400 may adjust the properties of the selected dispensing operation sequence 912 currently being performed by the dispensing apparatus 210 (e.g., most recently previously selected by the computing device 400 for the dispensing apparatus 210) to have one or more property values associated with the determined property value. The computing device 400 may thereby, at S808, generate a new dispensing operation sequence as the selected dispensing operation sequence 912 (e.g., a dispensing operation sequence that is different from dispensing operation sequences that may be stored at a memory and selected by the computing device 400), and the computing device 400 may transmit a new control signal at S812 to the dispensing apparatus 210 to cause the dispensing apparatus 210 to perform the generated selected dispensing operation sequence 912. As a result, the computing device 400 may be configured to implement responsive control of the septic waste system 102 with an improved level of granularity and improved response time to reduce, minimize, or prevent one or more properties of the septic waste system 102 from reaching one or more undesirable values (e.g., excessive accumulation of waste in the septic tank 110 due to low decomposition activity by the decomposition agent 180 in the septic tank 110). For example, in response to determining, based on processing sensor data from sensor device 160A at S804, that a level of waste (e.g., the level of the top surface of the scum 174) in the septic tank 110 has a certain value, the computing device 400 may at S808 generate a new dispensing operation sequence to have a corresponding dispensing operation frequency, dispensing operation amount, and/or dispensing operation maximum quantity that is indicated by a database (e.g., a look-up table) to be associated with the determined value of the level of waste in the septic tank 110, where the generated dispensing operation sequence is selected as the selected dispensing operation sequence 912 and the computing device 400 further transmits a control signal at S812 to the dispensing apparatus 210 associated with the same user account 920 as the sensor device 160A to cause the dispensing apparatus 210 to perform the new selected dispensing operation sequence which may be particularly generated based on processing sensor data received from one or more sensor devices 160.

In some example embodiments, the computing device 400 may cause the dispensing apparatus 210 to perform a dispensing operation independently of the currently-performed selected dispensing operation sequence 912 (e.g., corresponding to S712 in method S700, excluding some or all of the other operations of method S700) based on processing sensor data received from one or more sensor devices 160 (e.g., based on determining that the sensor data indicates that one or more properties of the septic waste system 102, including but not limited to the level of waste such as organic waste 170 in the septic tank 110), for example based on a determination that the sensor data indicates that a property value of at least one property of the septic waste system 102 being monitored by the one or more sensor devices 160 at least meets a corresponding at least one property threshold value (e.g., S806=YES) (where such threshold value(s) may be loaded from a memory such as 430). The computing device 400 may cause the dispensing apparatus 210 to perform a dispensing operation independently of the currently-performed selected dispensing operation sequence 912 in addition to or instead of performing operations S808, S812, S814, and/or S816 in response to S806=YES. For example, in response to determining a property value of at least one property of the septic waste system 102 at S804, alone or in combination with a determination at S806 that the property value at least meets a corresponding at least one property threshold value (S806=YES), the computing device 400 may transmit a dispensing control signal (corresponding to S712 in method S700) to cause the dispensing apparatus 210 to perform a dispensing operation independently of the selected dispensing operation sequence 912 currently being performed by the dispensing apparatus 210. Such a transmission of the dispensing control signal (corresponding to S712) in response to S806=YES may be performed in addition to or instead of selecting a new dispensing operation sequence at S808 and transmission of a selected control signal associated with it at S812 (e.g., S808 and S812 may be bypassed in combination with performing an operation corresponding to S712 in response to S806=YES).

At S818, the computing device 400 may transmit a status signal 830 and/or 832 to at least one of the user device 500 or a separate remote device 600 supporting a separate third-party entity (e.g., a government agency), where the status signal 830 and/or 832 includes information indicating the determined at least one property of the septic waste system 102, the sensor data received from the one or more sensor devices 160 at S804, an indication that at least one property of the septic waste system 102 at least meets a corresponding at least one property threshold value, an indication of a newly selected dispensing operation sequence 912, or any combination thereof. As shown, at S820 the user device 500 may receive and process the status signal 830 to provide, to a supported user via a user interface of the user device 500, an indication of the at least one property of the septic waste system 102 and/or the sensor data. As further shown, at S822 the separate remote device 600 may receive and process the status signal 832 to generate a report of the status of the septic waste system 102 and/or to store the data indicated by the status signal 832 in a database that associates the data with a database entry associated with the septic waste system 102.

As shown, method S800 may include method S800A performed by the computing device 400 and including operations S804, S806, S808, S810, S812, and S818, method S800B performed by the dispensing apparatus 210 and including operations S814 and S816, method S800C performed by the user device 500 and including operation S820, method S800D performed by the one or more sensor devices 160 and including operation S802, and/or method S800E performed by the separate remote device 600 and including operation S822. Based on performance of method S800 or any portion thereof (e.g., performance of at least method S800A), the computing device 400 may receive external data including sensor data 824 received from a sensor device 160 based on the sensor device 160 monitoring at least a portion of a septic waste system 102, and the computing device 400 may select the selected dispensing operation sequence 912 and control the dispensing apparatus to operate according to the same, based on processing the sensor data 824 to determine at least one property of the septic system, the at least one property including at least one of: a level of waste within the septic tank, a level of liquid within a drain field of the septic system, at least one of a presence or concentration of bacteria and/or nutrients within a drain field of the septic system, a presence, level, or concentration of liquid in soil within a threshold proximity of the septic tank, a drain field of the septic system, or any combination thereof, or at least one of a presence or concentration of bacteria and/or nutrients in soil within a threshold proximity of the septic tank, a drain field of the septic system, or any combination thereof.

The computing device 400 may therefore, at S800, transmit a control signal 826 to a dispensing apparatus 210 through a second communication link (802A) to cause the dispensing apparatus 210 to dispense a septic treatment composition according to a selected dispensing operation sequence 912 from among at least a plurality of dispensing operation sequences, where the selected dispensing operation sequence 912 is selected based on processing external data (including sensor data 824 received from a sensor device 160 based on the sensor device 160 monitoring at least a portion of a septic waste system 102), each dispensing operation sequence of the plurality of dispensing operation sequences associated with at least one of a separate dispensing operation frequency, a separate amount of septic treatment composition dispensed per dispensing operation, or a separate maximum dispensing operation quantity.

Additionally, the computing device 400 may, at S800, transmit a signal (status signal 830 and/or 832) to a remote electronic device (e.g., user device 500 and/or remote device 600) based on processing sensor data 824 received from a sensor device 160 to determine at least one property associated with the septic waste system 102, the sensor data received based on the sensor device 160 monitoring at least a portion of the septic waste system 102, the signal including status information indicating a status of the septic waste system 102, the at least one property including at least one of: a level of waste within the septic tank 110, a level of liquid within a drain field 114 of the septic waste system 102, at least one of a presence or concentration of bacteria and/or nutrients within a drain field 114 of the septic waste system 102, a presence, level, or concentration of liquid in soil 106 within a threshold proximity of the septic tank 110, a drain field 114 of the septic waste system 102, or any combination thereof, or at least one of a presence or concentration of bacteria and/or nutrients in soil 106 within a threshold proximity of the septic tank 110, a drain field 114 of the septic waste system 102, or any combination thereof.

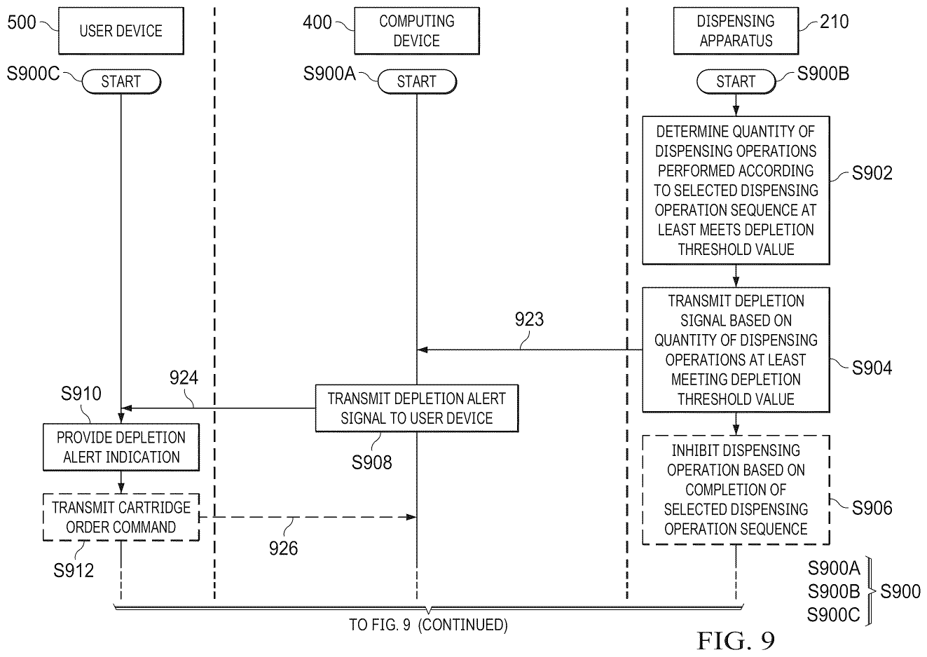

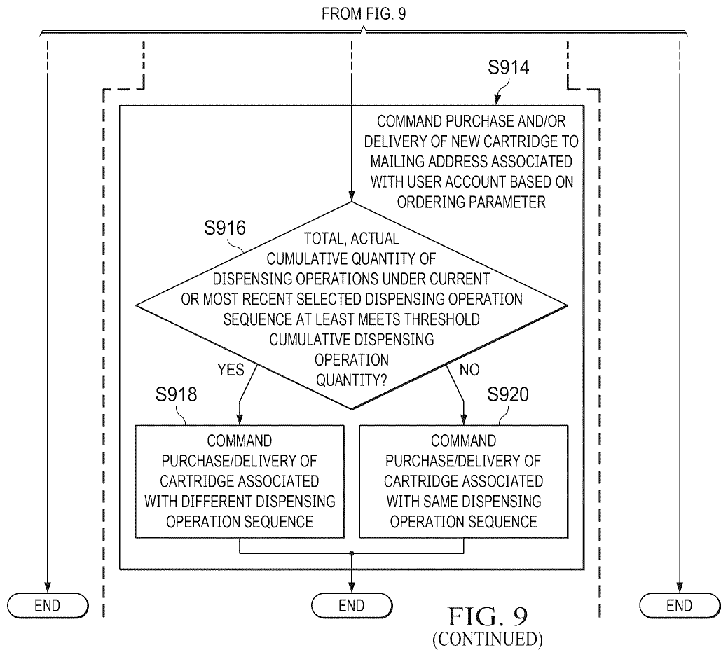

FIG. 9 is a flowchart illustrating a method S900 of operation of a septic treatment system according to some example embodiments. The method shown in FIG. 9 may be implemented with regard to the septic treatment system 1000 as shown in FIGS. 1 to 4, including the computing device 400, the dispensing apparatus 210, and the user device 500, although example embodiments are not limited thereto, and it will be understood that the method S900 shown in FIG. 9 may be implemented by a septic treatment system 1000 that is different from what is shown in FIGS. 1-4. As shown, method S900 may include respective methods S900A, S900B, and S900C performed by the computing device 400, the dispensing apparatus 210, and the user device 500, respectively, of the septic treatment system 1000. In some example embodiments, one or more of methods S900A to S900C may be performed independently of one or more others of methods S900A to S900C.

One or more operations of the method S900 shown to be implemented by the computing device 400 may be implemented by the user device 500, the dispensing apparatus 210, or any combination thereof. One or more operations of the method S900 shown to be implemented by the user device 500 may be implemented by the computing device 400. Operations of method S900 shown to be implemented by the computing device 400 may be implemented based on processor 420 executing a program of instructions stored at memory 430. Operations of method S900 shown to be implemented by the user device 500 may be implemented based on processor 520 executing a program of instructions stored at memory 530. Operations of method S900 shown to be implemented by the dispensing apparatus 210 may be implemented based on a processor of controller 218A executing a program of instructions stored at a memory of the controller 218A. It will be understood that operations shown to be performed in FIG. 9 may be performed in a different order than shown. One or more operations of method S900 may be omitted, and one or more operations may be added to method S900.

At S902, the dispensing apparatus 210 determines that a quantity of dispensing operations performed according to a selected dispensing operation sequence 912 has at least reached a depletion threshold value, such that a quantity of “remaining” dispensing operations to be performed according to the selected dispensing operation sequence is equal to or less than a threshold value. The depletion threshold value may be the same as the dispensing operation maximum quantity of the selected dispensing operation sequence 912, although example embodiments are not limited thereto. For example, in some example embodiments, the depletion threshold value may be 1 or 2 less than the dispensing operation maximum quantity of the selected dispensing operation sequence 912. The depletion threshold value may be any value that is equal to or less than the dispensing operation maximum quantity of the selected dispensing operation sequence 912. The dispensing apparatus 210 may determine the depletion threshold value based on processing instructions loaded from a memory of the dispensing apparatus 210.

At S904, in response to the determination at S902, the dispensing apparatus 210 transmits a depletion signal 923 to the computing device 400 through the communication link 802A. In some example embodiments, the dispensing apparatus 210 may further, at S906, inhibit the dispensing apparatus 210 from performing further dispensing operations according to the selected dispensing operation sequence in response to a determination that the quantity of dispensing operations performed by the dispensing apparatus 210 according to the selected dispensing operation sequence 912 has reached a maximum dispensing operation quantity associated with the selected dispensing operation sequence 912 (which may be equal to or greater than the depletion threshold value). The dispensing apparatus 210 may remain inhibited until receiving a control signal (e.g., at 616 or 826) to perform dispensing operations according to a selected dispensing operation sequence 912.

At S908, the computing device 400 receives the depletion signal from the dispensing apparatus 210 and, based on processing the received depletion signal, transmits a depletion alert signal 924 to the user device 500 supporting a user and associated with the same user account 920 as the dispensing apparatus 210 from which the depletion signal 923 is received. The depletion alert signal 924 includes data indicating that a quantity of dispensing operations performed at the dispensing apparatus 210 according to a selected dispensing operation sequence 912 has at least reached a threshold value (e.g., a dispensing operation maximum quantity associated with the selected dispensing operation sequence 912).

At S910, the user device 500 processes the depletion alert signal 924 and may provide information associated with the depletion alert signal 924 (e.g., a depletion alert indication) to a user supported by the user device 500, for example through a user interface 540 of the user device 500, based on processing the depletion alert signal 924. The information provided to the user may indicate that a quantity of dispensing operations performed by the dispensing apparatus 210 associated with the user account 920, and that is also associated with the user, according to a selected dispensing operation sequence 912 has at least reached a threshold value (e.g., the associated dispensing operation maximum value), an indication that a cartridge 220 coupled to the particular dispensing apparatus 210 is at least partially or entirely depleted of septic treatment composition, or any combination thereof. At S912, the user device 500 may provide a supported user with an interface to enable manual ordering of one or more new cartridges 220 to replace the currently-coupled cartridge 220 currently coupled to the dispensing apparatus 210, and the user device 500 may transmit a cartridge order command signal 926 to the computing device 400 (e.g., based on user interaction with the user interface 540).

At S914, the computing device 400, having associated the dispensing apparatus 210, and/or the user account 920 associated therewith, with the selected dispensing operation sequence 912 (e.g., at S608 and/or S612 in method S600), may determine that the quantity of dispensing operations performed by the dispensing apparatus 210 according to the selected dispensing operation sequence 912 is equal to the maximum dispensing operation quantity associated with the selected dispensing operation sequence 912 in response to receiving the depletion signal 923, even if the dispensing apparatus 210 transmits the depletion signal 923 in response to determining that the actual quantity of dispensing operations performed at S902 is a depletion threshold value that is less than the maximum dispensing operation quantity associated with the selected dispensing operation sequence 912.

The computing device 400 may further access user account information associated with the user account 920 that is further associated with the dispensing apparatus 210 to add the determined quantity of dispensing operations performed by the dispensing apparatus 210 according to the selected dispensing operation sequence 912 to a stored cumulative quantity of dispensing operations performed by the particular dispensing apparatus 210 associated with the user account 920 over one or more sequential, contiguous iterations of the same, current, or most recent selected dispensing operation sequence 912 (e.g., over multiple iterations of S600 using the same selected dispensing operation sequence and the coupling and depletion of multiple cartridges 220 coupled to the dispensing apparatus 210) to determine a total, actual cumulative quantity of dispensing operations performed by the dispensing apparatus 210 according to the selected dispensing operation sequence 912 (e.g., over one or more sequential, contiguous iterations of the same, current, or most recent selected dispensing operation sequence 912).

Still referring to S914, at S916 the computing device 400 may determine whether the total, actual cumulative quantity of dispensing operations performed by the dispensing apparatus 210 according to the selected dispensing operation sequence 912 at least meets a threshold cumulative dispensing operation quantity associated with the selected dispensing operation sequence 912. The threshold cumulative dispensing operation quantity associated with the selected dispensing operation sequence 912 may be equal to or greater than the maximum dispensing operation quantity associated with the selected dispensing operation sequence 912. In example embodiments where the threshold cumulative dispensing operation quantity associated with the selected dispensing operation sequence 912 is greater than the maximum dispensing operation quantity associated with the selected dispensing operation sequence 912, multiple iterations of methods S600 and S900 may be performed with regard to a particular dispensing operation sequence to cause the total, actual cumulative quantity of dispensing operations to equal or exceed the threshold cumulative dispensing operation quantity associated with the particular dispensing operation sequence.

At S914, the computing device 400 may command (e.g., via a transmitted order signal transmitted to the cartridge distribution system 700) at least one of purchase or delivery of a new cartridge 220 to a mailing address associated with the dispensing apparatus 210 (e.g., based on the mailing address being associated with the same user account 920 as the dispensing apparatus 210) based on an ordering parameter associated with the selected dispensing operation sequence 912 that is associated with the dispensing apparatus 210 and/or user account 920 associated with the same (e.g., an ordering parameter associated with the user account 920, a cartridge group identifier code associated with the selected dispensing operation sequence 912, or any combination thereof). The new cartridge 220 commanded to be purchased and/or delivered at S914 may be associated with either: the selected dispensing operation sequence 912, or a different dispensing operation sequence among the plurality of dispensing operation sequences 910. Such a commanding at S914 may be performed based on receiving a cartridge order command signal 926. In some example embodiments, based on a determination that the user account 920 is associated with a command to automatically (e.g., without manual interaction or manual order command receipt) command the purchase and/or delivery of a new cartridge to the mailing address associated with the user account 920 (e.g., using payment information associated with the user account 920), the computing device 400 may perform S914 independently of any cartridge order command signal 926.

Referring generally to S914, the computing device 400 may command the purchase and/or delivery of a new cartridge 220 associated with either a same cartridge group identifier code or a different cartridge group identifier code (and thus associated with a same dispensing operation sequence or a different dispensing operation sequence) as the cartridge 220 currently coupled with the dispensing apparatus 210 at S902. For example, at S916, the computing device 400 may access the user account 920 associated with the dispensing apparatus 210, which may include information indicating at least one of a current selected dispensing operation sequence 912 that the dispensing apparatus 210 is currently or most recently performing and information indicating a total, actual cumulative quantity of dispensing operations performed by the dispensing apparatus 210 over one or more sequential, contiguous iterations of a same selected dispensing operation sequence 912. The user account data may include an ordering parameter that is associated with the current selected dispensing operation sequence 912 currently or most recently being performed by a dispensing apparatus 210 associated with the user account 920. The ordering parameter may indicate a threshold cumulative dispensing operation quantity associated with the selected dispensing operation sequence 912 and further associated with ordering and/or delivering a cartridge associated with a same cartridge group identifier code (and thus which may be associated with a same cartridge group 722 and thus associated with a same dispensing operation sequence as the currently-coupled cartridge 220) as the current selected dispensing operation sequence 912 used by the dispensing apparatus 210 or with a particular different dispensing operation sequence.

At S916, the commanding at S914 may include determining whether a total, actual cumulative quantity of dispensing operations performed by the particular dispensing apparatus 210 over one or more sequential, contiguous iterations of a same, current or most recent selected dispensing operation sequence 912 (e.g., over multiple iterations of S600 using the same selected dispensing operation sequence and the coupling and depletion of multiple cartridges 220 coupled to the dispensing apparatus 210), which may be indicated by user account 920 data, is equal to or greater than a threshold cumulative dispensing operation quantity associated with the selected dispensing operation sequence 912, for example as indicated by the ordering parameter associated with the selected dispensing operation sequence 912 currently or most recently associated with the user account 920.

If not (S916=NO), at S920 the computing device 400 may transmit an order signal to the cartridge distribution system 700 that includes a command to purchase and/or deliver, to a mailing address associated with the user account 920, a new cartridge 220 included in the same cartridge group 722 associated with the cartridge group identifier code that is further associated with the same dispensing operation sequence 912 currently or most recently being used by the dispensing apparatus 210 (e.g., the same cartridge group 722 as the cartridge 220 currently or most recently coupled to the dispensing apparatus 210).

If so (S916=YES), at S918 the computing device 400 may transmit an order signal to the cartridge distribution system 700 that includes a command to purchase and/or deliver, to a mailing address associated with the user account 920, a new cartridge 220 included in a particular cartridge group 722 indicated by the ordering parameter (e.g., indicated by a particular cartridge group identifier code that is indicated by the ordering parameter) which may be a different cartridge group 722 than the cartridge group 722 that is associated with the cartridge group identifier code that is further associated with the same dispensing operation sequence 912 currently or most recently being used by the dispensing apparatus 210 (e.g., a command to purchase and/or delivery of a cartridge 220 included in a different cartridge group 722 than the cartridge 220 currently or most recently coupled to the dispensing apparatus 210).

In some example embodiments, a current selected dispensing operation sequence may not be associated with any threshold cumulative dispensing operation quantity. If so, at S914 the computing device 400 may, in response to determining that a current quantity of dispensing operations performed according to the current selected dispensing operation sequence by the dispensing apparatus 210 has reached the maximum dispensing operation quantity associated with the current selected dispensing operation sequence 912, bypass S916 to perform S920 and to transmit an order signal to the cartridge distribution system 700 that includes a command to purchase and/or deliver, to a mailing address associated with the user account 920, a new cartridge 220 included in the same cartridge group 722 associated with the cartridge group identifier code that is further associated with the same dispensing operation sequence 912 currently or most recently being used by the dispensing apparatus 210 (e.g., the same cartridge group 722 as the cartridge 220 currently or most recently coupled to the dispensing apparatus 210).

As shown, method S900 may include method S900A performed by the computing device 400 and including operations S908, S914, S916, S918, and S920, method S900B performed by the dispensing apparatus 210 and including operations S902, S904, and S906, method S900C performed by the user device 500 and including operations S910 and S912. Based on performance of method S900 or any portion thereof (e.g., performance of at least method S900A), the computing device 400 may associate the dispensing apparatus 210 with a selected dispensing operation sequence 912, track a quantity of dispensing operations performed by the dispensing apparatus 210 according to the selected dispensing operation sequence 912; and, in response to determining that the quantity of dispensing operations at least meets a threshold quantity (e.g., the maximum dispensing operation quantity associated with the selected dispensing operation sequence 912), command at least one of purchase or delivery of a new cartridge 220 to a mailing address associated with the dispensing apparatus 210 based on an ordering parameter associated with the selected dispensing operation sequence, the new cartridge 220 associated with either: the selected dispensing operation sequence 912 or a different dispensing operation sequence among the plurality of dispensing operation sequences 910.

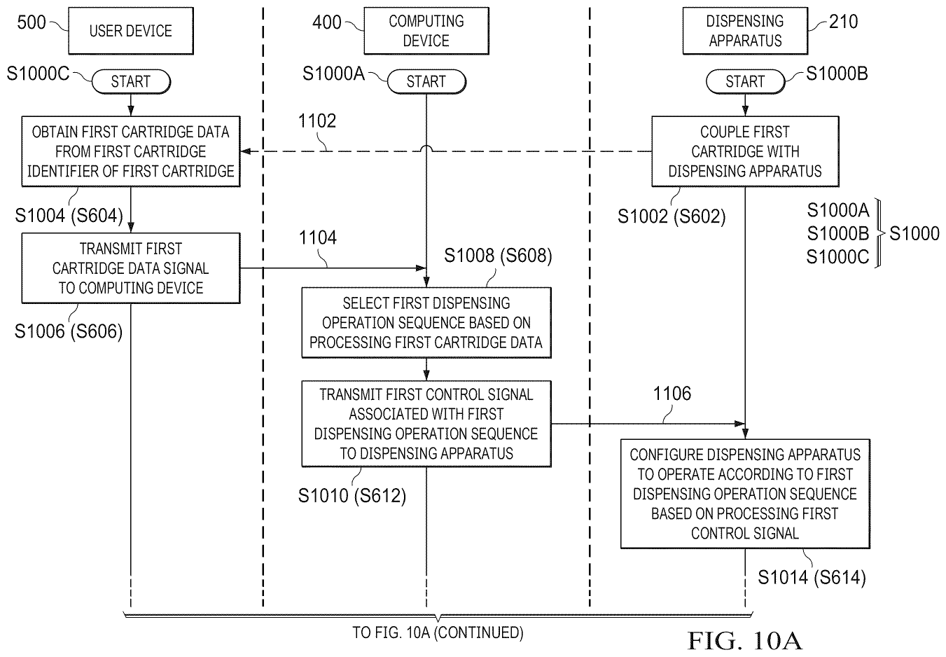

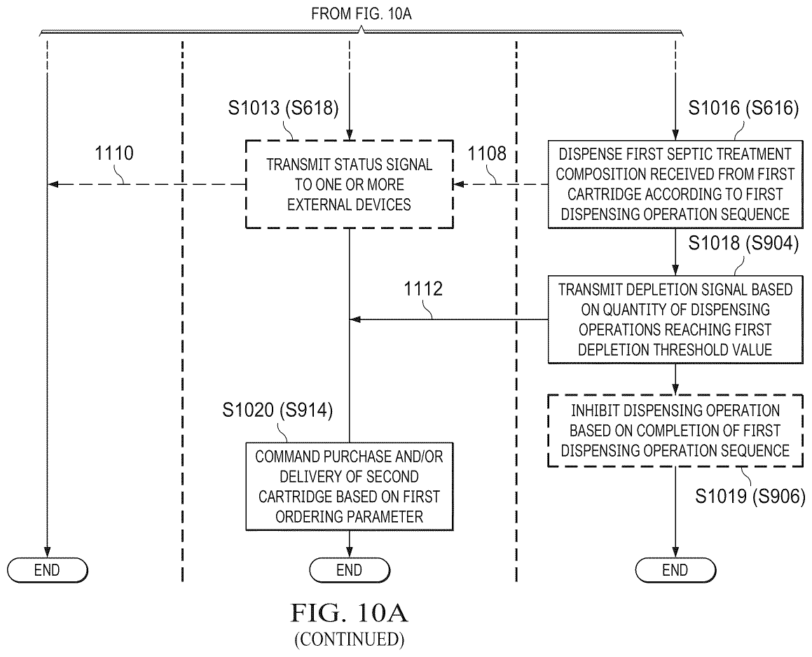

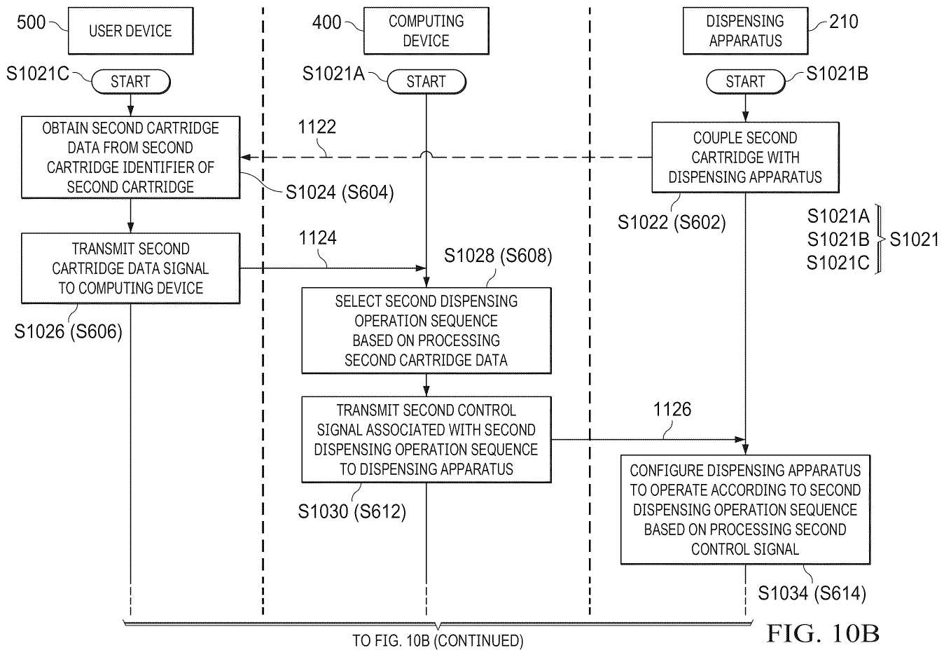

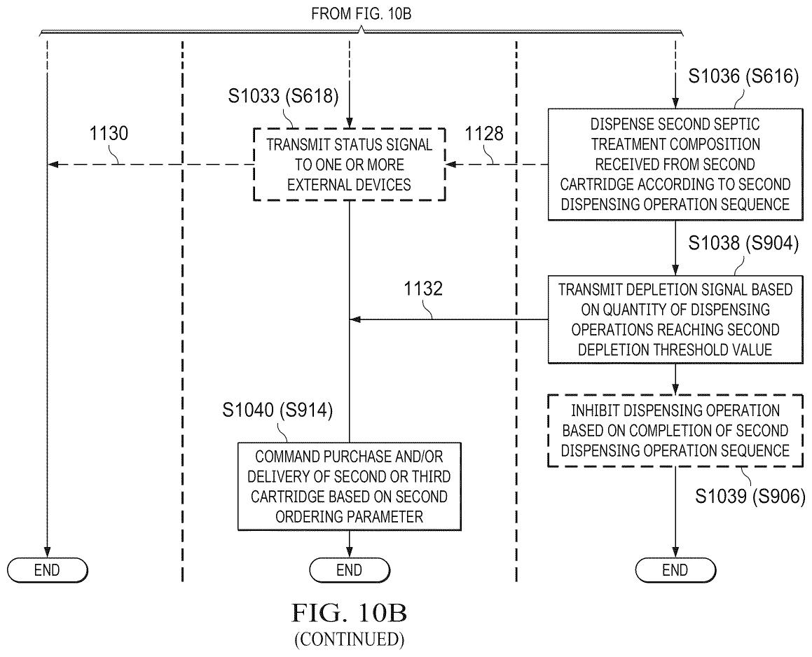

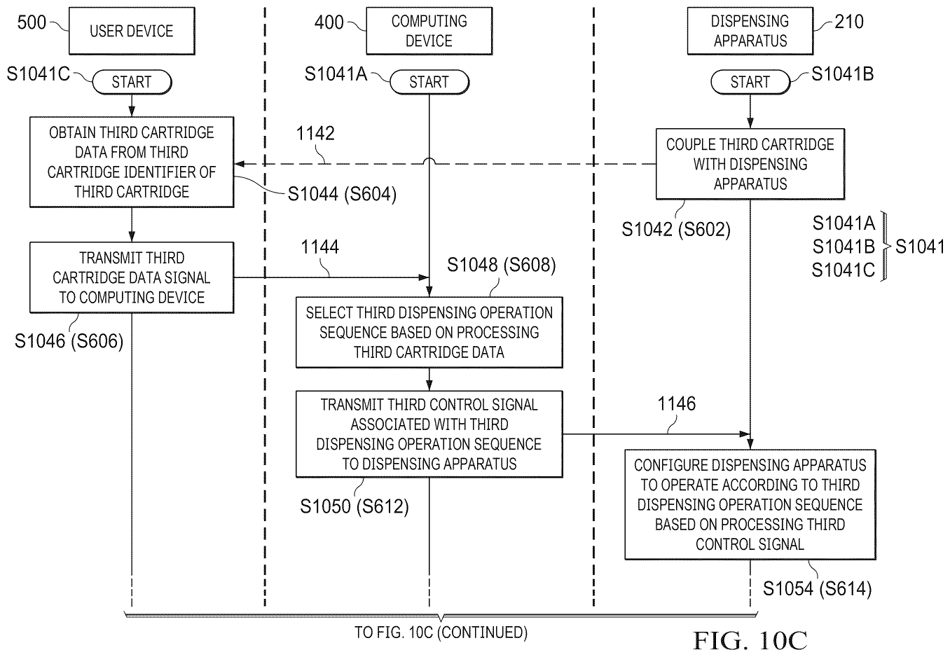

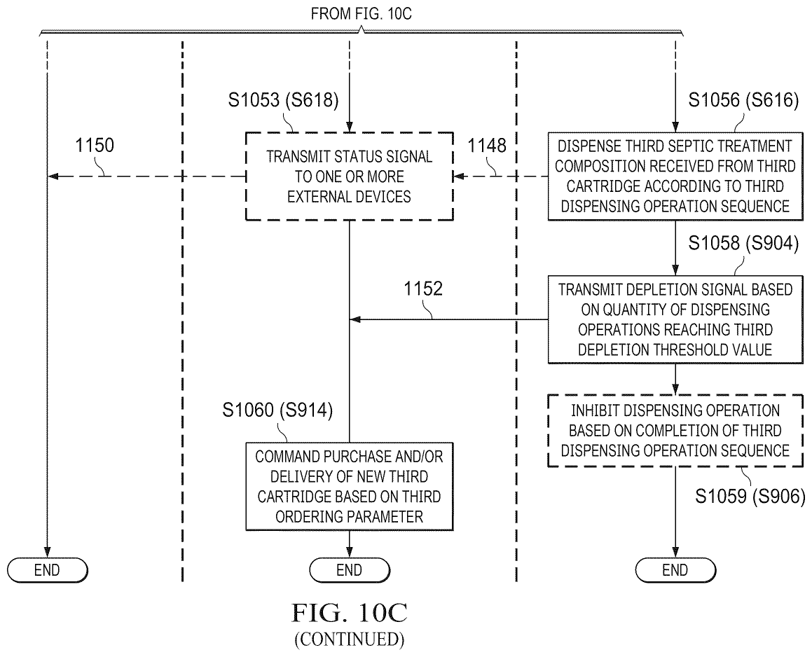

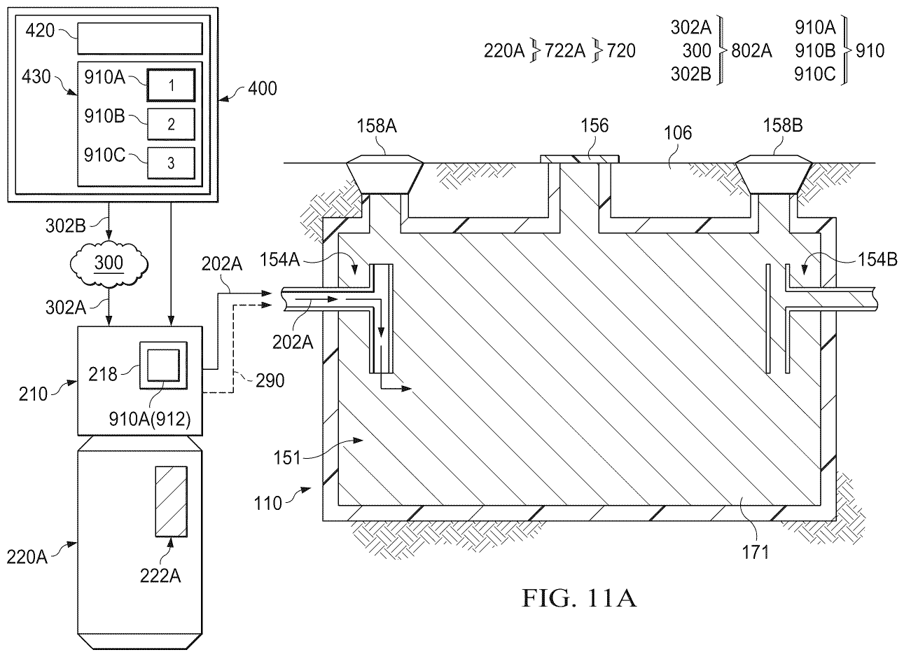

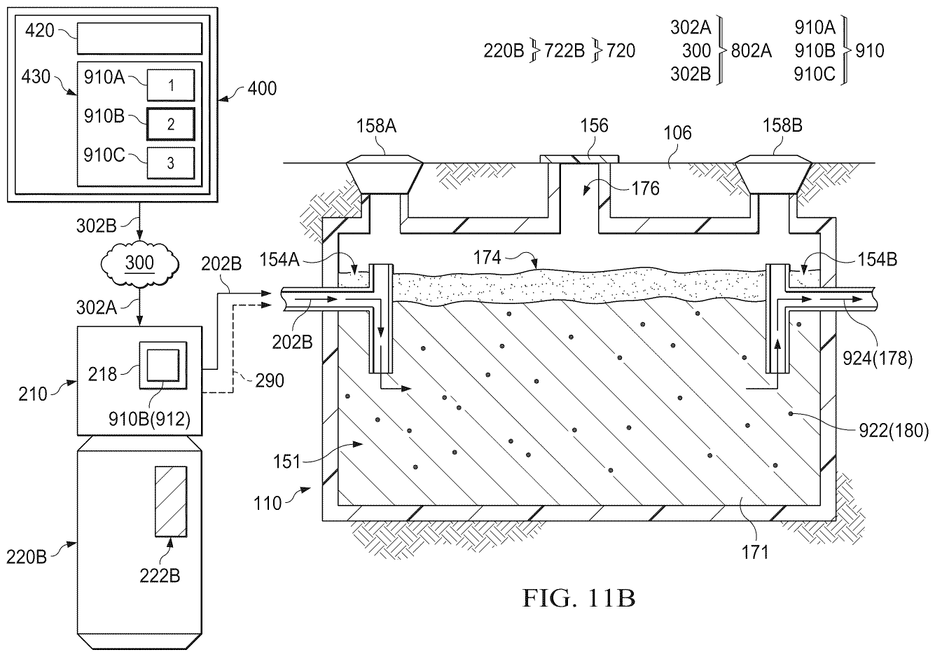

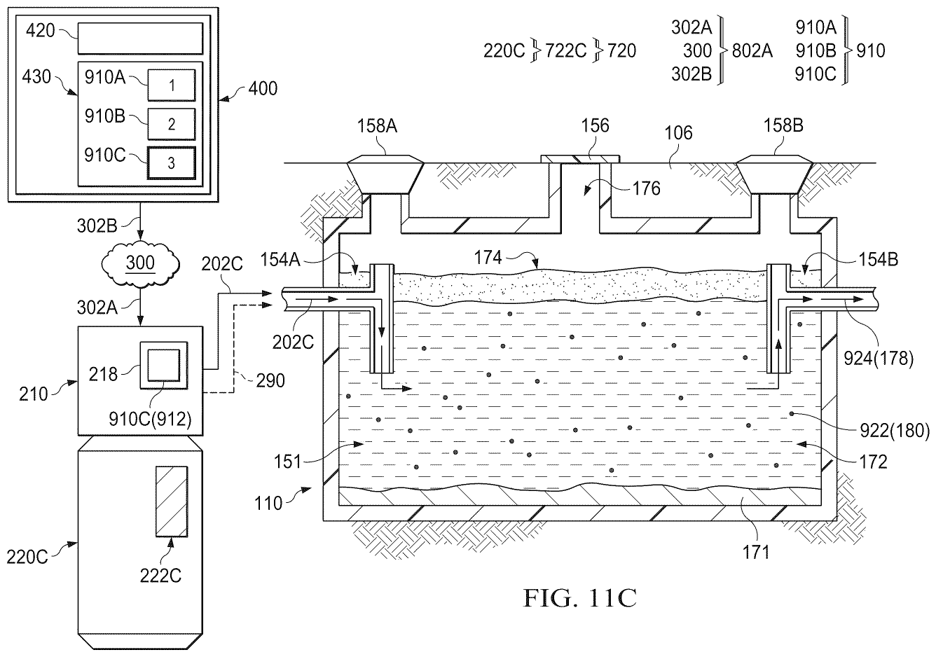

FIGS. 10A to 10C are flowcharts illustrating a method S1000 of operation of a septic treatment system according to some example embodiments. FIGS. 11A to 11C illustrate treatment of a septic tank 110 based on septic treatment compositions dispensed by the dispensing apparatus 210 of the septic treatment system based on the method S1000 of FIGS. 10A to 10C, according to some example embodiments.

The methods shown in FIGS. 10A to 10C and 11A to 11C may be implemented with regard to the septic treatment system 1000 as shown in FIGS. 1 to 4, including the computing device 400, the dispensing apparatus 210, the user device 500, the sensor device 160, and the separate remote device 600, although example embodiments are not limited thereto, and it will be understood that the methods S100, S1021, and S1041 shown in FIGS. 10A to 10C and 11A to 11C may be implemented by a septic treatment system 1000 that is different from what is shown in FIGS. 1-4. As shown, method S1000 may include respective methods S1000A, S1000B, and S1000C performed by the computing device 400, the dispensing apparatus 210, and the user device 500, respectively. In some example embodiments, one or more of methods S1000A to S1000C may be performed independently of one or more others of methods S1000A to S1000C. As shown, method S1021 may include respective methods S1021A, S1021B, and S1021C performed by the computing device 400, the dispensing apparatus 210, and the user device 500, respectively. In some example embodiments, one or more of methods S1021A to S1021C may be performed independently of one or more others of methods S1021A to S1021C. As shown, method S1041 may include respective methods S1041A, S1041B, and S1041C performed by the computing device 400, the dispensing apparatus 210, and the user device 500, respectively. In some example embodiments, one or more of methods S1041A to S1041C may be performed independently of one or more others of methods S1041A to S1041C.

One or more operations of the methods S1000, S1021, and S1041 shown to be implemented by the computing device 400 may be implemented by the user device 500, the dispensing apparatus 210, or any combination thereof. One or more operations of the methods S1000, S1021, and S1041 shown to be implemented by the user device 500 may be implemented by the computing device 400. Operations of the methods S1000, S1021, and S1041 shown to be implemented by the computing device 400 may be implemented based on processor 420 executing a program of instructions stored at memory 430. Operations of the methods S1000, S1021, and S1041 shown to be implemented by the user device 500 may be implemented based on processor 520 executing a program of instructions stored at memory 530. Operations of the methods S1000, S1021, and S1041 shown to be implemented by the dispensing apparatus 210 may be implemented based on a processor of controller 218A executing a program of instructions stored at a memory of the controller 218A. It will be understood that operations shown to be performed in FIGS. 10A to 10C and 11A to 11C may be performed in a different order than shown. One or more operations of the methods S1000, S1021, and S1041 may be omitted, and one or more operations may be added to the methods S1000, S1021, and S1041.

Referring generally to FIGS. 10A to 10C and 11A to 11C, the septic treatment system 1000 may be controlled to dispense one or more septic treatment compositions 202 according to various selected dispensing operation sequences in order to treat a septic waste system 102, for example, to rejuvenate or “revive” a “dead” septic waste system 102 that is not substantively decomposing organic waste 170 received at the septic tank 110.

For example, referring first to FIG. 11A, in some example embodiments, a dispensing apparatus 210 may be coupled in fluid communication (via a fluid communication pathway 290) with a septic tank 110 through one or more drain lines of a drain line system 130, where the septic tank 110 may be substantially “dead” such that influent organic waste 170 received at the septic tank 110 from the drain line(s) via septic tank influent port 154A is accumulating in the septic tank 110 as organic “sludge” 171 without being decomposed by decomposition agent 180 (e.g., the decomposition agent 180 may be missing or “dead” in the septic tank 110). As shown, the organic sludge 171 (corresponding to organic sludge 171 shown and described with reference to FIG. 2) may accumulate within the septic tank 110 without being decomposed by a decomposition agent 180 (e.g., microorganisms) such that the organic sludge fills the septic tank interior 151 and further escapes the septic tank 110 via septic tank effluent port 154B to the drain field 114 of the septic waste system 102 (shown in FIG. 2) and/or escapes the septic tank 110 via ports 156, 158A, and/or 158B. Such escaped organic sludge 171 may directly contaminate surrounding soil 106 and/or may cause growth and/or release of bacteria, nutrients, and/or various microorganisms into the surrounding ambient environment (e.g., soil 106, surface water, groundwater, proximate waterways, etc.). Additionally, the organic sludge 171 may “back up” through the septic tank influent port 154A and through the drain line system 130 into a structure 104 and/or one or more appliances 120.

In some example embodiments, the septic treatment system 1000 may dispense various different septic treatment compositions 202 according to different respective dispensing operation sequences 910 in order to adjustably control waste decomposition activity of the septic waste system 102. As shown in FIGS. 10A to 10C and 11A to 11C, such operation of the septic treatment system 1000 may include sequentially dispensing different, first to third septic treatment compositions 202A to 202C according to separate, respective first to third dispensing operation sequences 910A to 910C so as to rejuvenate or “revive” a “dead” septic tank 110 or septic waste system 102, including the same, that is not substantially decomposing received organic waste 170 to become a “live” septic waste system 102 that is breaking down organic waste 170 so as to reduce, minimize, or prevent release of organic “sludge” from the septic tank 110.

For example, as shown in FIG. 4, a plurality of cartridges 720 may include three different cartridge groups 722A, 722B, and 722C, where first to third cartridges 220A to 220C each belong to a separate cartridge group of the first to third cartridge groups 722A to 722C. Each separate cartridge group, and thus each of the first to third cartridges 220A to 220C, may include a different septic treatment composition 202A to 202C, and the respective cartridge identifier 222A to 222C of the first to third cartridges 220A to 220C may indicate separate, respective cartridge group identifier codes respectively associated with the respective cartridge groups 722A to 722C. The different septic treatment compositions 202A to 202C may include different concentrations (or amounts per unit volume) of microorganisms (e.g., blends of one or more bacteria strains).

For example, the first and second cartridges 220A and 220B, respectively, included in the first and second cartridge groups 722A and 722B as shown in FIG. 4, may each have an internal cartridge reservoir 224 of 36 oz, while the third cartridge 220C that is included in the third cartridge group 722C may have an internal cartridge reservoir 224 of 72 oz. The first cartridge 220A may hold 36 oz of a first septic treatment composition 202A having about 1.0 trillion to about 1.5 trillion CFU of a particular multi-strain blend of Bacillus bacteria in the reservoir 224 of the first cartridge 220A having a first volume of 36 oz, and the first cartridge 220A may have a first cartridge identifier 222A that is configured to provide first cartridge data indicating a first cartridge group identifier code that is uniquely associated with the first cartridge group 722A. The second cartridge 220B may hold 36 oz of a second septic treatment composition 202B having about 500 billion to about 750 billion CFU of the particular multi-strain blend of Bacillus bacteria in the reservoir 224 of the second cartridge 220B having a second volume of 36 oz, and the second cartridge 220B may have a second cartridge identifier 222B that is configured to provide second cartridge data indicating a second cartridge group identifier code that is uniquely associated with the second cartridge group 722B. The third cartridge 220C may hold 72 oz of a third septic treatment composition 202C having about 350 billion to about 450 billion CFU of the particular multi-strain blend of Bacillus bacteria in the reservoir 224 of the third cartridge 220C having a third volume of 72 oz, and the third cartridge 220C may have a third cartridge identifier 222C that is configured to provide third cartridge data indicating a third cartridge group identifier code that is uniquely associated with the third cartridge group 722C.

At FIG. 11A, a first cartridge 220A that is associated with a first cartridge group 722A (and thus a first cartridge group identifier code indicated by the first cartridge identifier 222A) and holds an amount (e.g., 36 oz) of a first septic treatment composition 202A (e.g., holding about 1.0 trillion to about 1.5 trillion CFU of a particular multi-strain blend of Bacillus bacteria in 36 oz of volume) may be selected to be coupled to the dispensing apparatus 210 based on a determination that the septic tank 110 is simply accumulating organic waste 170 received via the septic tank influent port 154A without breaking down the organic waste such that at least a portion of the waste accumulates within the septic tank interior 151 as organic “sludge” 171. Such a septic tank 110, or septic waste system 102 including same, may be referred to as “dead” due to not or substantially not decomposing received organic waste and instead simply accumulating organic sludge 171. As shown, when the organic sludge 171 accumulates to occupy more than a threshold amount of the septic tank interior 151 (e.g., the level of organic sludge 171 in the tank 110 rises to at least the level of the septic tank effluent port 154B), the organic sludge 171 may escape the septic tank 110 via the septic tank effluent port 154, the ports 158A, 158B, 156, or any combination thereof, to thereby contaminate the proximate soil 106, groundwater, surface water, or the like with waste and/or to cause the growth and/or release of bacteria and/or nutrients in the surrounding soil, water table, waterways, and/or ambient environment. The first cartridge 220A may be selected specifically to “revive” such a “dead” system based on “shocking” the septic tank 110 with microorganisms to serve as a decomposition agent 180 to reintroduce a microorganism population into the septic tank 110 to restart decomposition of organic waste (including organic sludge 171) within the septic tank 110.

As shown in FIGS. 11A to 11C, an outlet port 216 of a dispensing apparatus 210 may be coupled in fluid communication (e.g., via fluid communication pathway 290) with the septic tank influent port 154A of the septic tank 110 through one or more drain lines of a structure 104 (e.g., as shown in any of FIGS. 2, 3A, and 3B) so as to configure the dispensing apparatus 210 to dispense septic treatment composition into the septic tank 110 through at least the one or more drain lines of the drain line system 130 and further through the septic tank influent port 154A via which waste enters the septic tank 110.

Referring to FIGS. 10A and 11A, at S1002 (corresponding to S602 of method S600) the first cartridge 220A may be coupled to the dispensing apparatus 210. At S1004 (corresponding to S604 of method S600), a user device 500 may obtain 1102 first cartridge data indicated by the cartridge identifier 222A of the first cartridge 220A, for example based on capturing an image of a QR code, bar code, alphanumeric code, or the like that is presented as the cartridge identifier 222A on the outer surface of the first cartridge 220A. Based on processing the first cartridge data indicated by the cartridge identifier 222A (e.g., based on processing an image of a QR code, bar code, alphanumeric code, or the like comprising the first cartridge identifier 222A), the user device 500 may obtain (e.g., capture, generate, etc.) first cartridge data including a first cartridge group identifier code that is associated with the particular first cartridge group 722A that includes the first cartridge 220A. At S1006 (corresponding to S606 in method S600), the user device 500 may transmit a first cartridge data signal 1104 including at least a portion of the first cartridge data, including information indicating at least the first cartridge group identifier code, to the computing device 400 through communication link 802C.

At S1008 (corresponding to S608 in method S600), the computing device 400 may receive the first cartridge data signal 1104 from the user device 500 and may process the first cartridge data included in the first cartridge data signal 1104 to identify the first cartridge group identifier code and to further select, from among at least the plurality of dispensing operation sequences 910 (which may be accessed by the computing device 400 from a memory device), a first dispensing operation sequence 910A that is associated with the first cartridge group identifier code as the selected dispensing operation sequence 912. For example, the computing device 400 may apply the first cartridge group identifier code to a database (e.g., a look-up table) that associates the plurality of dispensing operation sequences 910 with separate, respective cartridge group identifier codes so as to identify the first dispensing operation sequence 910A as being associated with the first cartridge group identifier code.

At S1010 (corresponding to S612 in method S600), the computing device 400 may transmit a particular first control signal 1106 to the dispensing apparatus 210 via the communication link 802A based on the selected first dispensing operation sequence 910A. For example, the computing device 400 may determine a particular first control signal 1106 that is associated with the selected first dispensing operation sequence 910A (e.g., as may be indicated by a database accessible by the computing device 400). The computing device 400 may further update user account information of a user account 920 associated with the user device 500 and the dispensing apparatus 210 to indicate that the dispensing apparatus 210 is associated with (e.g., performing) the first dispensing operation sequence 910A as a selected dispensing operation sequence 912. Such information may indicate a quantity of dispensing operations performed according to the first dispensing operation sequence 910A, the first septic treatment composition 202A associated with the first dispensing operation sequence 910A, a first ordering parameter and/or a threshold cumulative dispensing operation quantity of dispensing operations associated with the first dispensing operation sequence 910A, or any combination thereof.

At S1014 (corresponding to S614 in method S600), the dispensing apparatus 210 may receive the first control signal 1106 from the computing device 400 and may configure (e.g., program) the dispensing apparatus 210 to operate to dispense the first septic treatment composition 202A according to the selected first dispensing operation sequence 910A (as the selected dispensing operation sequence 912) based on processing the first control signal 1106. At S1016 (corresponding to S616 in method S600), the dispensing apparatus 210 may perform the selected first dispensing operation sequence 910A to controllably dispense the first septic treatment composition 202A (which may be received at the dispensing apparatus 210 from the first cartridge 220A) at a particular dispensing operation frequency (e.g., interval), at a particular amount of dispensing composition and/or duration of dispensing operation per dispensing operation, for a particular dispensing operation maximum quantity of dispensing operations, or any combination thereof that may be associated with the selected first dispensing operation sequence 910A.

For example, the first dispensing operation sequence 910A may be a sequence that, when performed by the dispensing apparatus 210, causes the dispensing apparatus 210 to operate the dispenser device 212 thereof to dispense the first septic treatment composition 202A from outlet port 216 (and thus into the septic tank 110 through at least one or more drain lines of the drain line system 130) at a frequency of once every 24 hours (e.g., once per day) and an amount of 6 oz per dispensing operation, for example, such that the first dispensing operation sequence 910A is a sequence of a maximum dispensing operation quantity of 6 dispensing operations, an amount of 6 oz per dispensing operation, and a dispensing operation frequency (or interval) of 24 hours between adjacent dispensing operations of the first dispensing operation sequence 910A.

Such a first dispensing operation sequence 910A, when executed (performed) by the dispensing apparatus 210 to introduce the first septic treatment composition 202A (which, as noted above, may include about 1.0 trillion to about 1.5 trillion CFU of bacteria per 36 oz of volume), may introduce relatively large amounts of bacteria 922 into the septic tank 110 at a relatively high frequency to “shock” the “dead” septic tank 110 into restarting microorganism-catalyzed decomposition of at least some of the organic sludge 171 in the septic tank 110. Such an operation may decompose sufficient amounts of the organic sludge 171 in the septic tank 110 to reduce the amount of organic sludge 171 in the septic tank 110 and to clear the septic tank effluent port 154B of organic sludge 171, enabling a flow of liquid effluent 178 out of the septic tank 110 through the septic tank effluent port 154B to restart, resulting from the breakdown of organic sludge 171 out of the septic tank 110 and into a drain field 114 (shown in FIG. 2), while a solid layer of scum 174 is formed over the organic sludge 171 and a void 176 not occupied by the organic sludge 171 or scum 174 grows at the top of the septic tank interior 151 above the scum 174. Such a septic tank 110, and septic waste system 102 including same, may be understood to be “recovering” and is shown in FIG. 11B. Restated, the operation of the dispensing apparatus 210 to dispense the first septic treatment composition 202A from the first cartridge 220A according to the selected first dispensing operation sequence 910A that is associated with the first cartridge group 722A that includes the first cartridge 220A may cause the septic tank 110 to be “revived” from the “dead” state as shown in FIG. 11A to the “recovering” state shown in FIG. 11B, where effluent 178 flows out of the septic tank 110 is restored, organic sludge flow out of the septic tank 110 is reduced, minimized, or halted, and the amount of organic sludge 171 in the septic tank 110 is reduced, while scum 174 grows over the organic sludge 171 and a void 176 may grow over the scum 174.

As shown in FIG. 10A, at S1013 (corresponding to S618 of method S600), the computing device 400 may transmit a status signal 1110 to the user device 500, to a separate remote device 600 supporting a separate third-party entity (e.g., a government agency), or the like. The status signal 1110 may indicate operation of the dispensing apparatus 210, include an indication of the first dispensing operation sequence 910A being performed by the dispensing apparatus 210, the first cartridge group identifier code associated with the first dispensing operation sequence 910A (and further associated with the first septic treatment composition), an elapsed duration and/or quantity of dispensing operations performed according to the first dispensing operation sequence 910A, a remaining quantity of dispensing operations and/or duration of the first dispensing operation sequence 910A, an indication of the particular first septic treatment composition 202A being dispensed (which may be determined based on the first cartridge group identifier code and/or the selected first dispensing operation sequence 910A), or any combination thereof. The computing device 400 may transmit status signals 1110 at S1013 based on signals 1108 received from the dispensing apparatus 210, including, for example, signals indicating performance of one or more dispensing operations of the dispensing apparatus 210, signals indicating a quantity of dispensing operations performed (or remaining) according to the first dispensing operation sequence 910A, or any combination thereof.

Referring back to FIG. 10A, at S1018 (corresponding to S904 in method S900), in response to a determination that a quantity of dispensing operations performed by the dispensing apparatus 210 according to the first dispensing operation sequence 910A has at least reached a first depletion threshold value (which may be equal to or less than, for example, 1 or 2 less than, a maximum dispensing operation quantity associated with the first dispensing operation sequence 910A), the dispensing apparatus 210 may transmit a depletion signal 1112 to the computing device 400. The depletion signal 1112 may indicate that the dispensing apparatus 210 has or is about to perform the maximum dispensing operation quantity of dispensing operations associated with the first dispensing operation sequence 910A.

At S1020 (corresponding to S914 in method S900) the computing device 400 may, in response to receiving and processing the depletion signal 1112, determine whether the total, actual cumulative quantity of dispensing operations performed by the dispensing apparatus 210 according to the first dispensing operation sequence 910A (e.g., over one or more sequential, contiguous (e.g., adjacent) iterations of method S1000) has reached a threshold cumulative dispensing operation quantity associated with the first dispensing operation sequence 910A.

At S1020, the computing device 400 may determine that the quantity of dispensing operations performed by the dispensing apparatus 210 according to the first dispensing operation sequence 910A in the present iteration of S1000 is equal to the maximum dispensing operation quantity associated with the first dispensing operation sequence 910A, in response to receiving the depletion signal 1112, even if the dispensing apparatus 210 transmits the depletion signal 1112 in response to determining that the actual quantity of dispensing operations performed at S1018 is a first depletion threshold value that is less than the maximum dispensing operation quantity associated with the first dispensing operation sequence 910A.

Still referring to S1020, the computing device 400 may increment a stored cumulative dispensing operation quantity associated with the first dispensing operation sequence 910A (e.g., based on accessing information associated with the user account 920 that is further associated with the dispensing apparatus 210) to determine a total, actual cumulative quantity of dispensing operations performed by the particular dispensing apparatus 210 associated with the first dispensing operation sequence 910A (e.g., performed over one or more sequential, contiguous iterations of the first dispensing operation sequence 910A (e.g., over multiple iterations of S1000)). In some example embodiments, the stored cumulative dispensing operation quantity associated with the first dispensing operation sequence 910A may be zero (0), so that the total, actual cumulative quantity of dispensing operations performed by the particular dispensing apparatus 210 associated with the first dispensing operation sequence 910A is equal to the maximum dispensing operation quantity of the first dispensing operation sequence 910A.

In some example embodiments, the threshold cumulative dispensing operation quantity associated with the first dispensing operation sequence 910A may be equal to the maximum dispensing operation quantity associated with the first dispensing operation sequence 910A, such that at S1020 the computing device 400 may determine that the total, actual cumulative quantity of dispensing operations performed by the dispensing apparatus 210 according to the first dispensing operation sequence 910A has reached a threshold cumulative dispensing operation quantity associated with the first dispensing operation sequence 910A, based on determining at S1020 that the total, actual cumulative quantity of dispensing operations performed by the dispensing apparatus 210 according to the first dispensing operation sequence 910A may be determined to be equal to or greater than the threshold cumulative dispensing operation quantity associated with the first dispensing operation sequence 910A due to being a value that is equal to or greater than the maximum dispensing operation quantity associated with the first dispensing operation sequence 910A.

In response to such a determination that the total, actual cumulative quantity of dispensing operations performed by the dispensing apparatus 210 according to the first dispensing operation sequence 910A is equal to or greater than a threshold cumulative dispensing operation quantity associated with the first dispensing operation sequence 910A, at S1020 the computing device 400 may process information associated with the dispensing apparatus 210 and/or user account 920 associated therewith, information associated with the first dispensing operation sequence 910A, or the like to determine that the dispensing apparatus 210 (or the first dispensing operation sequence 910A) is associated with an ordering parameter of the first dispensing operation sequence 910A specifying the purchase and/or delivery of a second cartridge 220B associated with a second cartridge group identifier code (and thus included in a second cartridge group 722B associated with the second cartridge group identifier code) and holding the second septic treatment composition 202B, in response to the total, actual cumulative quantity of dispensing operations performed by the dispensing apparatus 210 according to the first dispensing operation sequence 910A being equal to or greater than a threshold cumulative dispensing operation quantity associated with the first dispensing operation sequence 910A.

As a result, at S1020 the computing device 400 may transmit an order signal (e.g., to a remote cartridge distribution system 700) commanding the purchase and/or delivery of a second cartridge 220B to a mailing address associated with the user account 920 and/or the dispensing apparatus 210 (e.g., using purchase information and/or mailing address information associated with the user account 920). Additionally, at S1019 the dispensing apparatus 210 may inhibit dispensing operations in response to performing a maximum dispensing operation quantity of dispensing operations associated with the first dispensing operation sequence 910A, such that the dispensing apparatus 210 determines that the first dispensing operation sequence 910A is completed.

Referring now to FIGS. 10B and 11B, at S1022 (corresponding to S602 of method S600) the first cartridge 220A may be decoupled from the dispensing apparatus 210 and the second cartridge 220B (which may have been delivered to a mailing address associated with the dispensing apparatus 210 and/or the user account 920 with which the dispensing apparatus 210 is also associated) may be coupled to the dispensing apparatus 210. At S1024 (corresponding to S604 of method S600), the user device 500 may obtain 1122 (corresponding to the obtaining 512 as described herein) second cartridge data indicated by the second cartridge identifier 222B of the second cartridge 220B, for example based on capturing an image of a QR code, bar code, alphanumeric code, or the like that is presented as the cartridge identifier 222B on the outer surface of the second cartridge 220B. Based on processing the second cartridge data indicated by the cartridge identifier 222B (e.g., based on processing an image of a QR code, bar code, alphanumeric code, or the like comprising the cartridge identifier 222B), the user device 500 may obtain (e.g., capture, generate, etc.) second cartridge data including a second cartridge group identifier code that is associated with the particular second cartridge group 722B that includes the second cartridge 220B. At S1026 (corresponding to S606 in method S600), the user device 500 may transmit a second cartridge data signal 1124 including at least a portion of the second cartridge data, including information indicating at least the second cartridge group identifier code, to the computing device 400 through communication link 802C.

At S1028 (corresponding to S608 in method S600), the computing device 400 may receive the second cartridge data signal 1124 from the user device 500 and may process the second cartridge data to identify the second cartridge group identifier code and to further select, from among at least the plurality of dispensing operation sequences 910 (which may be accessed by the computing device 400 from a memory device), a second dispensing operation sequence 910B (that is different from the first dispensing operation sequence 910A) that is associated with the second cartridge group identifier code as the selected dispensing operation sequence 912. For example, the computing device 400 may apply the second cartridge group identifier to a database (e.g., a look-up table) that associates the plurality of dispensing operation sequences 910 to separate, respective cartridge group identifier codes so as to identify the second dispensing operation sequence 910B as being associated with the second cartridge group identifier code.

At S1030 (corresponding to S612 in method S600), the computing device 400 may transmit a particular, second control signal 1126 to the dispensing apparatus 210 via the communication link 802A based on the selected second dispensing operation sequence 910B. For example, the computing device 400 may determine a particular second control signal 1126 that is associated with the selected second dispensing operation sequence 910B (e.g., as may be indicated by a database accessible by the computing device 400). The computing device 400 may further update user account information of a user account 920 associated with the user device 500 and the dispensing apparatus 210 to indicate that the dispensing apparatus 210 is associated with (e.g., performing) the second dispensing operation sequence 910B. Such information may indicate a quantity of dispensing operations performed according to the second dispensing operation sequence 910B, the second septic treatment composition 202B associated with the second dispensing operation sequence 910B, a second ordering parameter, and/or a threshold cumulative dispensing operation quantity of dispensing operations associated with the second dispensing operation sequence 910B, or any combination thereof.

At S1034 (corresponding to S614 in method S600), the dispensing apparatus 210 may receive the second control signal 1126 from the computing device 400 and may configure (e.g., program) the dispensing apparatus 210 to operate to dispense the second septic treatment composition 202B according to the selected second dispensing operation sequence 910B (as the selected dispensing operation sequence 912) based on processing the second control signal 1126. At S1036 (corresponding to S616 in method S600), the dispensing apparatus 210 may perform the selected second dispensing operation sequence 910B to controllably dispense the second septic treatment composition 202B (which may be received at the dispensing apparatus 210 from the cartridge 220B) at a particular dispensing operation frequency (e.g., interval), at a particular amount of dispensing composition and/or duration of dispensing operation per dispensing operation, for a particular dispensing operation maximum quantity of dispensing operations, or any combination thereof, which may be associated with the selected second dispensing operation sequence 910B.

The second dispensing operation sequence 910B may be associated with a different dispensing operation frequency, amount per dispensing operation, and/or maximum dispensing operation quantity of dispensing operations than the first dispensing operation sequence 910A. For example, the second dispensing operation sequence 910B may be a sequence that, when performed by the dispensing apparatus 210, causes the dispensing apparatus 210 to operate the dispenser device 212 thereof to dispense the second septic treatment composition 202B from outlet port 216 (and thus into the septic tank 110 through at least one or more drain lines of the drain line system 130) at a frequency of once every 7 days (e.g., once per week) and an amount of 3 oz per dispensing operation, for example, such that the second dispensing operation sequence 910B is a sequence of a maximum dispensing operation quantity of 12 dispensing operations, an amount of 3 oz per dispensing operation, and a frequency (or interval) of 7 days (168 hours) between adjacent dispensing operations of the second dispensing operation sequence 910B.

Such a second dispensing operation sequence 910B, when executed (performed) by the dispensing apparatus 210 to introduce the second septic treatment composition 202B (which, as noted above, may include about 500 billion to about 750 billion CFU of bacteria per 36 oz of volume), may introduce relatively smaller amounts of bacteria 922 into the septic tank 110 than introduced under the first dispensing operation sequence 910A, so as to maintain the continuous activity of bacteria as a decomposition agent 180 in the “recovering” septic tank 110 to continue decomposition and reduction of the remaining organic sludge 171 in the septic tank 110. Such an operation may decompose (break down) some or all of the remaining organic sludge 171 in the recovering septic tank 110 to reduce, minimize, or eliminate organic sludge 171 in the septic tank 110, to be replaced by a volume of liquid 172 (e.g., waste water) filled with a population of active microorganisms (e.g., active bacteria) that maintain continuous or periodic decomposition of “fresh” influent organic waste 170 introduced into the septic tank 110, where the septic tank 110 enables the septic tank effluent port 154B to direct an effluent 178 flow resulting from the breakdown of organic sludge 171 and/or fresh influent waste out of the septic tank 110 and into a drain field 114 (shown in FIG. 2). Such a septic tank 110, and septic waste system 102 including same, may be understood to be “maintained” and is shown in FIG. 11C. Restated, the operation of the dispensing apparatus 210 to dispense the second septic treatment composition 202B from the second cartridge 220B according to the selected second dispensing operation sequence 910B that is associated with the second cartridge group 722B that includes the second cartridge 220B may cause the septic tank 110 to be recovered from the “recovery” state as shown in FIG. 11B to the “maintenance” state shown in FIG. 11C, where the amount of organic sludge 171 in the septic tank 110 is reduced, minimized, or eliminated, and a volume of liquid 172 (e.g., waste water) comprising a population of active microorganisms actively decomposing organic waste 170 in the septic tank 110 is formed, and where effluent 178 may be directed out of the septic tank 110 via septic tank effluent port 154B into a drain field 114, thereby establishing an operational septic waste system 102 that breaks down organic waste 170 and reduces, minimizes, or prevents release of waste from the septic tank 110 into the surrounding ambient environment (e.g., soil, water table, ground water, surface water, waterways, etc.).

As shown in FIG. 10B, at S1033 (corresponding to S618 of method S600), the computing device 400 may transmit a status signal 1130 to the user device 500, to a separate remote device 600 supporting a separate third-party entity (e.g., a government agency), or the like. The status signal 1130 may indicate operation of the dispensing apparatus 210, including an indication of the second dispensing operation sequence 910B being performed by the dispensing apparatus 210, the second cartridge group identifier associated with the second dispensing operation sequence 910B (and further associated with the second septic treatment composition 202B), an elapsed duration and/or quantity of dispensing operations performed according to the second dispensing operation sequence 910B, a remaining quantity of dispensing operations and/or duration of the second dispensing operation sequence 910B, an indication of the particular second septic treatment composition 202B being dispensed (which may be determined based on the second cartridge group identifier code and/or the selected second dispensing operation sequence 910B), or any combination thereof. The computing device 400 may transmit status signals 1130 at S1033 based on signals 1128 received from the dispensing apparatus 210, including, for example, signals indicating performance of one or more dispensing operations of the dispensing apparatus 210, signals indicating a quantity of dispensing operations performed (or remaining) according to the second dispensing operation sequence 910B, or any combination thereof.

Referring back to FIG. 10B, at S1038 (corresponding to S904 in method S900), in response to a determination that a quantity of dispensing operations performed by the dispensing apparatus 210 according to the second dispensing operation sequence 910B has at least reached a second depletion threshold value (which may be equal to or less than, for example, 1 or 2 less than, a maximum dispensing operation quantity associated with the second dispensing operation sequence 910B), the dispensing apparatus 210 may transmit a depletion signal 1132 to the computing device 400. The depletion signal 1132 may indicate that the dispensing apparatus 210 has or is about to perform the maximum dispensing operation quantity of dispensing operations associated with the second dispensing operation sequence 910B.

At S1040 (corresponding to S914 in method S900), the computing device 400 may, in response to receiving and processing the depletion signal 1132, determine whether the total, actual cumulative quantity of dispensing operations performed by the dispensing apparatus 210 according to the second dispensing operation sequence 910B (e.g., over one or more sequential, contiguous (e.g., adjacent) iterations of method S1021) has reached a threshold cumulative dispensing operation quantity associated with the second dispensing operation sequence 910B.

At S1040, the computing device 400 may determine that the quantity of dispensing operations performed by the dispensing apparatus 210 according to the second dispensing operation sequence 910B in the present iteration of S1021 is equal to the maximum dispensing operation quantity associated with the second dispensing operation sequence 910B, in response to receiving the depletion signal 1132, even if the dispensing apparatus 210 transmits the depletion signal 1132 in response to determining that the actual quantity of dispensing operations performed at S1038 is a second depletion threshold value that is less than the maximum dispensing operation quantity associated with the second dispensing operation sequence 910B.

Still referring to S1040, the computing device 400 may increment a stored cumulative dispensing operation quantity associated with the second dispensing operation sequence 910B (e.g., based on accessing information associated with the user account 920 that is further associated with the dispensing apparatus 210) to determine a total, actual cumulative quantity of dispensing operations performed by the particular dispensing apparatus 210 associated with the second dispensing operation sequence 910B (e.g., performed over one or more sequential, contiguous iterations of the second dispensing operation sequence 910B (e.g., over multiple iterations of S1021)).

In some example embodiments, the threshold cumulative dispensing operation quantity associated with the second dispensing operation sequence 910B may be greater than the maximum dispensing operation quantity associated with the second dispensing operation sequence 910B, such that at S1040 the computing device 400 may determine that the total, actual cumulative quantity of dispensing operations performed by the dispensing apparatus 210 according to the second dispensing operation sequence 910B has not reached a threshold cumulative dispensing operation quantity associated with the second dispensing operation sequence 910B in a first iteration of S1021, but may determine that the total, actual cumulative quantity of dispensing operations performed by the dispensing apparatus 210 according to the second dispensing operation sequence 910B has reached the threshold cumulative dispensing operation quantity associated with the second dispensing operation sequence 910B in a subsequent iteration of S1021.

At S1040 (corresponding to S914 in method S900) the computing device 400 may, in response to receiving and processing the depletion signal 1132, determine whether the total, actual cumulative quantity of dispensing operations performed by the dispensing apparatus 210 according to the second dispensing operation sequence 910B (e.g., over one or more sequential, contiguous (e.g., adjacent) iterations of method S1021) has reached the threshold cumulative dispensing operation quantity associated with the second dispensing operation sequence 910B. The computing device 400 may process information associated with the dispensing apparatus 210 and/or the user account associated therewith, information associated with the second dispensing operation sequence 910B, or the like to determine that the dispensing apparatus 210 (or the second dispensing operation sequence 910B) is associated with an ordering parameter of the second dispensing operation sequence 910B.

The ordering parameter of the second dispensing operation sequence 910B may specify the purchase and/or delivery of a second cartridge 220B associated with a second cartridge group identifier code (and thus included in a second cartridge group 722B associated with the second cartridge group identifier code) in response to the total, actual cumulative quantity of dispensing operations performed by the dispensing apparatus 210 according to the second dispensing operation sequence 910B being less than the threshold cumulative dispensing operation quantity associated with the second dispensing operation sequence 910B (e.g., where the threshold cumulative dispensing operation quantity is greater than the maximum dispensing operation quantity associated with the second dispensing operation sequence 910B).

The ordering parameter may require the purchase and/or delivery of a third cartridge 220C associated with a third cartridge group identifier code (and thus included in a third cartridge group 722C associated with the third cartridge group identifier code) in response to the total, actual cumulative quantity of dispensing operations performed by the dispensing apparatus 210 according to the second dispensing operation sequence 910B being equal to or greater than the threshold cumulative dispensing operation quantity associated with the second dispensing operation sequence 910B.

In some example embodiments, the threshold cumulative dispensing operation quantity associated with the second dispensing operation sequence 910B may be greater than (e.g., twice the value of) the maximum dispensing operation quantity associated with the second dispensing operation sequence 910B, such that multiple (e.g., two) sequential, contiguous iterations of method S1021 may need to be performed for the total, cumulative quantity of dispensing operations performed according to the second dispensing operation sequence 910B to reach the threshold cumulative dispensing operation quantity.

In such example embodiments, at S1040 in a first iteration of S1021 following performing method S1000 (such that previous iterations of S1021 prior to S1000 are not contiguous with the present iteration of S1021), the computing device 400 may determine that the total, actual cumulative quantity of dispensing operations performed by the dispensing apparatus 210 according to the second dispensing operation sequence 910B (e.g., over one or more sequential, contiguous (e.g., adjacent)) iterations of method S1021) is less than the threshold cumulative dispensing operation quantity associated with the second dispensing operation sequence 910B. As a result, in the first iteration of method S1021, the computing device 400 at S1040 may transmit an order signal (e.g., to a remote cartridge distribution system 700) commanding the purchase and/or delivery of another second cartridge 220B to a mailing address associated with the user account 920 and/or the dispensing apparatus 210 (e.g., using purchase information and/or mailing address information associated with the user account 920), and the method S1021 may be repeated (e.g., another sequential iteration of S1021 may be performed).

In some example embodiments, at S1040 in a second, immediately subsequent iteration of S1021 following performing method S1000, the computing device 400 may determine that the total, actual cumulative quantity of dispensing operations performed by the dispensing apparatus 210 according to the second dispensing operation sequence 910B includes the quantity of dispensing operations performed in the first iteration of S1021 due to the first and second iterations being sequential, contiguous performances of the same second dispensing operation sequence 910B. Therefore, at S1040 in the second iteration of S1021, the computing device 400 may determine that the total cumulative quantity of dispensing operations performed by the dispensing apparatus 210 according to the second dispensing operation sequence 910B over the combined first and second iterations of S1021 is a value that is twice the maximum dispensing operation quantity of the second dispensing operation sequence 910B and is equal to or greater than the threshold cumulative dispensing operation quantity associated with the second dispensing operation sequence 910B. As a result, in the second iteration of method S1021, the computing device 400 at S1040 may transmit an order signal (e.g., to a remote cartridge distribution system 700) commanding the purchase and/or delivery of a new third cartridge 220C to a mailing address associated with the user account 920 and/or the dispensing apparatus 210 (e.g., using purchase information and/or mailing address information associated with the user account 920) based on the ordering parameter indicating a particular cartridge group identifier code associated with the third cartridge group 722C if the threshold cumulative dispensing quantity is met or exceeded, and the method S1041 may then be performed.

While the above example describes example embodiments where the threshold cumulative dispensing operation quantity associated with the second dispensing operation sequence 910B is greater than the maximum dispensing operation quantity associated with the second dispensing operation sequence 910B and is up to twice the maximum dispensing operation quantity, example embodiments are not limited thereto. It will be understood that the threshold cumulative dispensing operation quantity associated with a given dispensing operation sequence may be any value that may be equal to or greater than the maximum dispensing operation quantity associated with the same dispensing operation sequence.

Referring now to FIGS. 10C and 11C, at S1042 (corresponding to S602 of method S600) the second cartridge 220B may be decoupled from the dispensing apparatus 210 and the third cartridge 220C (which may have been delivered to a mailing address associated with the dispensing apparatus 210 and/or the user account with which the dispensing apparatus 210 is also associated) may be coupled to the dispensing apparatus 210. At S1044 (corresponding to S604 of method S600), the user device 500 may obtain 1142 second cartridge data indicated by the third cartridge identifier 222C of the third cartridge 220C, for example based on capturing an image of a QR code, bar code, alphanumeric code, or the like that is presented as the cartridge identifier 222C on the outer surface of the third cartridge 220C. Based on processing the third cartridge data indicated by the cartridge identifier 222C (e.g., based on processing an image of a QR code, bar code, alphanumeric code, or the like comprising the cartridge identifier 222C), the user device 500 may obtain (e.g., capture, generate, etc.) third cartridge data including a third cartridge group identifier code that is associated with a particular third cartridge group 722C that includes the third cartridge 220C. At S1046 (corresponding to S606 in method S600), the user device 500 may transmit a third cartridge data signal 1144 including at least a portion of the third cartridge data, including information indicating at least the third cartridge group identifier code, to the computing device 400 through communication link 802C.

At S1048 (corresponding to S608 in method S600), the computing device 400 may receive the third cartridge data signal 1144 from the user device 500 and may process the third cartridge data to identify the third cartridge group identifier code and to further select, from among at least the plurality of dispensing operation sequences 910 (which may be accessed by the computing device 400 from a memory device), a third dispensing operation sequence 910C (that is different from the first and second dispensing operation sequences 910A and 910B) as the selected dispensing operation sequence 912. For example, the computing device 400 may apply the third cartridge group identifier to a database (e.g., a look-up table) that associates the plurality of dispensing operation sequences 910 with separate, respective cartridge group identifier codes so as to identify the third dispensing operation sequence 910C as being associated with the third cartridge group identifier code.

At S1050 (corresponding to S612 in method S600), the computing device 400 may transmit a particular, third control signal 1146 to the dispensing apparatus 210 via the communication link 802A based on the selected third dispensing operation sequence 910C. For example, the computing device 400 may determine a particular third control signal 1146 that is associated with the selected third dispensing operation sequence 910C (e.g., as may be indicated by a database accessible by the computing device 400). The computing device 400 may further update user account information of a user account 920 associated with the user device 500 and the dispensing apparatus 210 to indicate that the dispensing apparatus 210 is associated with (e.g., performing) the third dispensing operation sequence 910C. Such information may indicate a quantity of dispensing operations performed according to the third dispensing operation sequence 910C, the third septic treatment composition 202C associated with the third dispensing operation sequence 910C, a third ordering parameter, and/or a threshold quantity of dispensing operations associated with the third dispensing operation sequence 910C, or any combination thereof.

At S1054 (corresponding to S614 in method S600), the dispensing apparatus 210 may receive the third control signal 1146 from the computing device 400 and may configure (e.g., program) the dispensing apparatus 210 to operate to dispense the third septic treatment composition 202C according to the selected third dispensing operation sequence 910C (as the selected dispensing operation sequence 912) based on processing the third control signal 1146. At S1056 (corresponding to S616 in method S600), the dispensing apparatus 210 may perform the selected third dispensing operation sequence 910C to controllably dispense the third septic treatment composition 202C (which may be received at the dispensing apparatus 210 from the cartridge 220C) at a particular dispensing operation frequency (e.g., interval), at a particular amount of dispensing composition and/or duration of dispensing operation per dispensing operation, for a particular dispensing operation maximum quantity of dispensing operations, or any combination thereof which may be associated with the selected third dispensing operation sequence 910C.

The third dispensing operation sequence 910C may be associated with a different dispensing operation frequency, amount per dispensing operation, and/or maximum dispensing operation quantity of dispensing operations. For example, the third dispensing operation sequence 910C may be a sequence that, when performed by the dispensing apparatus 210, causes the dispensing apparatus 210 to operate the dispenser device 208 to dispense the third septic treatment composition 202C from outlet port 216 (and thus into the septic tank 110 through at least one or more drain lines of the drain line system 130) at a third frequency of once every 7 days (e.g., once per week) and an amount of 3 oz per dispensing operation and a maximum dispensing operation quantity of 24 dispensing operations (accounting for the third cartridge 220C having an internal cartridge reservoir 224 configured to hold about 72 oz of the third septic treatment composition 202C instead of the first and second cartridges 220A and 220B which may have a smaller internal cartridge reservoir 224 configured to hold about 36 oz of the respective first and second septic treatment compositions 202A and 202B). As a result, the third dispensing operation sequence 910C may be a sequence of a maximum dispensing operation quantity of 24 dispensing operations, an amount of 3 oz per dispensing operation, and a frequency (or interval) of 7 days (168 hours) between adjacent dispensing operations of the third dispensing operation sequence 910C.

Such a third dispensing operation sequence 910C, when executed by the dispensing apparatus 210 to introduce the third septic treatment composition 202C (which, as noted above, may include about 350 billion to about 450 billion CFU of bacteria per 36 oz of volume and thus about 142 CFU per each 3 oz of third septic treatment composition 202C dispensed by the dispensing apparatus 210 per dispensing operation), may introduce relatively smaller amounts of bacteria 922 into the septic tank 110 than introduced under the first and second dispensing operation sequences 910A and 910B, so as to maintain the continuous activity of bacteria as a decomposition agent 180 in the “maintained” septic tank 110 to continue breakdown and reduction of “fresh” influent organic waste 170 received into the septic tank via the septic tank influent port 154A, where smaller amounts of bacteria 922 are introduced into the septic tank 110 per dispensing operation due to the reduced/minimized/eliminated amount of organic sludge 171 in the “maintained” septic tank 110, such that extra bacteria are not needed to further reduce/consume organic sludge 171. Restated, the dispensing operations performed according to the third dispensing operation sequence 910C “maintain” the quantity and/or concentration of bacteria 922 in the liquid 172 (e.g., waste water) in the septic tank 110 to maintain decomposition of freshly received influent organic waste 170 in the septic tank 110 with minimal/no accumulation of organic sludge. Such a septic tank 110, and septic waste system 102 including same, may be understood to be “maintained”.

As shown in FIG. 10C, at S1053 (corresponding to S618 of method S600), the computing device 400 may transmit a status signal 1150 to the user device 500, to a separate remote device 600 supporting a separate entity (e.g., a government agency), or the like. The status signal 1150 may indicate operation of the dispensing apparatus 210, including an indication of the third dispensing operation sequence 910C being performed by the dispensing apparatus 210, the third cartridge group identifier associated with the third dispensing operation sequence 910C (and further associated with the third septic treatment composition 202C), an elapsed duration and/or quantity of dispensing operations performed according to the third dispensing operation sequence 910C, a remaining quantity of dispensing operations and/or duration of the third dispensing operation sequence 910C, an indication of the particular third septic treatment composition 202C being dispensed (which may be determined based on the third cartridge group identifier code and/or the selected third dispensing operation sequence 910C), or any combination thereof. The computing device 400 may transmit status signals 1150 at S1053 based on signals 1148 received from the dispensing apparatus 210, including, for example, signals indicating performance of one or more dispensing operations of the dispensing apparatus 210, signals indicating a quantity of dispensing operations performed (or remaining) according to the third dispensing operation sequence 910C, or any combination thereof.

Referring back to FIG. 10C, at S1058 (corresponding to S904 in method S900), in response to a determination that a quantity of dispensing operations performed by the dispensing apparatus 210 according to the third dispensing operation sequence 910C has at least reached a threshold quantity (e.g., a maximum dispensing operation quantity associated with the third dispensing operation sequence 910C), the dispensing apparatus 210 may transmit a depletion signal 1152 to the computing device 400. The depletion signal 1152 may indicate that the dispensing apparatus 210 has or is about to perform the maximum dispensing operation quantity of dispensing operations associated with the third dispensing operation sequence 910C.

At S1060 (corresponding to S914 in method S900), the computing device 400 may, in response to receiving and processing the depletion signal 1152, determine whether the total, cumulative quantity of dispensing operations performed by the dispensing apparatus 210 according to the third dispensing operation sequence 910C (e.g., over one or more sequential, contiguous (e.g., adjacent) iterations of method S1041) has reached a threshold cumulative dispensing operation quantity associated with the third dispensing operation sequence 910C.

At S1060, the computing device 400 may determine that the quantity of dispensing operations performed by the dispensing apparatus 210 according to the third dispensing operation sequence 910C in the present iteration of S1041 is equal to the maximum dispensing operation quantity associated with the third dispensing operation sequence 910C, in response to receiving the depletion signal 1152, even if the dispensing apparatus 210 transmits the depletion signal 1152 in response to determining that the actual quantity of dispensing operations performed at S1058 is a third depletion threshold value that is less than the maximum dispensing operation quantity associated with the third dispensing operation sequence 910C.

Still referring to S1060, the computing device 400 may increment a stored cumulative dispensing operation quantity associated with the third dispensing operation sequence 910C (e.g., based on accessing information associated with the user account 920 that is further associated with the dispensing apparatus 210) to determine a total, actual cumulative quantity of dispensing operations performed by the particular dispensing apparatus 210 associated with the third dispensing operation sequence 910C (e.g., performed over one or more sequential, contiguous iterations of the third dispensing operation sequence 910C, e.g., over multiple iterations of S1041).

In some example embodiments, the third dispensing operation sequence 910C may not be associated with a threshold cumulative dispensing quantity, such that at S1060 the computing device 400 may skip a determination of whether the total, actual cumulative quantity of dispensing operations performed by the dispensing apparatus 210 according to the third dispensing operation sequence 910C has reached a threshold cumulative dispensing operation quantity associated with the third dispensing operation sequence 910C.

In response to such a determination that the quantity of dispensing operations performed by the dispensing apparatus 210 according to the third dispensing operation sequence 910C in the present iteration of S1041 is equal to the maximum dispensing operation quantity associated with the third dispensing operation sequence 910C, at S1060 the computing device 400 may process information associated with the dispensing apparatus 210 and/or the user account associated therewith, information associated with the third dispensing operation sequence 910C, or the like, to determine that the dispensing apparatus 210 (or the third dispensing operation sequence 910C) is associated with an ordering parameter specifying the purchase and/or delivery of another cartridge 220C associated with a third cartridge group identifier code (and thus included in a third cartridge group 722C associated with the third cartridge group identifier code) and holding the third septic treatment composition 202C, in response to the determination that the quantity of dispensing operations performed by the dispensing apparatus 210 according to the third dispensing operation sequence 910C in the present iteration of S1041 is equal to the maximum dispensing operation quantity associated with the third dispensing operation sequence 910C. As a result, the method S1041 may iterate repeatedly unless the septic treatment system 1000 is caused to perform one of methods S1021 or S1000 due to a separate factor (e.g., based on processing sensor data received from one or more sensor devices 160).

In response to such a determination, at S1060 the computing device 400 may transmit an order signal (e.g., to a remote cartridge distribution system 700) commanding the purchase and/or delivery of another third cartridge 220C to a mailing address associated with the user account and/or the dispensing apparatus 210 (e.g., using purchase information and/or mailing address information associated with the user account 920). The third dispensing operation sequence 910C may be associated with an ordering parameter that specifies the purchase and/or delivery of another third cartridge 220C associated with the same dispensing operation sequence 910C, in order to continue “maintaining” the septic tank 110 in the same “maintained” state.

Additionally, at S1059 the dispensing apparatus 210 may inhibit dispensing operations in response to performing a maximum dispensing operation quantity of dispensing operations according to the third dispensing operation sequence 910C.

In view of the above, and as shown in FIGS. 10A to 10C and 11A to 11C, the septic treatment system 1000 may be configured to “revive” a dead septic waste system 102 to re-start decomposition of organic waste in the septic tank 110 to thereby re-start flow of effluent 178 (e.g., waste water) out of the septic tank 110 and into the drain field 114, and to further reduce, minimize, or eliminate organic sludge 171 within the septic tank 110 to “recover” the septic waste system 102 to a “maintenance” state where organic sludge 171 is reduced, minimized, or prevented.

It will be understood that the operations shown to be separately performed in methods S500, S600, S700, S800, S900, S1000, S1021, and S1041 may be interchangeably performed in any of methods S500, S600, S700, S800, S900, S1000, S1021, and S1041. For example, in some example embodiments of method S800, the computing device 400 may, in response to the determination at S806 that at least one property value of a septic waste system 102 (determined based on processing sensor data received from one or more sensor devices 160) at least meets a corresponding at least one property threshold value, the computing device 400 may perform S914 to command purchase and/or delivery of a new cartridge 220 of a particular cartridge group 722, in addition to or instead of performing S808 and S812, so as to cause the dispensing apparatus 210 to operate according to a particular selected dispensing operation sequence associated with the particular cartridge group 722 (or the particular cartridge group identifier code associated with said cartridge group 722) upon coupling of the new cartridge 220 to the dispensing apparatus 210 in a subsequent performance of S600.

It will be understood that methods S500, S600, S700, S800, S900, S1000, S1021, and S1041 may be performed in any order relative to each other and, in some example embodiments, may be performed at least partially or entirely concurrently. It will be understood that at least some of the operations shown in methods S500, S600, S700, S800, S900, S1000, S1021, and S1041 may be omitted. It will be understood that one or more operations may be added to the operations shown in methods S500, S600, S700, S800, S900, S1000, S1021, and S1041.

While some example embodiments of the septic treatment system 1000 are shown to include the computing device 400, one or more dispensing apparatuses 210 (or one or more dispensing systems 200 including the same), one or more user devices 500, one or more sensor devices 160, one or more remote devices 600, and one or more cartridge distribution systems 700, it will be understood that example embodiments are not limited thereto. For example, at least some of the one or more user devices 500, one or more sensor devices 160, one or more remote devices 600, and one or more cartridge distribution systems 700 may be omitted from the septic treatment system 1000 (e.g., may each independently be omitted entirely or may be considered to be external to the septic treatment system 1000), such that the septic treatment system 1000 comprises the computing device 400 and one or more dispensing apparatuses 210 communicatively coupled thereto (e.g., via respective communication links 802A). In some example embodiments, the septic treatment system 1000 may further include one or more conduits 230, adaptors 240, or the like that establish fluid communication between the dispensing apparatus 210 and one or more drain lines of the drain line system 130 to establish fluid coupling 204 with at least a portion of the drain line system 130 and to thereby establish the fluid communication pathway 290 between the dispensing apparatus 210 and the septic tank 110 through at least a portion (e.g., one or more drain lines) of the drain line system 130. In some example embodiments, the drain line system 130 or at least a portion thereof may be considered to be part of the septic waste system 102, and therefore a fluid coupling 204 of the dispensing apparatus 210 with at least a portion of the drain line system 130 may be referred to as a fluid coupling of the dispensing apparatus 210 with the septic waste system 102 such that the dispensing apparatus 210 (alone or together with a conduit 230 and/or an adaptor 240) may be configured to dispense a septic treatment composition 202 into at least a portion of the septic waste system 102 and through one or more drain lines of the septic waste system 102 into the septic tank 110 of the septic waste system 102.

It will further be understood that functionality described herein as being performed by one device (e.g., user device 500, computing device 400, or the like) may be divided among multiple devices that may each separately perform a portion of the described functionality of the one device and may collectively (e.g., based on communicating with each other) perform the functionality of the device. Accordingly, where one device is described herein to perform a function, operation, or the like, it will be understood that such description may apply to a plurality of communicatively coupled devices that each independently perform at least a portion of said function, operation, or the like and may collectively (e.g., based on communication therebetween) perform the described function, operation, or the like of the one device. Additionally, it will be understood that any of the functionality (e.g., functions, operations, etc.) described herein to be performed by one of the described devices, apparatuses, or systems (e.g., the computing device 400, user device 500, dispensing apparatus 210, remote device 600, cartridge distribution system 700, etc.) may be performed by any other one or more of the described devices, apparatuses, or systems (e.g., the computing device 400, user device 500, dispensing apparatus 210, remote device 600, cartridge distribution system 700, etc.).

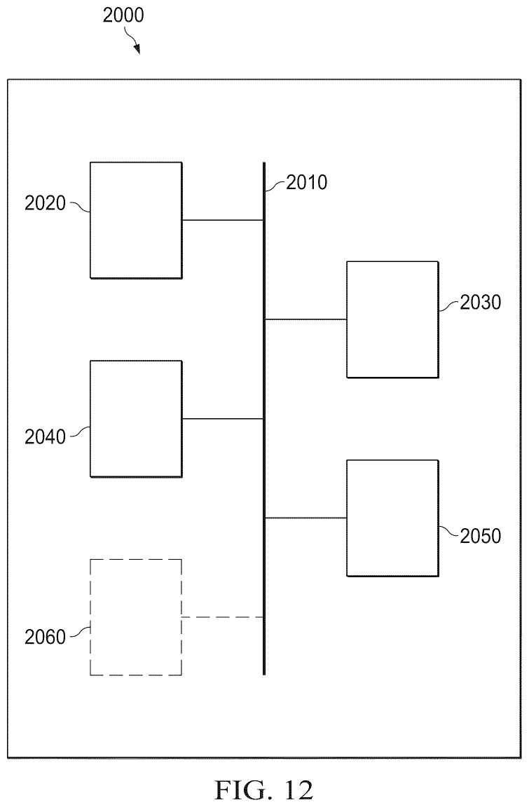

FIG. 12 is a schematic view of a computing device 2000 according to some example embodiments. The computing device 2000 may implement any of the computing devices, controllers, processors, or the like according to any of the example embodiments, including the septic treatment system 1000, dispensing apparatus 210, circuitry 218, controller 218A, computing device 400, user device 500, remote device 600, remote cartridge distribution system 700, any portion thereof, or any combination thereof.

As shown in FIG. 12, the computing device 2000 may include some or all of a processor 2020 (e.g., a CPU), a memory 2030 (e.g., a solid-state drive, or SSD), a communication interface 2040, and a power supply 2050 that are communicatively coupled together via a bus connection 2010. It will be understood that any type of non-transitory computer-readable storage device may be used as the memory 2030 in addition to or as an alternative to an SSD. The computing device 2000 may include additional devices, including a user interface device 2060 (e.g., “interface”) that may include a display device (e.g., an LED display screen, OLED display screen, etc.), a touchscreen display, a button interface, any combination thereof, or the like. The user interface device 2060 may be communicatively coupled to the bus connection 2010.

In some example embodiments, some or all of any of the computing device 2000 may include, may be included in, and/or may be implemented by one or more instances (e.g., articles, pieces, units, etc.) of processing circuitry such as hardware including logic circuits; a hardware/software combination such as a processor executing software; or a combination thereof. For example, the processing circuitry may more specifically include, but is not limited to, a central processing unit (CPU), an arithmetic logic unit (ALU), a digital signal processor, a microcomputer, a field-programmable gate array (FPGA), a System-on-Chip (SoC), a programmable logic unit, a microprocessor, an application-specific integrated circuit (ASIC), or any other device or devices capable of responding to and executing instructions in a defined manner. In some example embodiments, the processing circuitry may include a non-transitory computer-readable storage device, or memory (e.g., memory 2030), for example a solid-state drive (SSD), storing a program of instructions, and a processor (e.g., processor 2020) that is communicatively coupled to the non-transitory computer-readable storage device (e.g., via a bus connection 2010) and configured to execute the program of instructions to implement the functionality of some or all of any of the devices and/or mechanisms of any of the example embodiments and/or to implement some or all of any of the methods of any of the example embodiments.

It will be understood that, as described herein, an element (e.g., processing circuitry, digital circuits, etc.) that is described as “implementing” an element (e.g., septic treatment system 1000, dispensing system 200, dispensing apparatus 210, controller 218A, computing device 400, user device 500, remote device 600, cartridge distribution system 700, any portion thereof, or any combination thereof) will be understood to implement the functionality of said implemented element and/or any other elements (e.g., the functionality of the septic treatment system 1000, the functionality of the dispensing system 200, the functionality of the dispensing apparatus 210, the functionality of the controller 218A, the functionality of the computing device 400, the functionality of the user device 500, the functionality of the remote device 600, the functionality of the cartridge distribution system 700, any portion thereof, or any combination thereof).

While a number of example embodiments have been disclosed herein, it should be understood that other variations may be possible. Such variations are not to be regarded as a departure from the spirit and scope of the present inventive concepts, and all such modifications as would be obvious to one skilled in the art are intended to be included within the scope of the following claims. In addition, while processes have been disclosed herein, it should be understood that the described elements of the processes may be implemented in different orders, using different selections of elements, some combination thereof, etc. For example, some example embodiments of the processes of the inventive concepts may be implemented using fewer elements than that of the illustrated and described processes, and some example embodiments of the processes of the inventive concepts may be implemented using more elements than that of the illustrated and described processes.

What is claimed:

1. A septic treatment system, the septic treatment system comprising:
a dispensing apparatus; and
a computing device, the computing device communicatively coupled to the dispensing apparatus through a communication link, the computing device configured to control the dispensing apparatus through the communication link to cause the dispensing apparatus to dispense a septic treatment composition according to a selected dispensing operation sequence from among at least a plurality of dispensing operation sequences, the selected dispensing operation sequence selected based on processing external data received from an external device, each dispensing operation sequence of the plurality of dispensing operation sequences associated with at least one of a separate dispensing operation frequency, a separate amount of septic treatment composition dispensed per dispensing operation, or a separate maximum dispensing operation quantity.

2. The septic treatment system of claim 1, wherein:
the dispensing apparatus includes an outlet port,
the dispensing apparatus is configured to dispense the septic treatment composition through the outlet port, and
the outlet port is coupled in fluid communication with a septic tank of a septic waste system through one or more drain lines of a drain line system such that the septic treatment system is configured to dispense the septic treatment composition into the septic tank through the one or more drain lines based on the computing device causing the dispensing apparatus to dispense the septic treatment composition according to the selected dispensing operation sequence, the one or more drain lines including at least one of a greywater drain line or a blackwater drain line.

3. The septic treatment system of claim 1, wherein:
the dispensing apparatus is configured to dispense the septic treatment composition based on receiving the septic treatment composition from one of a plurality of cartridges, each cartridge of the plurality of cartridges associated with one of a plurality of cartridge groups, each cartridge group associated with a separate cartridge group identifier code among a plurality of cartridge group identifier codes;
the plurality of dispensing operation sequences are associated with separate, respective cartridge group identifier codes among the plurality of cartridge group identifier codes;
the external data includes cartridge data indicating a particular cartridge group identifier code among the plurality of cartridge group identifier codes; and
the computing device is configured to control the dispensing apparatus through the communication link to cause the dispensing apparatus to dispense the septic treatment composition according to the selected dispensing operation sequence based on:
processing the cartridge data to identify the particular cartridge group identifier code from among the plurality of cartridge group identifier codes, and
selecting a particular dispensing operation sequence from among at least the plurality of dispensing operation sequences as the selected dispensing operation sequence based on determining that the particular cartridge group identifier code is associated with the particular dispensing operation sequence.

4. The septic treatment system of claim 3, wherein the plurality of cartridge groups hold different, respective septic treatment compositions.

5. The septic treatment system of claim 4, wherein:
the different, respective septic treatment compositions include different concentrations of one or more microorganisms.

6. The septic treatment system of claim 1, further comprising:
a sensor device communicatively coupled to the computing device, the sensor device configured to generate sensor data based on monitoring at least a portion of a septic system, the septic system including a septic tank, the sensor device configured to transmit the sensor data to the computing device,
wherein the computing device is configured to select the selected dispensing operation sequence based on processing the sensor data to determine at least one property of the septic system, the at least one property including at least one of:
a level of waste within the septic tank,
a level of waste within a drain field of the septic system,
at least one of a presence or concentration of bacteria and/or nutrients within a drain field of the septic system,
a presence, level, or concentration of liquid in soil within a threshold proximity of the septic tank, a drain field of the septic system, or any combination thereof, or
at least one of a presence or concentration of bacteria and/or nutrients in soil within a threshold proximity of the septic tank, a drain field of the septic system, or any combination thereof.

7. The septic treatment system of claim 1, further comprising:
a sensor device communicatively coupled to the computing device, the sensor device configured to generate sensor data based on monitoring at least a portion of a septic system, the septic system including a septic tank, the sensor device configured to transmit the sensor data to the computing device,
wherein the computing device is configured to transmit a signal to a remote device based on processing the sensor data to determine at least one property associated with the septic system, the signal including status information indicating a status of the septic system, the at least one property including at least one of:
a level of waste within the septic tank,
a level of liquid within a drain field of the septic system,
at least one of a presence or concentration of bacteria and/or nutrients within a drain field of the septic system,
a presence, level, or concentration of liquid in soil within a threshold proximity of the septic tank, a drain field of the septic system, or any combination thereof, or
at least one of a presence or concentration of bacteria and/or nutrients in soil within a threshold proximity of the septic tank, a drain field of the septic system, or any combination thereof.

8. The septic treatment system of claim 1, wherein the computing device is configured to cause the dispensing apparatus to perform an interrupt dispensing operation independently of the selected dispensing operation sequence, in response to the computing device receiving a signal from a remote device.

9. The septic treatment system of claim 1, wherein the computing device is configured to:
associate the dispensing apparatus with the selected dispensing operation sequence;
track a quantity of dispensing operations performed by the dispensing apparatus according to the selected dispensing operation sequence; and
in response to determining that the quantity of dispensing operations at least meets a threshold quantity, command at least one of purchase or delivery of a new cartridge to a mailing address associated with the dispensing apparatus based on an ordering parameter associated with the selected dispensing operation sequence, the new cartridge associated with either:
the selected dispensing operation sequence, or
a different dispensing operation sequence.

10. A computing device for a septic treatment system, the computing device comprising:
a communication interface configured to establish a communication link with a dispensing apparatus;
a memory storing a program of instructions; and
a processor configured to execute the program of instructions to,
cause the computing device to control the dispensing apparatus through the communication link to cause the dispensing apparatus to dispense a septic treatment composition according to a selected dispensing operation sequence from among at least a plurality of dispensing operation sequences, the selected dispensing operation sequence selected based on processing external data received from an external device, each dispensing operation sequence of the plurality of dispensing operation sequences associated with at least one of a separate dispensing operation frequency, a separate amount of septic treatment composition dispensed per dispensing operation, or a separate maximum dispensing operation quantity.

11. The computing device of claim 10, wherein:
the dispensing apparatus is configured to dispense the septic treatment composition based on receiving the septic treatment composition from one of a plurality of cartridges, each cartridge of the plurality of cartridges associated with one of a plurality of cartridge groups, each cartridge group associated with a separate cartridge group identifier code among a plurality of cartridge group identifier codes;
the plurality of dispensing operation sequences are associated with separate, respective cartridge group identifier codes among the plurality of cartridge group identifier codes;
the external data includes cartridge data indicating a particular cartridge group identifier code among the plurality of cartridge group identifier codes; and
the processor is configured to execute the program of instructions to:
process the cartridge data to identify the particular cartridge group identifier code from among the plurality of cartridge group identifier codes, and
select a particular dispensing operation sequence from among at least the plurality of dispensing operation sequences as the selected dispensing operation sequence based on determining that the particular cartridge group identifier code is associated with the particular dispensing operation sequence.

12. The computing device of claim 11, wherein the plurality of cartridge groups hold different, respective septic treatment compositions.

13. The computing device of claim 12, wherein:
the different, respective septic treatment compositions include different concentrations of one or more microorganisms.

14. The computing device of claim 10, wherein:
the communication interface is configured to establish a separate communication link with a sensor device such that the computing device is configured to receive sensor data from the sensor device based on the sensor device monitoring at least a portion of a septic system, the septic system including a septic tank;
the external data includes the sensor data received from the sensor device, and
the processor is configured to execute the program of instructions to select the selected dispensing operation sequence based on processing the sensor data to determine at least one property of the septic system, the at least one property including at least one of:
a level of waste within the septic tank,
a level of liquid within a drain field of the septic system,
at least one of a presence or concentration of bacteria and/or nutrients within a drain field of the septic system,
a presence, level, or concentration of liquid in soil within a threshold proximity of the septic tank, a drain field of the septic system, or any combination thereof, or
at least one of a presence or concentration of bacteria and/or nutrients in soil within a threshold proximity of the septic tank, a drain field of the septic system, or any combination thereof.

15. The computing device of claim 10, wherein:
the communication interface is configured to establish a separate communication link with a sensor device such that the computing device is configured to receive sensor data from the sensor device based on the sensor device monitoring at least a portion of a septic system, the septic system including a septic tank; and
the processor is configured to execute the program of instructions to cause the computing device to transmit a signal to a remote device based on processing the sensor data to determine at least one property associated with the septic system, the signal including status information indicating a status of the septic system, the at least one property including at least one of:
a level of waste within the septic tank,
a level of liquid within a drain field of the septic system,
at least one of a presence or concentration of bacteria and/or nutrients within a drain field of the septic system,
a presence, level, or concentration of liquid in soil within a threshold proximity of the septic tank, a drain field of the septic system, or any combination thereof, or
at least one of a presence or concentration of bacteria and/or nutrients in soil within a threshold proximity of the septic tank, a drain field of the septic system, or any combination thereof.

16. The computing device of claim 10, wherein the processor is configured to execute the program of instructions to cause the computing device to transmit a dispensing control signal to the dispensing apparatus to cause the dispensing apparatus to perform an interrupt dispensing operation independently of the selected dispensing operation sequence, in response to the computing device receiving a signal from a remote device.

17. The computing device of claim 10, wherein the processor is configured to execute the program of instructions to:
associate the dispensing apparatus with the selected dispensing operation sequence;
track a quantity of dispensing operations performed by the dispensing apparatus according to the selected dispensing operation sequence; and
in response to determining that the quantity of dispensing operations at least meets a threshold quantity, command at least one of purchase or delivery of a new cartridge to an address associated with the dispensing apparatus based on an ordering parameter associated with the selected dispensing operation sequence, the new cartridge associated with either of:
the selected dispensing operation sequence, or
a different dispensing operation sequence.

18. A method for controlling a septic treatment system, the method comprising:
receiving external data from an external device through a first communication link; and
transmitting a control signal to a dispensing apparatus through a second communication link to cause the dispensing apparatus to dispense a septic treatment composition according to a selected dispensing operation sequence from among at least a plurality of dispensing operation sequences, the selected dispensing operation sequence selected based on processing the external data, each dispensing operation sequence of the plurality of dispensing operation sequences associated with at least one of a separate dispensing operation frequency, a separate amount of septic treatment composition dispensed per dispensing operation, or a separate maximum dispensing operation quantity.

19. The method of claim 18, wherein:
the dispensing apparatus is configured to dispense the septic treatment composition based on receiving the septic treatment composition from one of a plurality of cartridges, each cartridge of the plurality of cartridges associated with one of a plurality of cartridge groups, each cartridge group associated with a separate cartridge group identifier code among a plurality of cartridge group identifier codes;
the plurality of dispensing operation sequences are associated with separate, respective cartridge group identifier codes among the plurality of cartridge group identifier codes;
the external data includes cartridge data indicating a particular cartridge group identifier code among the plurality of cartridge group identifier codes; and
the method includes:
processing the cartridge data to identify the particular cartridge group identifier code from among the plurality of cartridge group identifier codes, and
selecting a particular dispensing operation sequence from among at least the plurality of dispensing operation sequences as the selected dispensing operation sequence based on determining that the particular cartridge group identifier code is associated with the particular dispensing operation sequence.

20. The method of claim 18, wherein:
the external data includes sensor data received from a sensor device based on the sensor device monitoring at least a portion of a septic system, the septic system including a septic tank, and
the method includes selecting the selected dispensing operation sequence based on processing the sensor data to determine at least one property of the septic system, the at least one property including at least one of:
a level of waste within the septic tank,
a level of liquid within a drain field of the septic system,
at least one of a presence or concentration of bacteria and/or nutrients within a drain field of the septic system,
a presence, level, or concentration of liquid in soil within a threshold proximity of the septic tank, a drain field of the septic system, or any combination thereof, or
at least one of a presence or concentration of bacteria and/or nutrients in soil within a threshold proximity of the septic tank, a drain field of the septic system, or any combination thereof.

21. The method of claim 18, wherein:
the method includes transmitting a signal to a remote device based on processing sensor data received from a sensor device to determine at least one property associated with a septic system, the sensor data received based on the sensor device monitoring at least a portion of the septic system, the septic system including a septic tank, the signal including status information indicating a status of the septic system, the at least one property including at least one of:
a level of waste within the septic tank,
a level of liquid within a drain field of the septic system,
at least one of a presence or concentration of bacteria and/or nutrients within a drain field of the septic system,
a presence, level, or concentration of liquid in soil within a threshold proximity of the septic tank, a drain field of the septic system, or any combination thereof, or
at least one of a presence or concentration of bacteria and/or nutrients in soil within a threshold proximity of the septic tank, a drain field of the septic system, or any combination thereof.

22. The method of claim 18, further comprising:
transmitting a dispensing control signal to the dispensing apparatus to cause the dispensing apparatus to perform an interrupt dispensing operation independently of the selected dispensing operation sequence, in response to receiving a signal from a remote device.

23. The method of claim 18, further comprising:
associating the dispensing apparatus with the selected dispensing operation sequence;
tracking a quantity of dispensing operations performed by the dispensing apparatus according to the selected dispensing operation sequence; and
in response to determining that the quantity of dispensing operations at least meets a threshold quantity, commanding at least one of purchase or delivery of a new cartridge to a mailing address associated with the dispensing apparatus based on an ordering parameter associated with the selected dispensing operation sequence, the new cartridge associated with either:
the selected dispensing operation sequence, or
a different dispensing operation sequence.
